(19) United States
(12) Patent Application Publication
(10) Pub. No.: US 2025/0024837 A1
(43) Pub. Date: Jan. 23, 2025

(54) PESTICIDE SYSTEM

(71) Applicant: POLARIS SENSOR TECHNOLOGIES, INC., Huntsville, AL (US)

(72) Inventors: Michele Banish, Huntsville, AL (US); Richard BANISH, Huntsville, AL (US); David CRANDALL, Huntsville, AL (US)

(21) Appl. No.: 18/711,564

(22) PCT Filed: Nov. 21, 2022
(86) PCT No.: PCT/US2022/050573

§ 371 Date: May 17, 2024

Related U.S. Application Data
(60) Provisional application No. 63/281,393, filed on Nov. 19, 2021.

(51) Int. Cl. A01N 25/18; A01M 1/20; A01N 25/08; A01N 31/08

(52) U.S. Cl. CPC A01N 25/18; A01M 1/2077; A01N 25/08; A01N 31/08

(57) ABSTRACT

A pesticide application method and device of the present disclosure produces a non-incendiary, organic-polymerization based pesticide smoke producing reaction. The smoke mainly comprises pesticide and reaction products of the initiator compound. A composition for the non-pyrotechnic generation of pesticide-containing smoke is provided that includes an initiator, and a pesticide agent. Some versions of the composition also include a monomer that polymerizes exothermically. A non-pyrotechnic method of generating pesticide-containing smoke is provided, which includes initiating a frontal reaction (FR) in a composition for the non-pyrotechnic generation of pesticide-containing smoke, and generating smoke comprising the pesticide agent. A method of applying a pesticide to an area is provided, involving initiating an FR to generate pesticide-containing smoke, and exposing the area to the smoke for a period of time sufficient to kill pests. A non-pyrotechnic smoke generator for generating a pesticide-containing smoke is provided, including the smoke-generating composition and an initiation source.

### CROSS-REFERENCE TO RELATED APPLICATIONS

This application cites the priority of U.S. Provisional Patent Application No. 63/281,393, filed on 19 Nov. 2021 (pending), which is incorporated herein by reference in its entirety.

### BACKGROUND

Many pesticides must be dispersed aerially in order to be effective.

Airborne pesticides will penetrate porous objects, envelop entire plants, can flow through gaps between the plants, can surround picked or crated agricultural products, can be designed to persist for prolonged periods, and can be formulated to be harmless to materials. Airborne delivery systems include sprays, smokes, mists and fogs. Sprays have the disadvantage of low airborne residence times as compared to smokes, mists, and fogs, seriously limiting their utility. Sprays tend to be more useful to treat surfaces than airspace itself. If the fog, mist, or smoke is composed of micrometer sized droplets airborne persistence may be several hours in duration.

Devices for producing smoke either rely on combustion or explosion (collectively “pyrotechnics”). Combustive smoke generation devices burn an organic fuel with or without an inorganic oxidizer. Examples of these smoke generation devices are thermite grenades, HC (hexachloroethane), TA (terephthalic acid), and WP (white phosphorus, or red phosphorus) smoke grenades. The reactions in these devices have large free energies and are by necessity highly exothermic. As such, the reactions produce dangerous levels of heat; many also produce smoke that is toxic or otherwise hazardous. The adiabatic flame temperatures of these materials greatly exceed 1000° C., which is one of the factors that leads to their incendiary characteristics. Such heat levels can set cloth, fuel, ammunition and other combustibles on fire. They can also destroy many pesticide compounds. Exposure of persons to them can cause fatal burns, and inhalation of the hot and/or toxic smoke can also be fatal.

Explosives have the same drawbacks as combustive systems in that they generate very high temperatures and often the smoke is toxic. Explosives can also cause injury and property damage due to shrapnel and concussion.

Fog generators operate at lower temperatures by vaporizing a liquid fog solution (commonly an aqueous glycol solution). The fog solution is evaporated in heated air, then blown out through a fan. When the warm and moist air from the fog generator contacts the cooler ambient air, it causes the vaporized solution to form a fog. These devices are generally safer than pyrotechnic smoke generators. However, fog generators are bulky, require a large volume of fog solution to be on hand, and require large amounts of energy (in the form of electricity) to vaporize the fog solution and to operate the fan. Depending on the local humidity and temperature, mechanical fog dispersion may be limited to small areas. As a result, they are not ideally suited for work in the field, and most are not very portable.

Consequently, there is a need in the art for a portable means to deliver pesticides in the form of a smoke, mist, or fog, ideally a non-toxic and non-pyrotechnic smoke, mist, or fog that will neither poison nor burn non-target organisms exposed to it; and which does not depend on an explosion for dispersal. Ideally the smoke can be generated without a heavy or energy-intensive generating device.

### SUMMARY

It has been found that some pesticides can be aerially dispersed in a smoke that is generated non-pyrotechnically (without flame or explosion) through a frontal reaction (FR). The FR generates a small amount of heat that causes a component of the composition to form a mist, fog, or a smoke (referred to herein generally as a “smoke” for the sake of simplicity). Because the smoke is formed at relatively low temperature, the smoke can contain additives with low flashpoints, or that thermally degrade at low temperature that would be destroyed by pyrotechnic methods. Furthermore, it has been found that certain smokes created by FR have pesticidal activity by themselves, so can be used alone or in combination with other pesticides.

It has further been found that the addition of “excess” initiator increases the quality of the smoke and decreases the quality of the resultant polymer. Generally during polymerization, the greater the concentration of initiator, the poorer the strength of the resultant polymer, due to voids, fractures, and other defects. Without wishing to be bound to any hypothetical model, it is believed that increasing the initiator concentration beyond the minimum necessary to sustain the polymerization reaction causes an excessive number of polymerization reactions to occur simultaneously; resulting in shorter polymer chains and in a far weaker polymer product. As the initiator concentration is increased excessively, the polymer product has much shorter chains and is far weaker. Although a disadvantage if one wishes to produce good quality polymer, this can be an advantage in the production of pesticidal smoke.

In a first general embodiment, a composition for the non-pyrotechnic generation of pesticide-containing smoke is provided, the composition comprising: a monomer that exothermically polymerizes upon initiation with an initiator generating a smoke; and said initiator at a mass concentration that is at least one tenth the mass concentration of the monomer; and a pesticide.

In a second general embodiment, a composition for the non-pyrotechnic generation of pesticide-containing smoke is provided, the composition comprising: an initiator; and a pesticide; wherein initiation of the initiator results in a frontal reaction that generates smoke from the degradation products of the initiator.

In a third general embodiment, a non-pyrotechnic method of generating pesticide-containing smoke is provided, the method comprising initiating an FR in a composition for the non-pyrotechnic generation of pesticide-containing smoke, and generating smoke comprising the pesticide.

In a fourth general embodiment, a smoke is provided that is the product of a non-pyrotechnic method of generating pesticide-containing smoke, the method comprising initiating an FR in a composition for the non-pyrotechnic generation of pesticide-containing smoke, and generating smoke comprising the pesticide.

In a fifth general embodiment, a pesticide-containing smoke is provided, the smoke comprising: a pesticide and a reaction product of an initiator.

In a sixth general embodiment, a method of treating an area with pesticide is provided, comprising: generating a pesticide containing smoke by initiating an FR in a composition for the non-pyrotechnic generation of pesticide-containing smoke; generating smoke comprising the pesticide; and exposing the area to the smoke.

In a seventh general embodiment, a method of exerting a pesticidal effect on a pest organism is provided, comprising: generating a pesticide-containing smoke by initiating an FR in a composition for the non-pyrotechnic generation of pesticide-containing smoke; generating smoke comprising the pesticide; and exposing the pest organism to the smoke.

In an eighth general embodiment, a method of repelling a pest organism is provided, comprising: generating a pesticide-containing smoke by initiating an FR in a composition for the non-pyrotechnic generation of pesticide-containing smoke; generating smoke comprising the pesticide; and exposing the pest organism to the smoke.

In a ninth general embodiment, a non-pyrotechnic smoke generator for generating a pesticide-containing smoke is provided, said smoke generator comprising: a composition supported by the support member comprising a monomer that exothermically polymerizes upon initiation with an initiator to generate a smoke, the initiator that initiates polymerization of the monomer present at a mass concentration that is at least the mass concentration of the monomer, and a pesticide; and one of either a heat source or a light source positioned to heat or illuminate the composition.

In a tenth general embodiment, a non-pyrotechnic smoke generator for generating a pesticide-containing smoke is provided, said smoke generator comprising: a composition comprising an initiator that initiates a frontal reaction upon initiation, and a pesticide; and one of either a heat source or a light source positioned to initiate the frontal reaction.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 depicts a “stacked disc” embodiment of a smoke generating device.

FIG. 2 depicts an embodiment of a smoke producing device comprising a substrate formed from a single sheet of material, rolled into a spiral shape.

FIG. 3 depicts a “stacked spiral” arrangement in which a plurality of spiral substrates stacked atop one another.

FIGS. 4A, 4B and 4C depict an embodiment of a smoke producing device in which a plurality of cylindrical petals are arranged “concentrically” inside a cylindrical container that is hinged on one side.

FIG. 5 is an absorbance spectrum of an embodiment of the smoke generating composition and the resulting smoke, with and without the pesticide thymol.

FIG. 6 is an absorbance spectrum of an embodiment of the pesticide-containing composition as compared to the same composition without pesticide, in which the pesticide is thymol, and over the range of 2000-4000 cm⁻¹.

FIG. 7 is an absorbance spectrum of the embodiment of the pesticide-containing composition from FIG. 6 as compared to the same composition without pesticide, in which the pesticide is thymol, and over the range of 500-2000 cm⁻¹.

FIG. 8 is an absorbance spectrum of an embodiment of the pesticide-containing smoke as compared to the same smoke without pesticide, in which the pesticide is thymol, and over the range of 2000-4000 cm⁻¹.

FIG. 9 is an absorbance spectrum of an embodiment of the pesticide-containing smoke as compared to the same smoke without pesticide, in which the pesticide is thymol, and over the range of 500-2000 cm⁻¹.

FIG. 10 depicts an embodiment of a caulk gun that could be used to dispense a bead or line of composition for generating pesticide-containing smoke.

FIG. 11 depicts an embodiment of a cannister that could be used to distribute the pesticide smoke.

FIG. 12 depicts an embodiment of a drone aircraft that could be used to distribute the pesticide smoke.

FIG. 13A-C show absorption peaks for garlic oil (920/cm, 889/cm) in tert-butyl peroxybenzoate and cedarwood oil (920/cm) in P base used to track presence of oil in smoke FTIR data.

FIG. 14 shows an infrared spectrum of garlic oil mixed at 10 pph in tert-butyl peroxybenzoate.

FIG. 15 shows an infrared spectrum of neem oil mixed at 10 pph in tert-butyl peroxybenzoate.

FIG. 16 shows an infrared spectrum of cedarwood oil mixed at 10 pph in tert-butyl peroxybenzoate.

FIG. 17 shows an infrared spectrum of red thyme oil mixed at 10 pph in tert-butyl peroxybenzoate.

FIG. 18 shows an infrared spectrum of spearmint oil mixed at 10 pph in tert-butyl peroxybenzoate.

FIG. 19 shows an infrared spectrum of orange oil mixed at 10 pph in tert-butyl peroxybenzoate (Luperox P) and 1,1-Bis(tert-butylperoxy)-3,3,5-trimethylcyclohexane (Luperox 231).

FIG. 20 shows an infrared spectrum of citronella mixed at 10 pph in tert-butyl peroxybenzoate (Luperox P) and 1,1-Bis(tert-butylperoxy)-3,3,5-trimethylcyclohexane (Luperox 231).

FIG. 21 shows an infrared spectrum of S-limonene mixed at 10 pph in tert-butyl peroxybenzoate (Luperox P) and 1,1-Bis(tert-butylperoxy)-3,3,5-trimethylcyclohexane (Luperox 231).

FIG. 22 shows an infrared spectrum of R-limonene mixed at 10 pph in tert-butyl peroxybenzoate (Luperox P) and 1,1-Bis(tert-butylperoxy)-3,3,5-trimethylcyclohexane (Luperox 231).

FIG. 23 shows an infrared spectrum of 1,1-Bis(tert-butylperoxy)-3,3,5-trimethylcyclohexane (Luperox 231).

FIG. 24 shows an infrared spectrum of tert-butyl peroxybenzoate (Luperox P).

### DETAILED DESCRIPTION

The disclosure provides compositions, methods, and devices for producing smoke, mist, or fog containing one or more pesticide agents. It is believed the compositions disclosed generally produce airborne suspensions of liquid droplets (mist or fog), as opposed to solid particles (smoke), but for the sake of brevity the term “smoke” is used to refer to the airborne suspension. In any instance where the term “smoke” appears it should be interpreted to include a mist, smoke, or a fog (or even a mixture of two or more of a mist, smoke, and fog).

Various embodiments of the compositions and methods disclosed herein may have one or more advantages over previously known smoke-producing compositions; for example: no flame is produced (safer to use indoors, outdoors, and in training environments with flame hazards); low toxicity of the smoke and any non-smoke residues; environmentally friendly (little to no residue or hazardous byproducts); high packing density; high smoke yield/low agglomeration of smoke particles; easily aerosolized; rapid smoke generation (short time constant); good obscuration properties in the visible portion of the electromagnetic spectrum; long smoke durations with appropriate buoyancy; and good shelf life (i.e., after mixing components, the mixture does not self-initiate and/or self-polymerize). However, it is to be understood that not every embodiment of the compositions and methods disclosed herein will have any particular advantage listed above.

The pesticide smoke is created not through combustion or explosion, but by an FR. A frontal reaction is a process in which a polymerization, degradation, or oligomerization reaction propagates directionally through a reaction mass because of the coupling of thermal transport and the Arrhenius-dependence of the kinetics of an exothermic reaction. In FRs, the components are premixed, but stable until initiated by an external source. This is unlike other systems, such as a 2-part epoxy: as soon as the two components are mixed, an exothermic reaction is initiated. As another example, RTV type polymers will self-initiate once exposed to oxygen. The reactions developed here operate differently than either of these or similar types of examples.

FR may be a form of self-propagating high-temperature synthesis (SPHTS). Here the term “high-temperature” is used to indicate higher than ambient temperature, but lower in temperature than pyrotechnic smoke generation. In FR as in the case of SPHTS the system will not start reacting until sufficient energy is applied to the material to get a reaction front propagating through the system. This self-propagating wave moves through the system so long as sufficient heat is generated at the propagation front. Thus, these systems are inherently stable until enough energy is added to start the reaction. Materials with high heat capacity can be incorporated into the mixture to moderate the reaction. Thus, the system can be tuned such that the heat released does not lead to excessive heating (or burning) of the surrounding environment, thereby reducing incendiary hazards. For example, the addition of filler materials has the effect of reducing the front temperature and thereby reducing the incendiary hazard by diluting the concentration of initiator with or without monomer and by raising the specific heat of the composition.

Without wishing to be bound by any hypothetical model, it is believed that when a monomer is present in the pesticidal smoke composition, the frontal reaction proceeds by the polymerization of the monomer, possibly accompanied by the oligomerization or degradation of initiator. It is believed that the frontal reaction proceeds as a front of oligomerization of the initiator, degradation of the initiator, or both when monomer is not present. It is to be understood that the front may result of polymerization of the monomer, oligomerization of the initiator, degradation of the initiator, or a combination of two or more of the foregoing.

### I. DEFINITIONS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

### II. COMPOSITIONS THAT GENERATE PESTICIDE SMOKE

In a general embodiment, the composition comprises an initiator and, optionally, a monomer that exothermically polymerizes upon initiation with an initiator to generate a smoke. When the monomer is present, the initiator is present at a mass concentration that is at least one tenth the mass concentration of the monomer. Some embodiments of the smoke have pesticidal properties in the absence of an additional pesticidal agent. Some embodiments of the composition comprise a separate pesticide agent in an amount effective to produce a pesticidal effect in the smoke. The pesticidal effect is some measurable or observable toxic effect in a pest organism. Some embodiments of the pesticide exert a toxic effect in the pest organism that is of greater severity than a toxic effect exerted on another non-pest organism. The non-pest organism may be a human, an animal, a plant, and a non-target insect (or other arthropod). Such non-pest organisms may be domesticated, and therefore of economic value. They may also be undomesticated, but of ecological value. They may also be domesticated organisms of non-economic value, such as decorative species or pets.

Without wishing to be bound by any hypothetical model, it is believed that the smoke is mainly reaction products of the initiator. These reaction products are believed to be one or both of thermal decomposition products and oligomerization products. It is believed that the initiator causes a front of auto-degradation reactions to spread and generates smoke with or without the presence of monomer. It is further believed that the exothermic polymerization of the monomer, when present, generates sufficient heat to volatilize the reaction products of the initiator. It is also believed that the pesticide is dissolved in the smoke particles, although it is possible that some amount of pesticide is volatilized during smoke generation.

Since the initiator is the source of the smoke in this embodiment, it is only necessary to have a sufficient reaction temperature to sustain the initiator decomposition/oligomerization reaction and maintain the FR. Conventional smoke generation involves the combustion of a fuel (often with an oxidizer) that vaporizes a separate component that forms the smoke. Since the smoke created by polymerization of embodiments of the present smoke generating composition is composed of reaction products of the initiator itself, an additional component is not strictly necessary (although it may be included in some embodiments). Without wishing to be bound by any hypothetical model, it is possible that the monomer itself may also decompose or oligomerize to form part of the smoke in some embodiments.

In some embodiments of the composition, the reactants have reaction temperatures in the range of up to 300° C. Various embodiments of the composition contain reactants that create smoke under conditions that differ significantly from pyrotechnic methods. For example, the reactants may react to create smoke wherein the reaction is flameless, nonexplosive, requires no O₂, consumes no O₂, and any combination of two or more of the foregoing. In a specific embodiment of the composition, O₂ is not a reactant in the exothermic reaction. Furthermore, other oxidants might not be required. Oxidants that are used in pyrotechnic applications include inorganic and organic forms of chlorate, perchlorate, nitrate, sulfate, permanganate, and chromate; and inorganic forms of peroxide and oxide. Commonly used cations include sodium, potassium, barium, ammonium, strontium, lead, cesium, bismuth, iron, and manganese. Some embodiments of the composition lack any significant amount of one or more inorganic oxidizers, such as those listed above. The “significant amount” can mean no more than 10% w/w. Some embodiments of the composition contain no more than 10%, 9%, 8%, 7%, 6%, 5%, 4%, 3%, 2%, 1%, 0.5% and 0.1% w/w of a chlorate, perchlorate, nitrate, sulfate, permanganate, chromate, an inorganic peroxide, and an inorganic oxide. A specific embodiment of the composition contains none of a chlorate, perchlorate, nitrate, sulfate, permanganate, chromate, an inorganic peroxide, and an inorganic oxide.

In experimental testing of the smoke producing composition of the present disclosure, it was found that increasing the amount of initiator in the compound increased the amount of smoke produced. When monomers are present, the composition may have a w/w ratio of initiator:monomer of at least 5% (i.e., 5 g of initiator per 95 g of monomer). Various embodiments of the composition may have higher w/w ratios of initiator:monomer, such as at least 1:10, 1:5, 1:2, 3:5, 7:10, 3:4, 4:5, 85:100, 95:100, 99:100, 1:1, 2:1, 3:1, 4:1, 5:1, 6:1, 7:1, 8:1, 9:1, 10:1, 15:1, 20:1, and a range between any two of the foregoing. In a specific embodiment the initiator:monomer mass ratio is in the range of 5:1-20:1.

Note that the initiator:monomer ratio may be allowed to approach infinity (i.e., no monomer) and still generate smoke. A particular embodiment of the composition comprises initiator, but not necessarily monomer. The initiator may also decompose exothermically. In comparison, ratios for standard reactions wherein the polymerization product, not the smoke product, is desired, are characterized by initiator concentrations utilizing much less than 10 pph-typically 0.01 pph-0.1 pph, but less than 1 pph.

Without wishing to be bound by any hypothetical model, it is believed that the monomer, when present, provides heat (through exothermic polymerization) to vaporize the smoke components. It is also possible that the degradation of the initiator contributes heat during the FR that vaporizes the smoke components. The monomer may be one that is suitable to participate in an FR, such as a trifunctional monomer, having three double-bond carbon ends associated with each monomer molecule. Some preferred embodiments of the composition contain a triacrylate monomer. Specific examples of triacrylate monomers potentially suitable in the composition are trimethylolpropane triacrylate (TMPTA), glycerol propoxylate (1-PO/OH) triacrylate (GPOTA), and trimethylpropane propoxylate triacrylate (TM(PO)TA). Combinations of such monomers could potentially be used as well. Note that the monomer may also be a material with a backbone other than carbon; for example, the silicon backbone in silicone caulk or RTV sealant. In addition, the production of a polymer is not a strict necessity, so long as an exothermic polymerization reaction occurs. Additional components, such as dibutyl phthalate, may be included to modulate the properties of the smoke.

Some embodiments of the composition contain an additional component that forms the smoke. Components such as methyl benzoate, benzyl benzoate, and pentyl acetate, also increase smoke production but reduce buoyancy. These materials are esters used as food additives and have the advantage of low toxicity.

The initiator functions to initiate the polymerization of the monomer when sufficient energy is introduced. One suitable class of initiators is organic peroxides. Specific examples of organic peroxide initiators include di-tert-butyl peroxide (Luperox® DI, Sigma Aldrich, St. Louis, MO, USA), tert-Butyl peroxybenzoate (Luperox® P, Sigma Aldrich, St. Louis, MO, USA), tert-Butyl hydroperoxide, tert-butylperoxy 2-ethylhexyl carbonate (Luperox® TBEC, Sigma Aldrich, St. Louis, MO, USA), 1,1-Bis(tert-butylperoxy)-3,3,5-trimethylcyclohexane (Luperox® 231), and cyclohexyl hydroperoxide. The composition may contain one or more of the foregoing, alone or in combination.

The specific heat and/or concentration of initiator with or without monomer can be modulated by the addition of a “filler.” The filler does not participate in the FR, and may be a generally unreactive compound. The filler may also play a role in nucleating suspended particles in the smoke. Suitable fillers include fumed silica, kaolin powder, powdered sugar, and any combination of two or more of the foregoing. Fumed silica has the advantages that the mass required is low and a high area-mass ratio which provides significant thickening with a low thermal mass. The filler should be present at a concentration sufficient to achieve propagation of the FR at a controlled rate-preventing the monomer from polymerizing too quickly (producing excessive heat) while allowing the production of sufficient heat for polymerization. For example, some embodiments of the composition contain at least 2% w/w filler (pph relative to the concentration of initiator). Further embodiments contain at least 3, 4, 5, 6, 7, 8, 9, 10, 11, 12, 13, 14, 15, 16, 17, 18, 19, 20, 21, 22, 23, 24, 25, 26, 27, 28, 30 pph w/w filler, about any of the foregoing, ±20% any of the foregoing, ±10% any of the foregoing, ±5% any of the foregoing, ±4% any of the foregoing, ±3% any of the foregoing, ±2% any of the foregoing, or ±1% any of the foregoing. Further embodiments contain at most 3, 4, 5, 6, 7, 8, 9, 10, 11, 12, 13, 14, 15, 16, 17, 18, 19, 20, 21, 22, 23, 24, 25, 26, 27, 28, 30 pph w/w filler, about any of the foregoing, ±20% any of the foregoing, ±10% any of the foregoing, ±5% any of the foregoing, ±4% any of the foregoing, ±3% any of the foregoing, ±2% any of the foregoing, or ±1% any of the foregoing. More specific embodiments of the composition contain 2-20 pph w/w filler. More specific embodiments of the composition contain 8-12 pph w/w filler. A specific embodiment of the composition contains 5-20 pph w/w fumed silica. Some embodiments contain a concentration of a filler sufficient to ensure the propagation of the frontal reaction.

The combination of the monomer, initiator, filler, and other components will contribute to the initiation temperature, when thermal initiation is used. The “initiation temperature” is the temperature to which the composition must be raised locally (in one particular area) in order to start the FR, when thermal initiation is used. In some embodiments of the composition, the initiation temperature is no more than 160° C. In further embodiments of the composition, the initiation temperature is no more than 130° C. In more specific embodiments of the composition, the initiation temperature is 100-160° C. In further specific embodiments of the composition, the initiation temperature is 120-130° C. These initiation temperatures have the advantage of being well below the flash points of many common construction materials, meaning that thermal initiation can be achieved without the use of a dangerously hot heat source. Furthermore, the absence of flame during the reaction means that components with lower flashpoints will not combust. In alternative embodiments photoinitiation is used by directing a light source of sufficient intensity to trigger initiation of the composition.

The combination of the monomer, initiator, filler, and other components will contribute to the temperature the composition reaches during the FR and/or during the generation of the smoke. Some embodiments of the composition will not exceed a given maximum temperature during the FR and/or during the generation of the smoke. In some such embodiments, the composition does not exceed 300° C. during the FR and/or during the generation of the smoke.

An infrared-opaque agent may be included in the composition to increase the opacity of the smoke in the IR spectrum. Ideally the IR-opaque agent will be at least partially soluble in the composition and will migrate into the smoke. Some suitable embodiments of the IR-opaque agent are: methyl benzoate, benzyl benzoate, pentyl acetate, and any combination of two or of the same.

Some embodiments of the composition are translucent or transparent over at least a portion of the infrared spectrum. This has the advantage of preventing the smoke from obscuring the use of IR cameras. Some embodiments of the composition generate smoke that is translucent or transparent over at least a portion of the infrared spectrum that includes λ=1.4 μm.

The composition can be formulated in various physical states. These states include a solid, a liquid, and a gel (among others). Some embodiments of the composition are not fluid. Such non-fluids may include a solid and a semi-solid. Such semi-solids may include a colloid, a slurry, a gel, a paste, and a slime. A non-fluid form has the advantage of preventing convection during the FPL, and may be formed to allow more controlled propagation of a frontal reaction.

Non-fluid embodiments of the composition may be manufactured with a defined shape. For example, a sheet is especially useful if an FR is desired. Suitable sheets may be created as strips, discs, spirals, tapes, and other relatively flat shapes. In some sheets a first dimension (e.g., height) is much smaller than at least one of the other two dimensions. Such flat shapes allow the formation of a reaction front that spreads along only one or two axes.

Fluid embodiments of the composition could potentially be used by dispensing a controlled amount to an initiation mechanism to produce smoke at a controlled rate.

An initiation mechanism may be present in the composition. The initiation mechanism provides sufficient energy to initiate polymerization, in form of heat, electromagnetic radiation, or other forms. Some embodiments of the initiation mechanism are a heat source. The heat source may be a non-pyrogenic heat source. Embodiments of the non-pyrogenic heat source may be a conductive wire connected to a source of electric current, a heated gas, a source of electromagnetic radiation, a solid heat conductor, a nichrome wire loop connected to an electric power source, a heat gun, a soldering iron, focused light, a piezoelectric device, and a combination of the foregoing. One exemplary embodiment of the initiation device is a 1″ conduction loop of 30-gauge (0.01″) nickel-chromium (NiCr, or nichrome) wire with a resistance/unit length of approximately 4.5 Ohm/in. Testing has shown that a current draw of approximately 1 Amp is sufficient to initiate the FR is some embodiments of the composition. Using Power, P=I²R, where I is the current in Amps and R is the resistance in Ohms, this yields an input Power of P=(1 Amp)²(4.5 Ohm)=4.5 W.

A preferred embodiment of the composition comprises TMPTA (as the monomer), tert-peroxybenzoate (as the initiator) present at a mass concentration that is 1-20 times the mass concentration of the monomer, and thymol as the pesticide.

The pesticide may be present in an amount sufficient to exert a pesticidal effect. A “pesticidal effect” exists if at least 50% of pests are killed or “knocked down” (i.e., the state of intoxication and partial paralysis which usually precedes death), or if at least 50% of pests are effectively repelled. In some embodiments the pesticide effect is a kill/inactivation/repellent rate of at least 50%, 80%, 85%, 90%, 95%, 99%, 99.9%, 99.99%, 99.999%, or 99.9999%. The pest may include without limitation a rodent, an invertebrate, an insect, an arachnid, a tick, a mite, a flatworm, a nematode, an annelid, and a protozoan. Specific insects that are contemplated include mosquitos, fleas, ants, termites, grasshoppers, cockroaches, wasps, lepidopterans, aphids, weevils, armyworms, beetles, and larvae.

The pesticide will ideally dissolve in the smoke generating composition and segregate into the smoke fraction during smoke generation. Without wishing to be bound by any given hypothetical model, it is believed that alcohols, oils, and organic acids have adequate pesticide properties, will dissolve in embodiments of the smoke generating composition, and will at least partially segregate into the smoke fraction.

In some embodiments of the composition the pesticide is an active ingredient of a pesticide on the list of pesticides publicly maintained by the United States Environmental Protection Agency (EPA), shown in Table 1. In further embodiments, the pesticide is selected from the list below, but is not a recognized or registered as a microbicide. The pesticide may be any of an arachnidicide, fungicide, herbicide, insecticide, insect growth regulator, nematicide, miticide, molluscicide, ovicide, repellent, rodenticide, vermicide, or any agent with two or more listed properties. In those embodiments in which the pesticide lacks disinfectant properties, disinfectant properties are said to exist if at least 50% of infectious agents are killed or inactivated. In some embodiments disinfectant properties are said to exist at a kill or inactivation rate of at least 50%, 80%, 85%, 90%, 95%, 99%, 99.9%, 99.99%, 99.999%, or 99.9999%.

TABLE 1
U.S. EPA-Listed Pesticides

| CAS | |
|---|---|
| Number | Chemical Name |
| 54844-65-4 | (Z)-6-Heneicosen-11-one |
| 28079-04-1 | (Z)-8-Dodecen-1-yl acetate |
| 56219-04-6 | (Z)-9-Hexadecenal |
| 53939-27-8 | (Z)-9-Tetradecenal |
| | (Z,E)-3,13-Octadecadienol |
| 53120-27-7 | (Z,Z)-3,13-Octadecadien-1-ol acetate |
| 66410-24-0 | (Z,Z)-3,13-Octadecadien-1-ol |
| 52304-36-6 | .beta.-Alanine, N-acetyl-N-butyl-, ethyl ester |
| 146659-78-1 | Polyoxin D zinc salt |
| 34590-94-8 | 1 (or 2)-(2-Methoxymethylethoxy)propanol |
| 2074-50-2 | 1,1′-Dimethyl-4,4′-bipyridinium bis(methyl sulfate) |
| 1191-17-9 | 1,1′-Oxybis(2,2-dichloroethane) |
| 79-34-5 | 1,1,2,2-Tetrachloroethane (No longer |
| | approved for inert use) p |
| | 1,12-Di(3-decyl-2- |
| | methylimidazolium)dodecane dibromide |
| 135158-54-2 | Acibenzolar-s-methyl |
| 7632-50-0 | 1,2,3-Propanetricarboxylic acid, 2-hydroxy-, |
| | ammonium salt |
| 29593-08-6 | 1,2,3-Propanetriol, mono(4-aminobenzoate) |
| 117-18-0 | 1,2,4,5-Tetrachloro-3-nitrobenzene |
| 64529-56-2 | 1,2,4-Triazine-5(4H)-one, 4-amino- |
| | 6-(1,1-dimethylethyl)-3-(ethylthio)- |
| 68049-83-2 | 1,2,4-Triazolo{4,3-a}pyridin-3(2H)-one,2- |
| | {2,4-dich<BR>loro-5-(2-propynyloxy)phenyl}- |
| | 5,6,7,8-tetrahydro- |
| 120-82-1 | 1,2,4-Trichlorobenzene |
| 135-77-3 | 1,2,4-Trimethoxybenzene |
| 643-79-8 | 1,2-Benzenedicarboxaldehyde |
| | 1,2-Benzisothiazol-3(2H)-one, 2-butyl- |
| 2634-33-5 | 1,2-Benzisothiazolin-3-one |
| 96-12-8 | 1,2-Dibromo-3-chloropropane |
| 78-87-5 | 1,2-Dichloropropane |
| 5716-15-4 | 1,2-Dihydro-3,6-pyridazinedione, diethanolamine salt |
| 107-15-3 | 1,2-Ethanediamine |
| 135-23-9 | 1,2-Ethanediamine, N,N-dimethyl-N′- |
| | 2-pyridinyl-N′-(2-thienylmethyl)-, |
| | monohydrochloride |
| 53404-62-9 | 1,2-Ethanediamine, N-((2-(1- |
| | nitroethyl)phenyl)methyl)-, monopotassium salt (Not |
| | selected for InertFinder) |
| 42751-79-1 | 1,2-Ethanediamine, polymer with |
| | (chloromethyl)oxirane and N-methylmethanamine |
| 107-06-2 | 1,2-Ethylene dichloride |
| 120-62-7 | 1,2-Methylenedioxy-4-(2- |
| | (octylsulfidnyl)propyl)ben<BR>zene |
| 99-26-3 | 1,3,2-Benzodioxabismole-5-carboxylic |
| | acid, 2,7-dihydroxy- |
| 2665-13-6 | 1,3,2-Dioxaborinane, 2,2′-((1-methyl-1,3- |
| | propanediyl)bis(oxy)) bis(4-methyl- |
| 14697-50-8 | 1,3,2-Dioxaborinane, 2,2′oxybis(4,4,6-trimethyl- |
| 72542-56-4 | 1,3,2-Dioxaphosphorinane, ethanimidiothioic acid deriv. |
| 2385-85-5 | 1,3,4-Metheno-1H-cyclobuta(cd)pentalene, |
| | 1,1a,2,2,3,3a,4,5,5,5a,5b,6- |
| | dodecachlorooctahydro- |
| 25254-50-6 | 1,3,5-Triazine-1,3,5(2H,4H,6H)-triethanol, |
| | .alpha.,.alpha.′,.alpha.′-trimethyl- |
| 30622-37-8 | 1,3,5-Triazine-2,4,6(1H,3H,5H)-trione, |
| | 1,3,5-trichloro-, mixt. with 1,3-dichloro-1,3,5- |
| | triazine-2,4,6(1H,3H,5H)-trione potassium salt |
| 22936-75-0 | 1,3,5-Triazine-2,4-diamine, N-(1,2- |
| | dimethylpropyl)-N′-ethyl-6-(methylthio)- |
| 28159-98-0 | 1,3,5-Triazine-2,4-diamine, N-cyclopropyl- |
| | N′-(1,1-dimethylethyl)-6-(methylthio)- |
| 101-05-3 | 1,3,5-Triazine-2-amine, 4,6-dichloro-N-(2-chlorophenyl)- |
| 7779-27-3 | 1,3,5-Triethylhexahydro-s-triazine |
| 107-88-0 | 1,3-Butylene glycol |
| 77-48-5 | 1,3-Dibromo-5,5-dimethylhydantoin |
| 82925-96-0 | 1,3-Dibromo-5-ethyl-5-methylhydantoin |
| 118-52-5 | 1,3-Dichloro-5,5-dimethylhydantoin |
| 89415-87-2 | 1,3-Dichloro-5-ethyl-5-methylhydantoin |
| 53983-00-9 | 1,3-Dioxane, 5-bromo-2-methyl-3-nitro- |
| 2372-82-9 | 1,3-Propanediamine, N-(3-aminopropyl)-N-dodecyl- |
| 83542-86-3 | 1,3-Propanediamine, N-9-octadecenyl-, |
| | (Z)-, mono-D-gluconate |
| 77-49-6 | 1,3-Propanediol, 2-methyl-2-nitro- |
| 118134-30-8 | Spiroxamine |
| 309-00-2 | 1,4:5,8-Dimethanonaphthalene, 1,2,3,4,10, |
| | 10-hexachloro-1,4,4a,5,8,8a-hexahydro-, |
| | (1.alpha.,4.alpha.,4a.beta.,5.alpha.,8.alpha.,8a.beta.)- |
| 18794-84-8 | 1,6,10-Dodecatriene, 7,11-dimethyl-3-methylene-, (E)- |
| 22232-16-2 | 1,6-Diamino-2,2-difluorohexane |
| 180-84-7 | 1,7-Dioxaspiro[5.5] undecane |
| 1861-44-5 | 1-((2,3,6-Trichlorobenzyl)oxy)-2-propanol |
| 105827-78-9 | 1-((6-Chloro-3-pyridinyl)methyl)-4,5-dihydro- |
| | N-nit<BR>ro-1H-imidazol-2-amine |
| | 1-(2-(2-Chlorobenzyl)-2-hydroxy-3,3- |
| | dimethylbutyl)<BR>-1,2,4-triazole |
| 61791-39-7 | 1-(2-Hydroxyethyl)-2-alkyl-2-imidazoline |
| | (as in fatty acids of tall oil) |
| 27136-73-8 | 1-(2-Hydroxyethyl)-2-heptadecenyl-2-imidazoline |
| 4080-31-3 | 1-(3-Chloroallyl)-3,5,7-triaza-1- |
| | azoniaadamantane chloride |
| 68155-37-3 | 1-(Alkyl* amino)-3-aminopropane *(42% C12, |
| | 26% C18, 15% C14, 8% C16, 5% C10, |
| | 4% C8) |
| 61791-58-0 | 1-(Alkyl* amino)-3-aminopropane *(53% C12, |
| | 19% C14, 8.5% C16, 7% C8, 6.5% C10, |
| | 6% C18) |
| 68155-42-0 | 1-(Alkyl* amino)-3-aminopropane adipate |
| | *(as in fatty acids of coconut oil) |
| 68188-29-4 | 1-(Alkyl* amino)-3-aminopropane benzoate |
| | *(as in fatty acids of coconut oil) |
| 61791-64-8 | 1-(Alkyl* amino)-3-aminopropane diacetate |
| | *(as in fatty acids of coconut oil) |
| 68155-43-1 | 1-(Alkyl* amino)-3-aminopropane hydroxyacetate |
| | *(as in fatty acids of coconut oil) |
| | 1-(Alkyl* amino)-3-aminopropane monoacetate |
| | *(47% C12, 18% C14, 10% C18, 9% C10, |
| | 8% C16, 8% C8) |
| 61791-64-8 | 1-(Alkyl* amino)-3-aminopropane monoacetate |
| | *(as in fatty acids of coconut oil) |
| | 1-(Alkyl* amino)-3-aminopropane |
| | propionate-copper acetate complex |
| 35691-65-7 | 1-Bromo-1-(bromomethyl)-1,3-propanedicarbonitrile |
| 109-79-5 | 1-Butanethiol |
| 2425-66-3 | 1-Chloro-2-nitropropane |
| 461-58-5 | 1-Cyanoguanidine |
| 32426-11-2 | 1-Decanaminium, N,N-dimethyl-N-octyl-, chloride |
| 7173-51-5 | 1-Decanaminium, N-decyl-N,N-dimethyl-, chloride |
| 112-30-1 | 1-Decanol |
| 1920-05-4 | 1-Dodecanamine, N,N-dimethyl-, acetate |
| 10361-16-7 | 1-Dodecanaminium, N,N-dimethyl-N-octyl-, chloride |
| | 1-Dodecanamium-N,N′-methylenebis(oxy-2,1- |
| | ethanediyl)bis(N,N-dimethyl-, dichloride |
| | 1-Ethyl-2-heptadecenyl-1-(2-hydroxyethyl)- |
| | 2-imidazolinium bromide |
| 525-79-1 | 1-H-Purin-6-amine, N-(2-furanylmethyl)- |
| 111-27-3 | 1-Hexanol |
| 85977-73-7 | 1-Indole-3-butanethioic acid, S-phenyl ester |
| 86-86-2 | 1-Naphthaleneacetamide |
| 86-87-3 | 1-Naphthaleneacetic acid |
| 5138-52-3 | 1-Napthalenesulfonic acid, methyl ester |
| 27668-52-6 | 1-Octadecanaminium, N,N-dimethyl-N- |
| | (3-(trimethoxysilyl)propyl)-, chloride |
| 199111-50-7 | 1-Octadecanaminium, N,N-dimethyl-N-[3- |
| | (trihydroxysi<BR>lyl)propyl],chloride |
| 5538-94-3 | 1-Octanaminium, N,N-dimethyl-N-octyl-, chloride |
| 111-87-5 | 1-Octanol |
| 3391-86-4 | 1-Octen-3-ol |
| 17699-14-8 | (-)-.alpha.-Cubebene |
| 5335-24-0 | (1,1′-Biphenyl)-2-ol, 3,5-dichloro- |
| 53404-30-1 | (1,1′-Biphenyl)-2-ol, 3,5-dichloro-, potassium salt |
| 85-97-2 | (1,1′-Biphenyl)-2-ol, 3-chloro- |
| 1331-46-0 | (1,1′-Biphenyl)-2-ol, 5-chloro- |
| 53404-21-0 | (1,1′-Biphenyl)-2-ol, 5-chloro-, potassium salt |
| 52704-98-0 | (1,1′-Biphenyl)-2-ol, ammonium salt |
| 3645-61-2 | (1,1′-Biphenyl)-4-ol, sodium salt |
| 5251-79-6 | (Benzamidooxy)acetic acid, ammonium salt |
| 26532-24-1; | (E)-(3,3-Dimethylcyclohexylidene)acetaldehyde |
| 26532-25-2; | |
| 36872-03-4 | |
| 72269-48-8 | (E)-4-Tridecen-I-yl acetate |
| 38363-29-0 | (E)-8-Dodecen-1-yl acetate |
| 35857-62-6 | (E)-9-Tricosene |
| 53120-26-6 | (E,Z)-3,13-Octadecadien-1-ol acetate |
| 64726-91-6 | (R,Z)-5-(1-Decenyl)dihydro-2(3H)-furanone |
| 26532-24-1 | (Z)-(3,3-Dimethylcyclohexylidene)acetaldehyde |
| 56683-54-6 | (Z)-11-Hexadecen-1-ol |
| 53939-28-9 | (Z)-11-Hexadecenal |
| 34010-21-4 | (Z)-11-Hexadecenyl acetate |
| 20711-10-8 | (Z)-11-Tetradecenyl acetate |
| 58594-45-9 | (Z)-13-Octadecenal |
| 60037-58-3 | (Z)-13-Octadecenyl acetate |
| 26532-23-0 | (Z)-2-(3,3-Dimethylcyclohexylidene)ethanol |
| 338-45-4 | (Z)-2-Carbomethoxy-1-methylvinyl dimethyl phosphate |
| 65954-19-0 | (Z)-4-Tridecen-1-yl acetate |
| 53466-82-3 | 1H-Imidazol-2-ethanol, 1-(heptadecenyl)- |
| | 4,5-dihydro-, monohydrochloride |
| 556-22-9 | 1H-Imidazole, 2-heptadecyl-4,5-dihydro-, monoacetate |
| 82078-98-6 | 1H-Imidazole, heptadecenyl-4,5-dihydro-, |
| | monohydrochloride |
| 443-48-1 | 1H-Imidazole-1-ethanol, 2-methyl-5-nitro- |
| 53466-92-5 | 1H-Imidazoleethanol, heptadecyl-4,5-dihydro-, |
| | monohydrochloride |
| 53404-72-1 | 1H-Indene-1,3(2H)-dione, 2-(2,2-dimethyl-1- |
| | oxopropyl)-, ion(1-), calcium |
| 83-28-3 | 1H-Indene-1,3(2H)-dione, 2-(3-methyl-1-oxobutyl)- |
| 69-89-6 | Xanthine |
| 58-08-2 | 1H-Purine-2,6-dione, 3,7-dihydro-1,3,7-trimethyl- |
| 85264-33-1 | 1H-Pyrazole-1-methanol, 3,5-dimethyl- |
| 1934-21-0 | Acid Yellow 23 |
| 119168-77-3 | Tebufenpyrad |
| 2465-59-0 | Oxypurinol |
| 70017-56-0 | 1H-Pyrrole-2,5-dione, 1-(2-methyl-1-naphthalenyl)- |
| 122454-29-9 | 1H-Pyrrole-3-carbonitrile,4-bromo-2-(4- |
| | chloropheny<BR>I)-5-(trifluoromethyl)- |
| 68479-77-6 | 2′-Hydroxyethyl-2,3-dibromopropionate |
| 16079-88-2 | 2,4-Imidazolidinedione, 1-bromo-3-chloro-5,5-dimethyl- |
| 113796-46-6 | 2,4-Imidazolidinedione, 1-chloro-5-ethyl-5-methyl- |
| 126-06-7 | 2,4-Imidazolidinedione, 3-bromo-1-chloro-5,5-dimethyl- |
| 105-67-9 | 2,4-Xylenol |
| 1917-97-1 | 2,4-dichlorophenoxyacetic acid, 2-octyl ester |
| 1928-45-6 | 2,4-dichlorophenoxyacetic acid, 3-butoxypropyl ester |
| 2212-59-1 | 2,4-dichlorophenoxyacetic acid, N-oleyl- |
| | 1,3-propylenediamine salt |
| 137335-70-7 | 2,4-dichlorophenoxyacetic acid, alkylamines |
| | derived from tall oil |
| 1928-57-0 | 2,4-dichlorophenoxyacetic acid, butoxyethylpropyl ester |
| 53404-01-6 | 2,4-dichlorophenoxyacetic acid, |
| | butoxypolyethoxypropyl ester |
| 94-80-4 | 2,4-dichlorophenoxyacetic acid, butyl ester |
| 1713-15-1 | 2,4-dichlorophenoxyacetic acid, isobutyl ester |
| 1320-18-9 | 2,4-dichlorophenoxyacetic acid, propylene |
| | glycol butyl ether ester |
| 136-45-8 | MGK 326 |
| 2478-21-9 | 2,6-Bis((dimethylamino)methyl)cyclohexanone |
| 828-00-2 | 2,6-Dimethyl-m-dioxan-4-ol acetate |
| 60-57-1 | 2,7:3,6-Dimethanonaphth(2,3-b)oxirene, |
| | 3,4,5,6,9,9-hexachloro-1a,2,2a,3,6,6a,7,7a- |
| | octahydro-, (1a.alpha.,2.beta.,2a.alpha., |
| | 3.beta.,6.beta.,6a.alpha.,7.beta.,7a.alpha.)- |
| 52299-20-4 | 2-((Hydroxymethyl)amino)-2-methyl-1-propanol |
| 34375-28-5 | 2-((Hydroxymethyl)amino)ethanol |
| 112-56-1 | 2-(2-Butoxyethoxy)ethyl thiocyanate |
| 62732-91-6 | 2-(2-Ethoxyethoxy)ethyl 2-benzimidazole carbamate |
| 81510-83-0 | Imazapyr, isopropylamine salt |
| 140-57-8 | 2-(4-tert-Butylphenoxy)isopropyl-2-chloroethyl sulfite |
| 36362-09-1 | 2-(Decylthio)ethanamine hydrochloride |
| 126-11-4 | 2-(Hydroxymethyl)-2-nitro-1,3-propanediol |
| 21564-17-0 | 2-(Thiocyanomethylthio)benzothiazole |
| 5825-87-6 | 2-(m-Chlorophenoxy)propionamide |
| 101-10-0 | 2-(m-Chlorophenoxy)propionic acid |
| 53404-22-1 | 2-(m-Chlorophenoxy)propionic acid, sodium salt |
| 94-75-7 | 2,4-D |
| 53466-68-5 | 2-Alkyl* isoquinolinium bromide |
| | *(50% C12, 30% C14, 17% C16, 3% C18) |
| 68309-34-2 | 2-Alkyl *-1(or 3)-benzyl-1-(2-hydroxethyl)- |
| | 2-imidazolinium chloride *(as 1n fatty acids of |
| | tall oil) |
| | 2-Alkyl *-1-(2-aminoethyl)-2-imidazoline |
| | acetate-nickel sulfate complex |
| 61791-39-7 | 2-Alkyl *-1-(2-hydroxyethyl)-2-imidazoline |
| | acetate *(as in fatty acids of tall oil) |
| 53404-11-8 | 2-Alkyl *-1-(2-hydroxyethyl)-2-imidazoline |
| | phosphate *(100% C13) |
| 61791-52-4 | 2-Alkyl *-1-benzyl-1-(2-hydroxyethyl)-2- |
| | imidazolinium chloride *(as in fatty acids of |
| | coconut oil) |
| 13952-84-6 | 2-Aminobutane |
| 120-32-1 | 2-Benzyl-4-chlorophenol |
| 3572-06-3 | 2-Butanone, 4-(4-(acetyloxy)phenyl)-, acetate |
| 53466-85-6 | 2-Butenedioic acid (Z)-, monoester with |
| | 1(or 2)-((tributylstannyl)oxy)propanol |
| 7786-34-7 | Mevinphos |
| 298-01-1 | 2-Butenoic acid, 3-((dimethoxyphosphinyl)oxy)-, |
| | methyl ester, (E)- |
| 111-76-2 | 2-Butoxyethanol |
| 115-84-4 | 2-Butyl-2-ethyl-1,3-propanediol |
| 470-90-6 | 2-Chloro-1-(2,4-dichlorophenyl)vinyl diethyl phosphate |
| 92-04-6 | 2-Chloro-4-phenylphenol |
| 2464-37-1 | 2-Chloro-9-hydroxy-9H-fluorene-9-carboxylic acid |
| 2832-19-1 | 2-Chloro-N-(hydroxymethyl)acetamide |
| 95-57-8 | 2-Chlorophenol |
| 139001-49-3 | 2-Cyclohexe-1-one, 2-[1-[2-(4- |
| | chlorophenoxy)propoxy]imino]butyl]-3-hydroxy-5- |
| | (tetrahydro-2H-thiopyran-3-yl)- |
| 149979-41-9 | Tepraloxydim |
| 80-71-7 | 2-Cyclopenten-1-one, 2-hydroxy-3-methyl- |
| 104-28-9 | 2-Ethoxyethyl p-methoxycinnamate |
| 94-96-2 | 2-Ethyl-1,3-hexanediol |
| 104-76-7 | 2-Ethyl-1-hexanol |
| 12379-46-3 | 2-Ethylhexanoate salt of magnesium 8-quinolinolate |
| 865363-39-9 | 2,4-DP-p, 2-ethylhexyl ester |
| | MCPP-P, 2-ethylhexyl ester |
| 640-19-7 | 2-Fluoroacetamide |
| 13470-50-3 | 2-Heptadecyl-1-methyl-1-(2-(stearoylamido)ethyl)- |
| | 2-imidazolinium methyl sulfate |
| 3547-33-9 | 2-Hydroxyethyl octyl sulfide |
| 23710-76-1 | 2-Isovaleryl-1,3-indandione, calcium salt |
| 93-23-2 | 2-Lauryl isoquinolinium bromide |
| 149-30-4 | 2-Mercaptobenzothiazole (No longer |
| | approved for nonfood use) |
| 2492-26-4 | 2-Mercaptobenzothiazole, sodium salt |
| 155-04-4 | 2-Mercaptobenzothiazole, zinc salt |
| 109-86-4 | 2-Methoxyethanol |
| 85-07-4 | 2-Methyl-1-naphthaleneacetamide |
| 85-08-5 | 2-Methyl-1-naphthaleneacetic acid |
| 107-41-5 | 2-Methyl-2,4-pentanediol |
| 2682-20-4 | 2-Methyl-3(2H)-isothiazolone |
| 79-57-2 | 2-Naphthacenecarboxamide, 4-(dimethylamino)- |
| | 1,4,4a,5,5a,6,11,12a-octahydro- |
| | 3,5,6,10,12,12a-hexahydroxy-6-methyl-1,11-dioxo-, (4S- |
| | (4.alpha.,4a.alpha.,5.alpha.,5a.alpha.,6.beta., 12a.alpha.))- |
| 57-62-5 | 2-Naphthacenecarboxamide, 7-chloro-4- |
| | (dimethylamino)-1,4,4a,5,5a,6,11,12a- |
| | octahydro-3,6,10,12, 12a-pentahydroxy- |
| | 6-methyl-1,11-dioxo-, (4S- |
| | (4.alpha.,4a.alpha.,5a.alpha.,6.beta., 12a.alpha.))- |
| 135-19-3 | 2-Naphthol |
| 597-09-1 | 2-Nitro-2-ethyl-1,3-propanediol |
| 60-12-8 | 2-Phenylethanol |
| 122-70-3 | Propionic acid, phenethyl ester |
| 26062-79-3 | 2-Propen-1-aminium, N,N-dimethyl- |
| | N-2-propenyl-, chloride, homopolymer |
| 58509-83-4 | Clopyralid potassium |
| 6753-47-5 | Picloram, triisopropanolamine salt |
| 290332-10-4 | 2-Pyridinesulfonamide, N-[(4,6-dimethoxy- |
| | 2-pyrimidinyl)amino]carbonyl]-3-(2,2,2- |
| | trifluoroethoxy)-, monosodium salt, monohydrate |
| 61213-25-0 | 2-Pyrrolidinone, 3-chloro-4-(chloromethyl)- |
| | 1-(3-(trifluoromethyl)phenyl)- |
| 104-61-0 | 2(3H)-Furanone, dihydro-5-pentyl- |
| 120-78-5 | 2,2′-Dithiobisbenzothiazole |
| 70-30-4 | 2,2′-Methylenebis(3,4,6-trichlorophenol) |
| 97-23-4 | 2,2′-Methylenebis(4-chlorophenol) |
| 4418-66-0 | 2,2′-Thiobis(4-chloro-6-methylphenol) |
| 10222-01-2 | 2,2-Dibromo-3-nitrilopropionamide |
| 126-15-8 | 2,3,4,5-Bis(2-butylene)tetrahydro-2-furaldehyde |
| 38827-35-9 | 2,3,5-Trichloro-4-(propylsulfonyl)pyridine |
| 2655-15-4 | 2,3,5-Trimethylphenyl methylcarbamate |
| 50-31-7 | 2,3,6-Trichlorobenzoic acid |
| 3426-62-8 | 2,3,6-Trichlorobenzoic acid and related |
| | polychlorobenzoic acids, dimethylamine salt of |
| 85-34-7 | 2,3,6-Trichlorophenylacetic acid |
| 2439-00-1 | 2,3,6-Trichlorophenylacetic acid, sodium salt |
| 117-80-6 | 2,3-Dichloro-1,4-napthoquinone |
| 78-88-6 | 2,3-Dichloropropene |
| 69484-13-5 | 2,4(1H,3H)-Pyrimidinedione, 5-bromo-6- |
| | methyl-3-(1-methylpropyl)-, compd. with N- |
| | methylmethanamine (1:1) |
| 95-95-4 | 2,4,5-Trichlorophenol |
| 93-76-5 | 2,4,5-Trichlorophenoxyacetic acid |
| 69462-12-0 | 2,4,5-Trichlorophenoxyacetic acid, |
| | 2-ethyl-4-methylpentyl ester |
| 55256-33-2 | 2,4,5-Trichlorophenoxyacetic acid, |
| | N,N-dimethyl oleyl-linoleyl amine salt |
| 53404-89-0 | 2,4,5-Trichlorophenoxyacetic acid, |
| | N,N-dimethyloleylamine salt |
| | 2,4,5-Trichlorophenoxyacetic acid, alkyl (C3-C7) ester |
| 120-39-8 | 2,4,5-Trichlorophenoxyacetic acid, amyl ester |
| 1928-58-1 | 2,4,5-Trichlorophenoxyacetic acid, |
| | butoxyethoxypropanol ester |
| 93-79-8 | 2,4,5-Trichlorophenoxyacetic acid, butyl ester |
| 53404-86-7 | 2,4,5-Trichlorophenoxyacetic acid, |
| | diethylethanolamine salt |
| 6369-97-7 | 2,4,5-Trichlorophenoxyacetic acid, dimethylamine salt |
| 93-78-7 | 2,4,5-Trichlorophenoxyacetic acid, isopropyl ester |
| | 2,4,5-Trichlorophenoxyacetic acid, triethanolamine salt |
| 2008-46-0 | 2,4,5-Trichlorophenoxyacetic acid, triethylamine salt |
| 88-06-2 | 2,4,6-Trichlorophenol |
| 3784-03-0 | 2,4,6-Trichlorophenol, sodium salt |
| 1928-43-4 | 2,4-D, 2-ethylhexyl ester |
| | 2,4-D, alkanolamine salt |
| 1929-73-3 | 2,4-D, butoxyethyl ester |
| 5742-19-8 | 2,4-D, diethanolamine salt |
| 2008-39-1 | 2,4-D, dimethylamine salt |
| 94-11-1 | 2,4-D, isopropyl ester |
| 5742-17-6 | 2,4-D, isopropylamine salt |
| 3766-27-6 | 2,4-D, lithium salt |
| 2702-72-9 | 2,4-D, sodium salt |
| 28685-18-9 | 2,4-D, tetradecylamine salt |
| 32341-80-3 | 2,4-D, triisopropanolamine salt |
| 2307-55-3 | 2,4-Dichlorophenoxyacetic acid, ammonium salt |
| 2212-54-6 | 2,4-Dichlorophenoxyacetic acid, dodecylamine salt |
| 2212-53-5 | 2,4-Dichlorophenoxyacetic acid, octylamine salt |
| 97-16-5 | 2,4-Dichlorophenyl benzenesulfonate |
| 1836-75-5 | 2,4-Dichlorophenyl p-nitrophenyl ether |
| 97-00-7 | 2,4-Dinitrochlorobenzene |
| 51-28-5 | 2,4-Dinitrophenol |
| 65733-20-2 | 2,4-Dodecadienoic acid, 3,7,11-trimethyl-, |
| | 2-propynyl ester, (S-(E,E))- |
| 65733-18-8 | 2,4-Dodecadienoic acid, 3,7,11- |
| | trimethyl-, ethyl ester, (S-(E,E))- |
| 6440-58-0 | 2,4-Imidazolidinedione, |
| | 1,3-bis(hydroxymethyl)-5,5-dimethyl- |
| 116-25-6 | 2,4-Imidazolidinedione, 1-(hydroxymethyl)-5,5-dimethyl- |
| 110-66-7 | 1-Pentanethiol |
| 1446-61-3 | 1-Phenanthrenemethanamine, 1,2,3,4,4a,9,10, |
| | 10a-octahydro-1,4a-dimethyl-7-(1- |
| | methylethyl)-, ?1R-(1.alpha.,4a.beta., 10a.alpha.)- |
| 2026-24-6 | 1-Phenanthrenemethanamine, 1,2,3,4,4a,9,10, |
| | 10a-octahydro-1,4a-dimethyl-7-(1- |
| | methylethyl)-, acetate, ?1R-(1.alpha.,4a.beta., 10a.alpha.)- |
| 5451-63-8 | 1-Tetradecanol, formate |
| 593-50-0 | 1-Triacontanol |
| 2536-26-7 | 1-Tridecanamine, N,N-dimethyl-, 7- |
| | oxabicyclo?2.2.1 heptane-2,3-dicarboxylate (2:1) |
| 54573-75-0 | 1-alpha-Hydroxyergocalciferol |
| 58-36-6 | 10, 10′-Oxybisphenoxarsine |
| 71317-73-2 | (Z,Z)-11,13-Hexadecadienal |
| 35153-18-5 | 11-Tetradecen-1-ol, (E)- |
| 33189-72-9 | (E)-11-Tetradecen-1-ol acetate |
| 56709-13-8 | 1H,3H,5H,-Oxazolo(3,4-c)oxazole, |
| | poly(oxymethylene) deriv. |
| 60207-93-4 | 1H-1,2,4-Triazole, 1-((2-(2,4-dichlorophenyl)- |
| | 4-ethyl-1,3-dioxolan-2-yl)methyl)- |
| 116255-48-2 | 1H-1,2,4-Triazole, 1-((4-bromo-2-(2,4- |
| | dichlorophenyl)tetrahydro-2-furanyl)methyl)- |
| 66246-88-6 | 1H-1,2,4-Triazole, 1-(2-(2,4-dichlorophenyl)pentyl)- |
| 94-82-6 | 2,4-DB |
| 2224-44-4 | 4-(2-Nitrobutyl)morpholine |
| 2032-59-9 | 4-(Dimethylamino)-3-methylphenyl methylcarbamate |
| 26952-20-5 | 4-Amino-3,5,6-trichloropicolinic acid, isooctyl ester |
| 35832-11-2 | 4-Amino-3,5,6-trichloropicolinic acid, triethylamine salt |
| 63-74-1 | 4-Aminobenzenesulfonamide |
| 504-24-5 | 4-Aminopyridine |
| 5137-36-0 | 4-Bromoacetoxymethyl-m-dioxolane |
| 13347-42-7 | 4-Chloro-2-cyclopentylphenol |
| 35471-38-6 | 4-Chloro-2-cyclopentylphenol, potassium salt |
| 59-50-7 | 4-Chloro-3-cresol |
| 122-88-3 | 4-CPA |
| 2227-13-6 | 4-Chlorophenyl 2,4,5-trichlorophenyl sulfide |
| 31717-87-0 | 4-Cyclododecyl-2,6-dimethylmorpholine acetate |
| 108-10-1 | 4-Methyl-2-pentanone |
| 100-02-7 | 4-Nitrophenol |
| 80-46-6 | 4-tert-Amylphenol |
| 98-54-4 | 4-tert-Butylphenol |
| 53404-19-6 | Bromacil, lithium salt |
| 69484-12-4 | 5-Bromo-3-sec-butyl-6-methyluracil, sodium salt |
| 26172-55-4 | 5-Chloro-2-methyl-3(2H)-isothiazolone |
| 57373-19-0 | 5-Chloro-2-methyl-3(2H)-isothiazolone, |
| | calcium chloride complex |
| 55965-87-2 | 5-Chloro-2-methyl-4-isothiazolin-3-one |
| | calcium chloride with 2-methyl-4-isothazolin-3- |
| | one calcium chloride |
| 56578-18-8 | 5-Decen-1-ol, (E)- |
| 38421-90-8 | 5-Decen-1-ol, acetate, (E)- |
| 104-67-6 | gamma-Undecalactone |
| 59720-42-2 | 5-Hydroxymethoxymethyl-1-aza-3,7- |
| | dioxabicyclo(3.3.<BR>0)octane |
| 6542-37-6 | 5-Hydroxymethyl-1-aza-3,7- |
| | dioxabicyclo(3.3.0)octan<BR>e |
| 67403-00-3 | 5-Isothiazolecarboxylic acid, 3,4-dichloro-, potassium salt |
| 28401-39-0 | 6,8-Dioxabicyclo(3.2.1)octane, 1,5-dimethyl-, (1S)- |
| 59014-03-8 | 6,8-Dioxabicyclo(3.2.1)octane, |
| | 5-ethyl-2,4-dimethyl-, (1S-(endo,endo))- |
| 8063-85-2 | 6-(and 2)-Chloro-3,4-xylyl methylcarbamate |
| 18128-17-1 | 6-Chloro-2-phenylphenol, potassium salt |
| 29868-16-4 | 6-Dodecen-1-ol, acetate, (E)- |
| 16974-12-2 | 6-Dodecen-1-ol, acetate, (Z)- |
| 50933-33-0 | 7,11-Hexadecadien-1-ol, acetate |
| 53042-79-8 | 7,11-Hexadecadien-1-ol, acetate, (E,Z)- |
| 52207-99-5 | 7,11-Hexadecadien-1-ol, acetate, (Z,Z)- |
| | 7-Oxabicyclo(2.2.1)heptane-2,3-dicarboxylic |
| | acid, compd with N,N-dimethylcocamine |
| | (1:2) |
| 2536-27-8 | 7-Oxabicyclo(2.2.1) heptane-2,3-dicarboxylic |
| | acid, compd. with N,N-dimethyl-1- |
| | tridecaneamine (1:1) |
| 129-67-9 | 7-Oxabicyclo(2.2.1)heptane-2,3-dicarboxylic |
| | acid, disodium salt |
| | 7-Oxabicyclo(2.2.1) heptane-2,3- |
| | dicarboxylic acif, dihydroxyaluminum salt |
| 148-24-3 | 8-Quinolinol |
| 7091-57-8 | 8-Quinolinol benzoate |
| 134-30-5 | 8-Quinolinol citrate |
| 134-31-6 | 8-Quinolinol sulfate |
| 84-65-1 | Anthraquinone |
| 67-97-0 | Cholecalciferol |
| 41294-56-8 | 9,10-Secocholesta-5,7,10(19)-triene-1,3-diol, |
| | (1.alpha.,3.beta.,5Z,7E)- |
| 31654-77-0 | (Z,E)-9,12-Tetradecadien-1-ol acetate |
| 67601-10-9 | 9-Decen-1-ol, 3-methyl-6- |
| | (1-methylethenyl)-acetate, (3S,6S)- |
| 67601-06-3 | 9-Decen-1-ol, 3-methyl-6-(1-methylethenyl)-, |
| | acetate.(3S,6R)- |
| 35148-19-7 | (E)-9-Dodecen-1-ol acetate |
| 16974-11-1 | 9-Dodecenyl acetate, (Z)- |
| 22968-84-9 | 9-Octadecen-1-amine, N,N-dimethyl-, (Z)-, acetate |
| 6458-13-5 | 9-Octadecen-1-aminium, N-ethyl-N,N-dimethyl-, bromide |
| 35153-15-2 | (Z)-9-Tetradecen-1-ol |
| 21634-96-8 | Dichlorflurenol-methyl |
| 53537-63-6 | ?1,1′-Biphenyl-2-ol, 3(or 5)-chloro-, compd. |
| | with 2,2′-iminobis?ethanol (1:1) |
| 10605-11-5 | ?1,1′-Biphenyl-2-ol, 3-chloro-, sodium salt |
| 10605-10-4 | ?1,1′-Biphenyl-2-ol, 5-chloro-, sodium salt |
| 31366-97-9 | ?1,1′-Biphenyl-4-ol, 3-chloro-, sodium salt |
| | A blend of CrylA(c) and CryIC |
| | derived*delta endotoxins of Bacillus thuringiensis |
| | encapsulated in killed pseudomonas |
| | fluorescens (*Patent pending) |
| 71751-41-2 | Abamectin |
| 115096-11-2; | Acephate |
| 30560-19-1 | |
| 58842-20-9 | 2H-1,3-Thiazine, tetrahydro-2-(nitromethylene)- |
| 117-52-2 | 2H-1-Benzopyran-2-one, 3-(1- |
| | (2-furanyl)-3-oxobutyl)-4-hydroxy- |
| 34490-93-2 | 2H-1-Benzopyran-2-one, 3-(1-(2-furanyl)- |
| | 3-oxobutyl)-4-hydroxy-, sodium salt |
| 82633-79-2 | 2H-Cyclopent(d)isothiazol-3(4H)-one, |
| | 5,6-dihydro-2-methyl- |
| 4418-26-2 | 2H-Pyran-2,4(3H)-dione, |
| | 3-acetyl-6-methyl-, ion(1-), sodium |
| 16423-68-0 | 3′,6′-Dihydroxy-2′,4′,5′,7′- |
| | tetraiodospiro(isobenzofuran-1(3H), |
| | 9′-(9H)xanthen)-3-one, |
| | disodium salt |
| 57373-20-3 | 3(2H)-Isothiazolone, 2-methyl-, calcium complex |
| 64359-81-5 | 3(2H)-Isothiazolone, 4,5-dichloro-2-octyl- |
| 87-10-5 | 3,4′, 5-Tribromosalicylanilide |
| 101-20-2 | 3,4,4′-Trichlorocarbanilide |
| 2686-99-9 | 3,4,5-Trimethylphenyl methylcarbamate |
| 18480-53-0 | 3,4-Dichloro-5-isothiazolecarboxylic acid |
| 78-59-1 | 3,5,5-Trimethyl-2-cyclohexen-1-one |
| 76902-90-4 | 3,5,7-Triaza-1-azoniatricyclo(3.3.1.1 |
| | (superscript3,7))decane, 1-methyl-, chloride |
| 51350-84-6 | 3,5,7-Triaza-1-azoniatricyclo(3.3.1.13,7)decane, |
| | 1,1′-(2-butene-1,4-diyl)bis-, dichloride |
| 51229-78-8 | 3,5,7-Triazatricyclo(3.3.1.1 (superscript 3,7))decane, |
| | 1-(3-chloro-2-propenyl)-, chloride, |
| | (Z)- |
| 4776-06-1 | 3,5-Dibromo-3′-(trifluoromethyl)salicylanilide |
| 3861-41-4 | 3,5-Dibromo-4-hydroxybenzonitrile butyrate |
| 2577-72-2 | 3,5-Dibromosalicylanilide |
| 57754-85-5 | Clopyralid, monoethanolamine salt |
| 16655-82-6 | 3,7-Benzofurandiol, 2,3-dihydro-2,2-dimethyl-, |
| | 7-(methylcarbamate) |
| 672-04-8 | 3-(1-Ethylpropyl)phenyl methylcarbamate |
| 2282-34-0 | 3-(1-Methylbutyl)phenyl methylcarbamate |
| 66-81-9 | 3-(2-(3,5-Dimethyl-2-oxocyclohexyl)- |
| | 2-hydroxyethyl<BR>)glutarimide |
| 140-41-0 | 3-(4-Chlorophenyl)-1,1-dimethylurea trichloroacetate |
| 68187-63-3 | 3-Alkoxy *-2-hydroxypropyl trimethyl |
| | ammonium chloride *(100% C12-C15 as in linear, |
| | primary alcohol) |
| 127-41-3 | 3-Buten-2-one, 4-(2,6,6-trimethyl- |
| | 2-cyclohexen-1-yl)-, (E)- |
| 55720-26-8 | 3-Butenoic acid, 2-amino-4-(2-aminoethoxy)-, |
| | monohydrochloride, (S-(E))- |
| 1928-48-9 | 3-Butoxypropyl 2,4,5-trichlorophenoxyacetate |
| 95-74-9 | 3-Chloro-4-methylbenzenamine |
| 14979-39-6 | 3-Heptanol, 4-methyl- |
| 50723-80-3 | Sodium bentazon |
| | 3-Ketopetromyzonol sulfate |
| 1193-18-6 | 3-Methyl-2-cyclohexen-1-one |
| 4482-55-7 | 3-Phenyl-1,1-dimethylurea trichloroacetate |
| 104-54-1 | 3-Phenyl-2-propenol |
| 104098-49-9 | Imazapic-ammonium |
| 81052-29-1 | 3-Pyridinecarboxylic acid, 2-(4-chlorophenyl)- |
| | 1-ethyl-1,4-dihydro-6-methyl-4-oxo-, |
| | potassium salt |
| 109293-98-3 | Diflufenzopyr-sodium |
| 81335-47-9 | 3-Quinolinecarboxylic acid, 2-(4,5-dihydro- |
| | 4-methyl-4-(1-methylethyl)-5-oxo-1H- |
| | imidazol-2-yl)-, monoammonium salt |
| 81335-46-8 | 3-Quinolinecarboxylic acid, 2-(4,5-dihydro- |
| | 4-methyl-4-(1-methylethyl)-5-oxo-1H- |
| | imidazol-2-yl)-, monosodium salt |
| 1192-52-5 | 3H-1,2-Dithiol-3-one, 4,5-dichloro- |
| 21962-62-9 | 3H-2-Benzopyran-3-one, octahydro- |
| 87-12-7 | 4′,5-Dibromosalicylanilide |
| 80-06-8 | 4,4′-Dichloro-a-methylbenzhydrol |
| 51200-87-4 | 4,4-Dimethyloxazolidine |
| 20679-58-7 | Acetic acid, bromo-, 2-butene-1,4-diyl ester |
| 2514-53-6 | Acetic acid, trichloro-, 1,2-ethanediyl ester |
| 16094-02-3 | Acetic acid, trichloro-, magnesium salt |
| 112143-82-5 | Acetic acid, {{1-{(dimethylamino)carbonyl}- |
| | 3-(1,1-dimethylethyl)-1H-1,2,4-triazol-5- |
| | yl}thio}-, ethyl ester |
| 34256-82-1 | Acetochlor |
| 67-64-1 | Acetone (Data submitter rights) |
| 50-78-2 | Acetylsalicylic acid |
| 2650-18-2 | Acid Blue 9 |
| 50594-66-6 | Acifluorfen |
| 107-02-8 | Acrolein |
| 107-13-1 | Acrylonitrile |
| | Agrobacterium radiobacter (strain K84) |
| | Agrobacterium radiobacter strain K1026 |
| | Agrobacterium vitis strain F2/5 |
| 15972-60-8 | Alachlor |
| | Alcohols, C6, C8 & C10, ethoxylated, |
| | propoxylated mix with alcohols, C12-15, |
| | ethoxylated |
| 68603-15-6 | Alcohols, C6-12 |
| 116-06-3 | Aldicarb |
| 1646-88-4 | Aldoxycarb |
| 64742-89-8 | Aliphatic petroleum solvent |
| 8048-12-2 | Alkanol* amine dinoseb ( 2-sec-butyl- |
| | 4,6-dinitrophenol ) *(salts of the ethanol and |
| | isoprapanol series) |
| 68391-11-7 | Alkyl pyridines |
| | Alkyl(C12-C15) poly(oxypropylene)poly(oxyethylene)- |
| | iodine complex |
| | Alkyl* (ethyl cycloimidinium) 3-hydroxy-3-ethyl |
| | sodium alcoholate, 2-methyl sodium |
| | carboxylate-tridecyl polyoxyethylene |
| | ethanol-iodine complex *(100% C12) |
| | Alkyl* N,N-bis(2-hydroxyethyl)amine *(100% C8-C18) |
| 91745-52-7 | Alkyl* amine hydrochloride *(as in |
| | fatty acids of coconut oil) |
| | Alkyl* bis(2-hydroxyethyl) amine acetate |
| | *(65% C18, 30% C16, 5% C14) |
| 61791-31-9 | Alkyl* bis(2-hydroxyethyl) ammonium |
| | acetate *(as in fatty acids of coconut oil) |
| 68424-92-0 | Alkyl* trimethyl ammonium bromide |
| | *(67% C16, 30% C14, 3% C12-C18) |
| 1119-97-7 | Alkyl* trimethyl ammonium bromide |
| | *(95% C14, 5% C16) |
| 112-00-5 | Alkyl* trimethyl ammonium chloride |
| | *(70% C12, 30% C14) |
| 68002-63-1 | Alkyl* trimethyl ammonium chloride |
| | *(70% C18, 27% C16, 3% C14) |
| 68002-62-0 | Alkyl* trimethyl ammonium chloride |
| | *(90% C18, 10% C16) |
| 61790-41-8 | Alkyl* trimethyl ammonium chloride |
| | *(alkyl as in fatty acids of soybean oil) |
| 61789-18-2 | Alkyl* trimethyl ammonium chloride |
| | *(as in fatty acids of coconut oil) |
| 68002-61-9 | Alkyl* trimethyl ammonium chloride |
| | *derived from cottonseed oil |
| | Alkyl *-5-hydroxy-4-oxo-2(4H)-pyranylmethyl |
| | dimethyl ammonium chloride *(49% C12, |
| | 17% C14, 17% C10, 10% C18, 9% C16, 8% C8) |
| 71786-60-2 | Alkyl *-N,N-bis(2-hydroxyethyl)amine |
| | *(100% C12-C18) |
| 70750-47-9 | Alkyl *-N,N-bis(2-hydroxyethyl)methyl |
| | ammonium chloride *(53% C12, 19% C14, 8.5% |
| | C16, 7.0% C8, 6.5% C10, 6.0% C18) |
| 68425-47-8 | Alkyl *-N,N-di(hydroxyethyl)amine |
| | *(as in fatty acids of soybean oil) |
| 68526-65-8 | Alkyl *-diamine monobenzoate |
| | *(as in fatty acids of coconut oil) |
| 68919-17-5 | Alkylated aromatic petroleum oil |
| 97-59-6 | Allantoin |
| 584-79-2 | Allethrin |
| 137-98-4; | Allethrin Coil |
| 18793-35-6; | |
| 18877-88-8; | |
| 20301-61-5; | |
| 207562-36-5; | |
| 22431-63-6; | |
| 22467-86-3; | |
| 22556-34-9; | |
| 23453-08-9; | |
| 24313-23-3; | |
| 25406-22-8; | |
| 25406-24-0; | |
| 25406-25-1; | |
| 28057-48-9; | |
| 28434-00-6; | |
| 28991-27-7; | |
| 34624-48-1; | |
| 3972-20-1; | |
| 42534-61-2; | |
| 584-79-2; | |
| 6385-67-7; | |
| 6385-68-8; | |
| 71119-51-2; | |
| 71211-88-6; | |
| 8018-12-0; | |
| 84030-86-4 | |
| 107-18-6 | Allyl alcohol (No longer approved for nonfood use) |
| | Alternaria cassiae |
| | Alternaria destruens strain 059 |
| | Aluminum 3,6-dichloro-o-anisate |
| 7446-70-0 | Aluminum chloride |
| 20859-73-8 | Aluminum phosphide |
| 7429-90-5 | Aluminum powder |
| 10043-01-3 | Aluminum sulfate |
| 834-12-8 | Ametryn |
| 129909-90-6 | Amicarbazone |
| 40164-67-8 | Amidochlor |
| 70592-80-2 | Amines, C10-16-alkyldimethyl, N-oxides |
| 68213-26-3 | Amines, tallow alkyl, ethoxylated propoxylated |
| 33089-61-1 | Amitraz |
| 61-82-5 | Amitrole |
| 7664-41-7 | Ammonia |
| 25545-89-5 | Ammonium 1-naphthaleneacetate |
| 53404-90-3 | Ammonium 2,3,6-trichlorophenylacetate |
| 1076-46-6 | Ammonium 3-amino-2,5-dichlorobenzoate |
| 7784-25-0 | Ammonium alum |
| 13462-93-6 | Ammonium arsenate |
| 12124-97-9 | Ammonium bromide |
| 506-87-6 | Ammonium carbonate |
| 12125-02-9 | Ammonium chloride |
| 6365-83-9 | Ammonium dinoseb ( 2-sec-butyl-4,6-dinitrophenol ) |
| 7379-26-2 | Ammonium ethylenediaminetetraacetate |
| 16919-19-0 | Ammonium fluosilicate (No longer |
| | approved for nonfood use) |
| 22228-82-6 | Ammonium isobutyrate |
| 2235-54-3 | Ammonium lauryl sulfate |
| 6484-52-2 | Ammonium nitrate |
| 544-60-5 | Ammonium oleate |
| 1113-38-8 | Ammonium oxalate |
| 9080-17-5 | Ammonium polysulfides |
| 101917-66-2 | Imazethapyr, ammonium salt |
| 84776-33-0 | Ammonium soaps of fatty acids |
| 7773-06-0 | Ammonium sulfamate |
| 7783-20-2 | Ammonium sulfate |
| 7783-18-8 | Ammonium thiosulfate |
| | Ampelomyces quisqualis isolate M-10 |
| 628-63-7 | Amyl acetate |
| | Anagrapha falcifera multi-nuclear polyhedrosis |
| | virus polyhedral inclusion bodies in |
| | aqueous suspension |
| 12771-68-5 | Ancymidol |
| 1249-84-9 | Androst-5-en-3-ol, 17-((3- |
| | (dimethylamino)propyl)methyl)amino)-, dihydrochloride, |
| | (3.beta., 17.beta.)- |
| 53-41-8 | Androsterone |
| | Animal gland extract (lion urine) |
| 65996-91-0 | Anthracene oil |
| 28300-74-5 | Antimony potassium tartrate (No longer approved for use) |
| 1397-94-0 | Antimycin A |
| 68477-31-6 | Aromatic petroleum solvent |
| 7778-39-4 | Arsenic acid |
| 7778-44-1 | Arsenic acid (H3AsO4), calcium salt (2:3) |
| 7784-40-9 | Arsenic acid (H3AsO4), lead(2+) salt (1:1) |
| 1327-53-3 | Arsenic oxide (As2O3) |
| 1303-28-2 | Arsenic oxide (As2O5) |
| 98-50-0 | Arsonic acid, (4-aminophenyl)- |
| 53404-47-0 | Arsonic acid, methyl-, compd. with 1-docecanamine (1:1) |
| | Arthrobotrys amerospora |
| 1332-21-4 | Asbestos |
| | Aspergillus flavus NRRL 21882 |
| 8052-42-4 | Asphalt |
| 3337-71-1 | Asulam |
| 2302-17-2 | Asulam, sodium salt |
| 11121-31-6; | Atrazine |
| 12040-45-8; | |
| 12797-72-7; | |
| 1912-24-9; | |
| 39400-72-1; | |
| 69771-31-9; | |
| 93616-39-8 | |
| 492-80-8 | Auramine |
| 60207-31-0 | Azaconazole |
| 108168-76-9 | Azadirachtin |
| 36476-78-5 | Azetidine-3-carboxylic acid |
| 86-50-0 | Azinphos-Methyl |
| 131860-33-8 | Azoxystrobin |
| 53516-75-9 | BTC 1100 |
| | Bacillus Thuringiensis eCry3.1Ab protein and |
| | the genetic material necessary for its |
| | production (vector pSYN12274) in |
| | Event 5307 corn (SYN-05307-1) |
| | Bacillus cereus strain BP01 |
| | Bacillus licheniformis strain SB3086 |
| | Bacillus megaterium |
| | Bacillus popilliae and B. lentimorbus |
| | Bacillus pumilus strain GB34 |
| | Bacillus pumilus strain QST 2808 |
| | Bacillus subtilis GB03 |
| | Bacillus amyloliquefaciens MBI 600 |
| | (antecedent Bacillus subtilis MBI 600) |
| | Bacillus subtilis var. amyloliquefaciens strain FZB24 |
| 68038-71-1 | Bacillus thuringiensis (Berliner) |
| | Bacillus thuringiensis Cry1A.105 protein |
| | and genetic material necessary (vector PV- |
| | ZMIR245) for its production in corn |
| | Bacillus thuringiensis Cry1Ab protein and |
| | the genetic material (PV-ZMBK07) |
| | necessary for its production in corn event |
| | MON-00810-6; % dry weight |
| | Bacillus thuringiensis Cry1Ab protein and |
| | the genetic material necessary for its |
| | production (pTDL004 or pTDL008) in Event |
| | T303-3 or T304-40 cotton plants |
| | Bacillus thuringiensis Cry1Ac and the genetic |
| | material necessary for its production |
| | (PV-GMIR9) in soybean. |
| | Bacillus thuringiensis Cry1F protein and |
| | the genetic material necessary for its |
| | production (plasmid insert PHI8999) in corn |
| | Bacillus thuringiensis Cry2Ab protein and |
| | the genetic material necessary for its |
| | production (Vector ZMBK28) in corn |
| | Bacillus thuringiensis Cry2Ab protein and |
| | the genetic material necessary for its |
| | production (vector GHBK11) in cotton |
| | Bacillus thuringiensis Cry2Ab2 protein and |
| | the genetic material necessary (vector PV- |
| | ZMIR245) for its production in corn |
| | Bacillus thuringiensis Cry2Ae protein and |
| | the genetic material necessary for its |
| | production (pTEM 12) in event GHB119 |
| | or GHB714 cotton seeds. |
| | Bacillus thuringiensis Cry34Ab1 and |
| | Cry35Ab1 proteins and the genetic material |
| | necessary for their production in corn |
| | Bacillus thuringiensis Cry3Bb protein |
| | and the genetic material necessary for its |
| | production (Vector ZMIR 12L) in corn |
| | Bacillus thuringiensis Cry3B1 protein and |
| | the genetic material necessary for its |
| | production (Vector ZMIR 13L) in corn |
| | Bacillus thuringiensis Cry3Bb protein and |
| | the genetic material necessary for its |
| | production (Vector ZMIR 14L) in corn |
| | Bacillus thuringiensis Cry3Bb1 protein and |
| | the genetic material necessary (vector |
| | ZMIR39) for its production in corn |
| | Bacillus thuringiensis CrylA(b) delta-endotoxin |
| | and the genetic material necessary for |
| | its production (plasmid vector pZ01502) in |
| | corn, when used as a plant pesticide in all |
| | raw agricultural commodities of field corn, |
| | sweet corn and popcorn. |
| | Bacillus thuringiensis FLCry1Ab protein and |
| | the genetic material necessary for its |
| | production (vector pNOV4641/pNOV1914) |
| | in Event COT67B cotton (SYN-IR67B-1) |
| | Bacillus thuringiensis VIP3A protein and |
| | the genetic material necessary for its |
| | production (pCOT1 in cotton) |
| | Bacillus thuringiensis Vip3Aa19 protein and |
| | the genetic material necessary for its |
| | production (vector pCOT1) in Event COT102 |
| | cotton (SYN-IR102-7) |
| | Bacillus thuringiensis Vip3Aa20 protein encoded |
| | by vector pNOV1300 in event MIR162 |
| | corn (SYN-IR162-4), % dw |
| | Bacillus thuringiensis moCry 1F insecticidal |
| | protein and the genetic material necessary |
| | for its production in maize |
| | Bacillus thuringiensis serovar japonensis strain buibui |
| | Bacillus thuringiensis sub. kurstaki strain |
| | EG7673 Coleopteran active toxin |
| | Bacillus thuringiensis sub. kurstaki strain |
| | EG7673 Lepidopteran active toxin |
| 68038-71-1 | Bacillus thuringiensis subsp. aizawai |
| | Bacillus thuringiensis subsp. aizawai strain GC-91 |
| | Bacillus thuringiensis aizawai strain NB200 |
| 68038-71-1 | Bacillus thuringiensis subsp. israelensis |
| 68038-71-1 | Bacillus thuringiensis subsp. kurstaki |
| | Bacillus thuringiensis subsp. kurstaki CrylA |
| | (c) delta-endotoxin and the genetic |
| | material necessary for its production in corn |
| | Bacillus thuringiensis subsp. kurstaki delta |
| | endotoxin protein as produced by the CryIIA |
| | gene and its controlling sequences in cotton |
| | Bacillus thuringiensis subsp. kurstaki strain BMP123 |
| | Bacillus thuringiensis subsp. kurstaki strain EG2348 |
| | Bacillus thuringiensis subsp. kurstaki strain EG2371 |
| | Bacillus thuringiensis subsp. kurstaki strain EG2424 |
| | Bacillus thuringiensis subsp. kurstaki strain HD1 |
| | delta-endotoxin as produced in corn |
| | by a cry1A(b) gene and its controlling sequences |
| | Bacillus thuringiensis subsp. kurstaki, delta-endotoxin |
| | as produced in corn by an HD-1 |
| | gene, and its controlling sequences and found |
| | on plasmid vector, pZO1502. |
| | Bacillus thuringiensis subsp. morrisoni, lepidopteran active |
| | Bacillus thuringiensis subsp. san diego |
| 68038-71-1 | Bacillus thuringiensis subsp. tenebrionis |
| | Bacillus thuringiensis subsp. tolworthi |
| | Cry9C protein and the genetic material |
| | necessary for its production (pRVA9909) in corn plants |
| 91721-81-2 | Alkyl* bis(2-hydroxyethyl)benzyl ammonium |
| | chloride *(57% C10, 20% C12, 11% C14, |
| | 9% C18, 2% C16, 1% C8) |
| 97926-10-8 | Alkyl* diethanolamide *(70% C12, 30% C14) |
| 102-30-7 | Alkyl* dimethyl 3,4-dichlorobenzyl |
| | ammonium chloride *(100% C12) |
| | Alkyl* dimethyl 3,4-dichlorobenzyl ammonium |
| | chloride *(42% C12, 27% C14, 13% |
| | C16, 18% C8-C18) |
| 8023-53-8 | Alkyl* dimethyl 3,4-dichlorobenzyl ammonium |
| | chloride *(50% C12, 30% C14, 17% C16, |
| | 3% C18) |
| 68989-02-6 | Alkyl* dimethyl 3,4-dichlorobenzyl ammonium |
| | chloride *(50% C14, 40% C12, 10% C16) |
| 92129-28-7 | Alkyl* dimethyl 3,4-dichlorobenzyl ammonium |
| | chloride *(55% C14, 23% C12, 20% C16, |
| | 2% C18) |
| 68989-02-6 | Alkyl* dimethyl 3,4-dichlorobenzyl ammonium |
| | chloride *(60% C12, 25% C14, 15% C16) |
| 68989-02-6 | Alkyl* dimethyl 3,4-dichlorobenzyl ammonium |
| | chloride *(63% C12, 23% C14, 14% |
| | C16) |
| 92129-28-7 | Alkyl* dimethyl 3,4-dichlorobenzyl ammonium |
| | chloride *(65% C12, 22% C14, 10% C16, |
| | 3% C18) |
| 68989-02-6 | Alkyl* dimethyl 3,4-dichlorobenzyl ammonium |
| | chloride *(90% C14, 5% C16, 5% C12) |
| | Alkyl* dimethyl 3,4-dichlorobenzyl ammonium chloride |
| | polyethoxypolypropoxypolyethoxyethanol- |
| | iodine complex *(50% C12, 30% C14, |
| | 17% C16, 3% C18) |
| 63449-41-2 | Alkyl* dimethyl benzyl ammonium chloride *(C8-18) |
| 139-08-2 | Alkyl* dimethyl benzyl ammonium chloride *(100% C14) |
| 122-18-9 | Alkyl* dimethyl benzyl ammonium chloride *(100% C16) |
| 68424-85-1 | Alkyl* dimethyl benzyl ammonium chloride |
| | *(40% C12, 40% C14, 20% C16) |
| 68391-01-5 | Alkyl* dimethyl benzyl ammonium chloride |
| | *(41% C14, 28% C12, 19% C18, 12% C16) |
| | Alkyl* dimethyl benzyl ammonium chloride |
| | *(47% C12, 18% C14, 15% (C5-C15), |
| | 10% C18, 10% C16) |
| 8001-54-5 | Alkyl* dimethyl benzyl ammonium chloride |
| | *(50% C12, 30% C14, 17% C16, 3% C18) |
| 68424-85-1 | Alkyl* dimethyl benzyl ammonium chloride |
| | *(50% C14, 40% C12, 10% C16) |
| 68424-85-1 | Alkyl* dimethyl benzyl ammonium chloride |
| | *(58% C14, 28% C16, 14% C12) |
| 68424-85-1 | Alkyl* dimethyl benzyl ammonium chloride |
| | *(60% C14, 30% C16, 10% C12) |
| 68424-85-1 | Alkyl* dimethyl benzyl ammonium chloride |
| | *(60% C14, 25% C12, 15% C16) |
| 53516-76-0 | Alkyl* dimethyl benzyl ammonium chloride |
| | *(60% C14, 30% C16, 5% C18, 5% C12) |
| 61789-71-7 | Alkyl* dimethyl benzyl ammonium chloride |
| | *(61% C12, 23% C14, 11% C16, 2.5% C18 |
| | 2.5% C10 and trace of C8) |
| 68391-01-5 | Alkyl* dimethyl benzyl ammonium chloride |
| | *(61% C12, 23% C14, 11% C16, 5% C18) |
| 68424-85-1 | Alkyl* dimethyl benzyl ammonium chloride |
| | *(65% C12, 23% C14, 12% C16) |
| 68424-85-1 | Alkyl* dimethyl benzyl ammonium chloride |
| | *(65% C12, 25% C14, 10% C16) |
| 63449-41-2 | Alkyl* dimethyl benzyl ammonium chloride |
| | *(67% C12, 24% C14, 9% C10-C18) |
| 68391-01-5 | Alkyl* dimethyl benzyl ammonium chloride |
| | *(67% C12, 25% C14, 7% C16, 1% C18) |
| 63449-41-2 | Alkyl* dimethyl benzyl ammonium chloride |
| | *(67% C12, 25% C14, 7% C16, 1% C8, C10, |
| | and C18) |
| 68424-85-1 | Alkyl* dimethyl benzyl ammonium chloride |
| | *(67% C12, 27% C14, 6% C16) |
| 68424-85-1 | Alkyl* dimethyl benzyl ammonium chloride |
| | *(68% C12, 25% C14, 7% C16) |
| 134058-54-1 | Alkyl* dimethyl benzyl ammonium chloride |
| | *(70% C12, 30% C14) |
| 68989-00-4 | Alkyl* dimethyl benzyl ammonium chloride |
| | *(70% C12, 24% C14, 5% C16, 1% C10) |
| 68424-85-1 | Alkyl* dimethyl benzyl ammonium chloride |
| | *(90% C14, 5% C12, 5% C16) |
| 68424-85-1 | Alkyl* dimethyl benzyl ammonium chloride |
| | *(93% C14, 4% C12, 3% C16) |
| 68607-20-5 | Alkyl* dimethyl benzyl ammonium chloride |
| | *(95% C16, 5% C18) |
| 68424-85-1 | Alkyl* dimethyl benzyl ammonium chloride |
| | *(95% C14, 3% C12, 2% C16) |
| 61789-71-7 | Alkyl* dimethyl benzyl ammonium chloride |
| | *(as in fatty acids of coconut oil) |
| 68989-01-5 | Alkyl* dimethyl benzyl ammonium saccharinate |
| | *(50% C14, 40% C12, 10% C16) |
| 63393-87-3 | Alkyl* dimethyl betaines *(46% C12, 24% C14, |
| | 10% C16, 8% C10, 7% C8, 5% C18) |
| 8045-22-5 | Alkyl* dimethyl dimethylbenzyl ammonium |
| | chloride *(50% C12, 30% C14, 17% C16, |
| | 3% C18) |
| 134595-54-3 | Alkyl* dimethyl ethyl ammonium bromide |
| | *(85% C16, 15% C18) |
| 68527-84-4 | Alkyl* dimethyl ethyl ammonium bromide |
| | *(90% C14, 5% C16, 5% C12) |
| 61788-99-6 | Alkyl* dimethyl ethyl ammonium bromide |
| | *(mixed alkyl and alkenyl groups as in fatty |
| | acids of soybean oil) |
| 8045-21-4 | Alkyl* dimethyl ethylbenzyl ammonium |
| | chloride *(50% C12, 30% C14, 17% C16, |
| | 3% C18) |
| 68956-79-6 | Alkyl* dimethyl ethylbenzyl ammonium |
| | chloride *(60% C14, 30% C16, 5% C12, 5% C18) |
| 85409-23-0 | Alkyl* dimethyl ethylbenzyl ammonium |
| | chloride *(68% C12, 32% C14) |
| 37335-68-5 | Alkyl* dimethyl ethylbenzyl ammonium |
| | cyclohexylsulfamate *(50% C12, 30% C14, |
| | 17% C16, 3% C18) |
| | Alkyl* dimethyl isopropylbenzyl ammonium |
| | chloride *(50% C12, 30% C14, 17% C16, |
| | 3% C18) |
| | Alkyl* dipropoxyamine *(47% C12, 18% |
| | C14, 10% C18, 9% C10, 8% C16, 8% C8) |
| 87175-02-8 | Alkyl* dodecylbenzyl dimethyl ammonium |
| | chloride *(70% C12, 30% C14) |
| 71820-38-7 | Alkyl* methyl isoquinolinium chloride |
| | *(55% C14, 12% C12, 17% C16, 3% C18) |
| 68140-00-1 | Alkyl* monoethanolamide |
| | *(as in fatty acids of coconut oil) |
| | Alkyl* poly(oxypropylene)poly(oxyethylene)- |
| | iodine complex *(43% C10, 30% C14, |
| | 12% C12, 10% C16, 5% C18) |
| 68411-30-3 | Alkyl* sodium benzene sulfonate |
| | *(56% C11, 33% C12, 7% C10, 4% C13) |
| 57960-19-7 | Acequinocyl |
| | Acetalized polyvinyl alcohol complexed with iodine |
| 63114-77-2 | Acetamide, 2-chloro-N-(2,3- |
| | dimethylphenyl)-N-(1-methylethyl)- |
| 53780-36-2 | Mefluidide, diethanolamine salt |
| 38827-31-5 | Acetamide, N-(4-methyl-3- |
| | (((trifluoromethyl)sulfonyl)amino)phenyl)-, |
| | compd. with 2,2′- |
| | iminobis(ethanol) (1:1) |
| 103-90-2; | Acetaminophen |
| 8055-08-1 | |
| 135410-20-7 | Acetamiprid |
| 64700-56-7 | Triclopyr, butoxyethyl ester |
| 60825-27-6 | Acetic acid, ((3,5,6-trichloro-2-pyridinyl)oxy)-, ethyl ester |
| 1928-47-8 | Acetic acid, (2,4,5-trichlorophenoxy)-, 2-ethylhexyl ester |
| 53404-87-8 | Acetic acid, (2,4,5-trichlorophenoxy)-, |
| | compd. with (Z)-N-9-octadecenyl-1,3- |
| | propanediamine (1:1) |
| 53404-84-5 | Acetic acid, (2,4,5-trichlorophenoxy)-, |
| | compd. with 1-dodecanamine (1:1) |
| 53535-37-8 | Acetic acid, (2,4,5-trichlorophenoxy)-, |
| | compd. with 1-tetradecanamine |
| 53535-36-7 | Acetic acid, (2,4-dichlorophenoxy)-, compd. |
| | with (Z)-N,N-dimethyl-9-octadecen-1- |
| | amine (1:1) |
| 55256-32-1 | Acetic acid, (2,4-dichlorophenoxy)-, compd. |
| | with (Z,Z)-N,N-dimethyl-9,12- |
| | octadecadien-1-amine (1:1), mixt. with (Z)- |
| | N,N-dimethyl-9-octadecen-1-amine (2,4- |
| | dichlorophenoxy)acetate |
| 6365-72-6 | Acetic acid, (2,4-dichlorophenoxy)-, compd. |
| | with 1-amino-2-propanol (1:1) |
| 37102-63-9 | Acetic acid, (2,4-dichlorophenoxy)-, compd. |
| | with 1-heptanamine (1:1) |
| 2569-01-9 | Acetic acid, (2,4-dichlorophenoxy)-, compd. |
| | with 2,2′,2″-nitrilotris(ethanol) (1:1) |
| 3599-58-4 | Acetic acid, (2,4-dichlorophenoxy)-, compd. |
| | with 2-aminoethanol (1:1) |
| 2646-78-8 | Acetic acid, (2,4-dichlorophenoxy)-, compd. |
| | with N,N-diethylethanamine (1:1) |
| 20940-37-8 | Acetic acid, (2,4-dichlorophenoxy)-, compd. |
| | with N-ethylethanamine (1:1) |
| 6365-73-7 | Acetic acid, (2,4-dichlorophenoxy)-, |
| | compd. with morpholine (1:1) |
| 26544-20-7 | MCPA, isooctyl ester |
| 17601-49-9 | Benzoic acid, 2,3,5-triiodo-, compd. |
| | with N-methylmethanamine (1:1) |
| 132-66-1 | Benzoic acid, 2-((1-naphthalenylamino)carbonyl)- |
| 134-20-3 | Methyl anthranilate |
| 134605-64-4 | Benzoic acid, 2-chloro-5-[3,6-dihydro-3- |
| | methyl-2,6-dioxo-4-(trifluoromethyl)-1 (2H)- |
| | pyrimidinyl]-, 1,1-dimethyl-2-oxo-2- |
| | (2-propenyloxy)ethyl ester |
| 7491-21-6 | Benzoic acid, 2-hydroxy-, compd. |
| | with 1-dodecanamine (1:1) |
| 144651-06-9 | Benzoic acid, 2-{{{{(4,6-dimethyl-2- |
| | pyrimidinyl)amino}carbonyl}amino}sulfonyl}-, 3- |
| | oxetanyl ester |
| 25059-78-3 | Benzoic acid, 3,6-dichloro-2-methoxy-, |
| | compd with 2,2′-iminobis(ethanol) (1:1) |
| 104040-79-1 | Dicamba, diglycolamine salt |
| 55871-02-8 | Dicamba, isopropylamine salt |
| 2300-66-5 | Dicamba, dimethylamine salt |
| 10007-85-9 | Dicamba, potassium salt |
| 147150-35-4 | Cloransulam-methyl |
| 80-13-7 | Benzoic acid, 4-((dichloroamino)sulfonyl)- |
| 136-47-0 | Benzoic acid, 4-(butylamino)-, |
| | 2-(dimethylamino)ethyl ester, monohydrochloride |
| 112226-61-6 | Halofenozide |
| 62476-59-9 | Sodium acifluorfen |
| 94-36-0 | Benzoyl peroxide (No longer approved for inert use) |
| 100-51-6 | Benzyl alcohol |
| 120-51-4 | Benylate |
| 5437-45-6 | Benzyl bromoacetate |
| 3734-33-6 | Benzyl diethyl ((2,6- |
| | xylylcarbamoyl)methyl) ammonium benzoate |
| 7006-60-2 | Benzyl tris(2-hydroxyethyl) ammonium chloride |
| 1214-39-7 | Benzyladenine |
| 8007-75-8 | Bergamot oil |
| 25655-41-8 | Betadine |
| 163269-30-5 | Bethoxazin |
| 124-76-5 | Bicyclo{2.2.1}heptan-2-ol, 1,7,7-trimethyl-, exo- |
| 149877-41-8 | Bifenazate |
| 42576-02-3 | Bifenox |
| 82657-04-3 | Bifenthrin |
| 28434-01-7 | Bioresmethrin |
| 92-52-4 | Biphenyl |
| 7437-35-6 | Bis(tributyltin) adipate |
| 12379-54-3 | Bis(tributyltin) dodecenylsuccinate |
| 4644-96-6 | Bis(tributyltin) succinate |
| 4808-30-4 | Bis (tributyltin) sulfide |
| 3064-70-8 | Bis(trichloromethyl) sulfone |
| 1067-29-4 | Bis(tripropyltin) oxide |
| 125401-92-5 | Bispyribac-sodium |
| 8052-42-4 | Bitumen |
| 8001-85-2 | Bone oil |
| 1303-96-4 | Borax (B4Na2O7.10H2O) |
| 10043-35-3 | Boric acid |
| 214710-34-6 | Boric acid (H3BO3), polymer with |
| | N-decyl-1-decanamine, oxirane and 1,2-propanediol |
| 7775-19-1 | Boric acid (HBO2), sodium salt |
| 12040-58-3 | Boric acid, calcium salt |
| 1303-86-2 | Boric oxide |
| 76-49-3 | Bornyl acetate |
| 1330-43-4 | Boron sodium oxide (B4Na2O7) (1330-43-4) |
| 12179-04-3 | Boron sodium oxide (B4Na2O7), pentahydrate |
| 12008-41-2 | Boron sodium oxide (B8Na2O13) (12008-41-2) |
| 12280-03-4 | Boron sodium oxide (B8Na2O13), |
| | tetrahydrate (12280-03-4) |
| | Brewer′s yeast extract hydrolysate |
| | from Saccharomyces cerevisiae |
| 56073-10-0 | Brodifacoum |
| 314-40-9 | Bromacil |
| 28772-56-7 | Bromadiolone |
| 63333-35-7 | Bromethalin |
| 7726-95-6 | Bromine |
| 13863-41-7 | Bromine chloride |
| 91112-66-2 | Bromochloro-5-ethyl-5-methyl- |
| | 2,4-imidazolidinedion<BR>e |
| 18181-80-1 | Bromopropylate |
| 1689-84-5 | Bromoxynil |
| 1689-99-2 | Bromoxynil octanoate |
| 52-51-7 | Bronopol |
| 69327-76-0 | Buprofezin |
| | Burkholderia (Pseudomonas) cepacia type |
| | Wisconsin isolate/strain M54 |
| | Burkholderia (pseudomonas) cepacia |
| | type Wisconsin isolate/strain J82 |
| | Burkholderia Cepacia AMMD (Use pc code 006468) |
| | Burkholderia cepacia strain Ral-3 |
| | Burkholderia(Pseudomonas)cepacia strain AMMD |
| 23184-66-9 | Butachlor |
| 868-14-4 | Butanedioic acid, 2,3-dihydroxy- |
| | {R-(R*,R*)}-, monopotassium salt |
| 577-11-7 | Butanedioic acid, sulfo-, 1,4-bis(2-ethylhexyl) |
| | ester, sodium salt |
| 6753-24-8 | Butanoic acid, 4-(2,4-dichlorophenoxy)-, butyl ester |
| 1320-15-6 | Butanoic acid, 4-(2,4-dichlorophenoxy)-, isooctyl ester |
| 56-12-2 | Gamma-aminobutyric acid |
| 53404-82-3 | Butanoic acid, 4-oxo-4-((tributylstannyl)oxy)-, |
| | 1-methylethyl ester |
| 106-31-0 | Butanoic acid, anhydride |
| 34681-23-7 | Butoxycarboxim |
| 32357-46-3 | Butoxyethanol 4-(2,4-dichlorophenoxy)butyrate |
| 2545-59-7 | Butoxyethyl 2,4,5-trichlorophenoxyacetate |
| 53404-31-2 | Butoxyethyl 2-(2,4-dichlorophenoxy)propionate |
| 19480-43-4 | Butoxyethyl 2-methyl-4-chlorophenoxyacetate |
| 9003-13-8 | Stabilene |
| 25537-26-2 | Butoxypropyl silvex |
| 33629-47-9 | Butralin |
| 1713-12-8 | Butyl 2-methyl-4-chlorophenoxyacetate |
| 532-34-3 | Butyl 3,4-dihydro-2,2-dimethyl-4-oxo- |
| | 2H-pyran-6-carboxylate |
| 94-26-8 | Butyl 4-hydroxybenzoate |
| 2008-41-5 | Butylate |
| 128-37-0 | Butylated hydroxytoluene |
| 126-22-7 | Butyric acid ester of dimethyl (2,2,2- |
| | trichloro-1-hydroxyethyl)phosphonate |
| 83542-87-4 | CAS Reg. No. 83542-87-4 ( Propanoic acid, |
| | 3,3-dichloro-, 2-(2-hydroxyethoxy)ethyl |
| | ester ) |
| 75-60-5 | Cacodylic acid |
| 124-65-2 | Cacodylic acid, sodium salt |
| 513-78-0 | Cadmium carbonate |
| 10108-64-2 | Cadmium chloride |
| 4476-04-4 | Cadmium sebacate |
| 141-00-4 | Cadmium succinate |
| 19651-91-3 | Cadmium, (benzenamine)bis(2- |
| | hydroxypropanoato-O1,O2)- |
| 95465-99-9 | Cadusafos |
| 471-34-1 | Calcium carbonate |
| 10137-74-3 | Calcium chlorate |
| 10043-52-4 | Calcium chloride |
| 156-62-7 | Calcium cyanamide |
| 592-01-8 | Calcium cyanide |
| 1305-62-0 | Calcium hydroxide (Ca(OH)2) |
| 7778-54-3 | Calcium hypochlorite |
| 1305-78-8 | Calcium oxide |
| 7179-50-2 | Calcium oxytetracycline |
| 7758-87-4 | Calcium phosphate |
| 4075-81-4 | Calcium propionate |
| 12168-85-3 | Calcium silicate |
| 7778-18-9 | Calcium sulfate |
| | Calcium tetrathiocarbonate |
| 10124-41-1 | Calcium thiosulfate |
| 76-22-2 | Camphor |
| 8008-51-3 | Camphor oil |
| 8007-47-4 | Canadian balsam |
| | Candida oleophila isolate I-182 |
| 120962-03-0 | Canola oil |
| 334-48-5 | Capric acid |
| 136-26-5 | Capric diethanolamide |
| 142-62-1 | Caproic acid |
| 124-07-2 | Caprylic acid |
| 404-86-4 | Capsaicin |
| 2939-80-2 | Captafol |
| 133-06-2 | Captan |
| 51543-98-7 | Carbamic acid, ((4-methyl-1,3- |
| | phenylene)bis(iminocarbonyl-1H-benzimidazole-1,2- |
| | diyl)) bis-, dimethyl ester |
| | Bacillus thuringiensis subsp. israelensis strain EG2215 |
| | Bacillus thuringiensis subspecies kurstaki |
| | strain EG7841 Lepidopteran active toxin |
| | Bacillus thuringiensis subsp. kurstaki strain EG7826 |
| | Bacillus thuringiensis subspecies tenebrionis |
| | delta endotoxin as produced in potato by |
| | Cry IIIA gene and its controlling sequences |
| | and found in the following constructs: PV- |
| | STMT02, PV-STMT04, PV-STMT10, |
| | PV-STMT11, (Continued on qualification) |
| | Bacillus thuringiensis subspecies tenebrionis |
| | delta endotoxin as produced in potato by |
| | Cry IIIA gene and its controlling sequences |
| | and found in the following constructs:PV- |
| | STBT02, PV-STBT04, and PV-STMT01, IR-22, |
| | Bacillus thuringiensis subspecies tenebrionis |
| | delta endotoxin as produced in potato by |
| | Cry IIIA gene and its controlling sequences |
| | and found in the following contructs: |
| | PVSTMT15, PVSTBT02 in combination |
| | with PV-STPY01, IR-22, |
| | Bacillus thuringiensis var. kurstaki Cry1Ac |
| | (synpro) and the genetic material (from |
| | the insert of plasmid pMYC3006) |
| | necessary for its production in cotton |
| | Bacillus thuringiensis var. aizawai Cry1F |
| | (synpro) and the genetic material (from the |
| | insert of plasmid pGMA281) necessary |
| | for its production in cotton |
| | Bacillus thuringiensis var. kurstaki delta endotoxin |
| | protein as produced by the Cry1A(c) |
| | gene and its controlling sequences |
| | Bacillus thuringiensis var. kurstaki |
| | strain M-200 protein toxin |
| | Bacteriophage (from selected Pseudomonas species) |
| 101-27-9 | Barban |
| 513-77-9 | Barium carbonate |
| 13701-59-2 | Barium metaborate (Not selected for InertFinder) |
| 7727-43-7 | Barium sulfate |
| | Barley straw |
| 1332-40-7 | Basic copper chloride |
| 1344-73-6 | Basic copper sulfate |
| 55072-57-6 | Basic copper zinc sulfate complex |
| | Beauveria bassiana ATCC 74040 |
| | Beauveria bassiana strain 447 |
| 22781-23-3 | Bendiocarb |
| 1861-40-1 | Benfluralin |
| 17804-35-2 | Benomyl |
| 83055-99-6 | Bensulfuron-methyl |
| 741-58-2 | Bensulide |
| 25057-89-0 | Bentazon |
| 100-52-7 | Benzaldehyde |
| 122-03-2 | Benzaldehyde, 4-(1-methylethyl)- |
| 64628-44-0 | Benzamide, 2-chloro-N-(((4- |
| | (trifluoromethoxy)phenyl)amino)carbonyl)- |
| 526-18-1 | Benzamide, 2-hydroxy-N-(4-hydroxyphenyl)- |
| 4638-48-6 | Benzamide, 5-chloro-2-hydroxy-N-phenyl- |
| 113036-88-7 | Benzamide, N-(((4-(((((4- |
| | chlorophenyl)cyclopropylmethylene)ami- |
| | no)oxy)methyl)phenyl)amino)carbonyl)-2,6- |
| | difluoro- |
| 103055-07-8 | Lufenuron |
| 71422-67-8 | Benzamide, N-{{{3,5-dichloro-4- |
| | {{3-chloro-5-(trifluoromethyl)-2- |
| | pyridinyl}oxy}phenyl}amino}carbonyl}-2,6-difluoro- |
| 4726-14-1 | Benzenamine, 4-(methylsulfonyl)- |
| | 2,6-dinitro-N,N-dipropyl- |
| 71-43-2 | Benzene |
| 608-73-1 | Benzene hexachloride gamma isomer of |
| | ------------------------------- % other isomers of --- |
| | --------------------------- % |
| 72-56-0 | Benzene, 1,1′-(2,2-dichloroethylidene)bis(4-ethyl- |
| 93-15-2 | Methyleugenol |
| 53905-38-7 | Benzene, 1-(8-methoxy-4,8- |
| | dimethyl(nonyl)-4-(1-methylethyl)- |
| 140-67-0 | p-Allylanisole |
| 145451-07-6 | Benzeneacetamide, 2-?(2,5- |
| | dimethylphenoxy)methylU-.alpha.-(methoxyimino)-N- |
| | methyl- |
| 143390-89-0 | Kresoxim-methyl |
| 69462-13-1 | Benzeneacetic acid, 2,3,6-trichloro-, compd. |
| | with N-methylmethanamine |
| 66267-77-4 | Benzeneacetic acid, 4-chloro-.alpha.-(1-methylethyl)-, |
| | cyano(3-phenoxyphenyl)methyl |
| | ester, (R-R*,S*))- |
| 34911-46-1 | Benzeneethanimidoyl chloride, N,4-dihydroxy-.alpha.-oxo- |
| 100-95-8 | Benzenemathanaminium, N-(2-(dodecylamino)- |
| | 2-oxoethyl)-N,N-dimethyl-, chloride |
| 121-54-0 | Benzenemethanaminium, |
| | N,N-dimethyl-N-(2-(2-(4-(1,1,3,3- |
| | tetramethylbutyl)phenoxy)ethoxy)ethyl)-, chloride |
| 25155-18-4 | Benzenemethanaminium, N,N-dimethyl- |
| | N-(2-(2-(methyl-4-(1,1,3,3- |
| | tetramethylbutyl)phenoxy)ethoxy)ethyl)-, chloride |
| 53466-87-8 | Benzenemethanaminium, |
| | N,N-dimethyl-N-(2-(2-(methylbis(2- |
| | methylpropyl)phenoxy)ethoxy)ethyl)-, |
| | chloride, compd. with (1,1′-biphenyl)-2-ol (1:1) |
| 90823-38-4 | Denatonium saccharide |
| 53404-46-9 | Benzenemethanaminium, N-dodecyl- |
| | N,N,2,4,5-pentamethyl-, chloride |
| 1777-82-8 | Benzenemethanol, 2,4-dichloro- |
| 26856-61-1 | Benzenesulfonic acid, nonyl-, sodium salt |
| 1079-33-0 | Benzo(b)thiophene-4-ol, methylcarbamate |
| 94-09-7 | Benzocaine |
| 65-85-0 | Benzoic acid |
| 786-19-6 | Carbophenothion |
| 55285-14-8 | Carbosulfan |
| 5234-68-4 | Carboxin |
| 68527-99-1 | Carboxymethyl-1,1-ethylcarboxymethyl- |
| | 2-undecylimidazolinium hydroxide, disodium |
| | salt |
| 128639-02-1 | Carfentrazone-ethyl |
| 8001-79-4 | Castor oil |
| 8007-20-3 | Cedar leaf oil |
| 8000-27-9 | Cedarwood oil |
| 9004-32-4 | Cellulose, carboxymethyl ether, sodium salt |
| 66105-29-1 | Cetiol HE |
| 36653-82-4 | Cetyl alcohol |
| 124-03-8 | Cetyl dimethyl ethyl ammonium bromide |
| 140-72-7 | Cetyl pyridinium bromide |
| 123-03-5 | Cetyl pyridinium chloride |
| 57-09-0 | Cetyl trimethyl ammonium bromide |
| 33956-49-9 | CheckMate Technical Pheromone |
| 68602-80-2 | Chevron 100 |
| 1398-61-4 | Chitin |
| | Chitinolytic enzymes |
| 9012-76-4 | Chitosan |
| 127-52-6 | Chloramine B |
| 127-65-1 | Chloramine T |
| 118-75-2 | Chloranil |
| 13360-45-7 | Chlorbromuron |
| 12789-03-6 | Chlordane, technical |
| 6164-98-3 | Chlordimeform |
| 54593-83-8 | Chlorethoxyfos |
| 122453-73-0 | Chlorfenapyr |
| 37339-61-0 | Chlorflurenol, methyl ester |
| 56-95-1 | Chlorhexidine diacetate |
| 7790-93-4 | Chloric acid |
| 90982-32-4 | Chlorimuron |
| 776-19-2 | Chlorinated glycoluril (1,3,4,6- |
| | Tetrachloroglycoluril and related compounds) |
| | Chlorinated levulinic acids ( 45% |
| | minimum chlorine required ) |
| 11084-85-8 | Chlorinated trisodium phosphate |
| 7782-50-5 | Chlorine |
| 10049-04-4 | Chlorine dioxide |
| | Chlorite clay |
| 999-81-5 | Chlormequat chloride |
| 10257-54-2 | Copper sulfate monohydrate |
| 7758-99-8 | Copper sulfate pentahydrate |
| 1111-67-7 | Copper thiocyanate |
| 82027-59-6 | Copper triethanolamine complex |
| 10380-28-6 | Copper, bis(8-quinolinolato-N1,O8)-, |
| 312600-89-8 | Copper, bis[1-cyclohexyl-1,2- |
| | di(hydroxy-.kappa.O)diazeniumato(2-)]- |
| 8001-29-4 | Cottonseed oil |
| 56-72-4 | Coumaphos |
| 61789-28-4 | Creosote oil (Note: Derived from any source) |
| 8021-39-4 | Creosote, wood |
| 1319-77-3 | Cresylic acid, coal tar acids, |
| | coal tar phenols, or coal tar cresols |
| 7700-17-6 | Crotoxyphos |
| 299-86-5 | Crufomate |
| | Cry1F derived delta endotoxin of |
| | Bacillus thuringiensis(B.t.) encapsulated in killed |
| | Pseudomonas fluorescens |
| | CryIC derived delta endotoxin of |
| | Bacillus thuringiensis encapsulated in killed |
| | Pseudomonas fluorescens |
| 15096-52-3 | Cryolite |
| | Cryptococcus infirmo-miniatus strain YY6 |
| | Cube Resins other than rotenone |
| | Cuprammonium zirconyl carbonate |
| 12168-20-6 | Cupric ferric subsulfate complex |
| 1317-38-0 | Cupric oxide |
| 82010-82-0 | Cuprous and cupric oxide, mixed |
| 7758-89-6 | Cuprous chloride (Cu2Cl2) |
| 1317-39-1 | Cuprous oxide |
| 420-04-2 | Cyanamide |
| 21725-46-2 | Cyanazine |
| 120116-88-3 | Cyazofamid |
| 113136-77-9 | Cyclanilide |
| 1134-23-2 | Cycloate |
| 26532-22-9 | Cyclobutaneethanol, |
| | 1-methyl-2-(1-methylethenyl)-, (1R-cis)- |
| 110-82-7 | Cyclohexane |
| 51971-67-6 | Cyclohexanecarboxamide, 1-(4-chloro- |
| | 1,3-dihydro-1,3-dioxo-2H-isoindol-2-yl)- |
| 127277-53-6 | Prohexadione calcium |
| 12002-53-8 | 4(or 5)-Chloro-2-methylcyclohexanecarboxylic |
| | acid, 1,1-dimethylethyl ester |
| 55635-13-7 | Cyclohexanecarboxylic acid, 2,2-dimethyl- |
| | 4,6-dioxo-5-{1-{(2-propenyloxy)imino}butyl}-, |
| | methyl ester, ion(1-), sodium |
| 42822-86-6 | p-Menthane-3,8-diol |
| 108-94-1 | Cyclohexanone |
| 116-04-1 | Cyclopentadecatriene |
| 121-21-1 | Cyclopropanecarboxylic acid, 2,2-dimethyl- |
| | 3-(2-methyl-1-propenyl)-, 2-methyl-4-oxo-3- |
| | (2,4-pentadienyl)-2-cyclopenten-1-yl ester, |
| | (1R-(1.alpha.(S*(Z)),3.beta.))- |
| 52341-33-0 | Cyclopropanecarboxylic acid, |
| | 3-(2,2-dichloroethenyl)-2,2-dimethyl_, (3- |
| | phenoxyphenyl)methyl ester, cis-(.+-.) |
| 121-29-9 | Cyclopropanecarboxylic acid, 3-(3-methoxy- |
| | 2-methyl-3-oxo-1-propenyl)-2,2-dimethyl-, |
| | 2-methyl-4-oxo-3-(2,4-pentadienyl)-2- |
| | cyclopenten-1-yl ester, (1R-(1.alpha.(S*(Z)),3- |
| | beta.(E)))- |
| 3100-04-7 | 1-Methylcyclopropene |
| | Cydia pomonella granulosis virus |
| 68359-37-5 | Cyfluthrin |
| 122008-85-9 | Cyhalofop-butyl |
| 68085-85-8 | Cyhalothrin |
| 13121-70-5 | Cyhexatin |
| 57966-95-7 | Cymoxanil |
| 52315-07-8 | Cypermethrin |
| 39515-40-7 | Cyphenothrin |
| 22936-86-3 | Cyprazine |
| 94361-06-5 | Cyproconazole |
| 121552-61-2 | Cyprodinil |
| 66215-27-8 | Cyromazine |
| 525-79-1 | Cytokinin (as kinetin) |
| 18472-87-2 | D & C Red No.28 |
| 70630-17-0 | Metalaxyl-M |
| 108175-15-1 | Sorbitol octanoate |
| 526-95-4 | D-Gluconic acid |
| 18472-51-0 | D-Gluconic acid, compd with N,N″-bis(4- |
| | chlorophenyl)-3,12-diimino-2,4, 11,13- |
| | tetraazatetradecanediimidamide (2:1) |
| 57-92-1 | Streptomycin |
| 1861-32-1 | DCPA (or chlorthal-dimethyl?) |
| 144-21-8 | DSMA |
| 67891-94-5 | Dactylaria brochopaga |
| 75-99-0 | Dalapon |
| 1596-84-5 | Daminozide |
| 533-74-4 | Dazomet |
| 147858-26-2 | Decanoic acid, 3-[[6-deoxy-2-o-(6- |
| | deoxy-alpha-L-mannopyranosyl)-alpha-L- |
| | mannopyranosyl]oxy]-, 1-(carboxymethyl)octyl |
| | ester, mixt. with 1-(carboxymethyl)octyl |
| | 3-[(6-deoxy-alpha-L-mannopyranosyl)oxy]decanoate |
| 123-35-3 | Decatriene |
| 138698-36-9 | Decyl isononyl dimethyl ammonium chloride |
| 53404-25-4 | Dehydroabietylammonium phenoxide |
| | Delta endotoxin of Bacillus thuringiensis |
| | subsp. san diego encapsulated in killed |
| | Pseudomonas fluorescens |
| | Delta endotoxin of Bacillus thuringiensis |
| | variety kurstaki encapsulated in killed |
| | Pseudomonas fluorescens |
| 52918-63-5 | Deltamethrin |
| | Derris resins other than rotenone |
| 13684-56-5 | Desmedipham |
| 9004-53-9 | Dextrin |
| | Di(alkyl* oxypropyl)dimethyl ammonium |
| | chloride *(60% C8, 40% C10) |
| 123-42-2 | Diacetone alcohol |
| 10311-84-9 | Dialifor |
| 68953-58-2 | Dialkyl* dimethyl ammonium bentonite |
| | *(as in fatty acids of tallow) |
| 73398-64-8 | Dialkyl* dimethyl ammonium chloride |
| | *(47% C12, 18% C14, 10% C18, 9% C10, 8% C16, |
| | 8% C8) |
| 73398-64-8 | Dialkyl* dimethyl ammonium chloride |
| | *(48% C12, 17% C14, 10% C18, 9% C16, 8% |
| | C8, 7% C10, 1% C6) |
| 68153-33-3 | Dialkyl* dimethyl ammonium chloride |
| | *(50% C12, 20% C14, 15% C10, 10% C16, 5% C18) |
| 68910-56-5 | Dialkyl* dimethyl ammonium chloride |
| | *(50% C12, 30% C14, 20% C16) |
| 68002-59-5 | Dialkyl* dimethyl ammonium chloride |
| | *(70% C18, 26% C16, 4% C14) |
| 61789-77-3 | Dialkyl* dimethyl ammonium chloride |
| | *(as in fatty acids of coconut oil) |
| 73049-75-9 | Dialkyl* methyl benzyl ammonium chloride |
| | *(60% C14, 30% C16, 5% C18, 5% C12) |
| 1754-58-1 | Diamidafos |
| 3566-10-7 | Diammonium ethylenebis(dithiocarbamate) |
| 13464-42-1 | Diarsenic acid, tetrasodium salt |
| 333-41-5 | Diazinon |
| 84-74-2 | Dibutyl phthalate (SEE COMMENTS) |
| 141-03-7 | Dibutyl succinate |
| 1918-00-9 | Dicamba |
| 8068-77-7 | Dicamba with 2,4-D |
| 1982-69-0 | Dicamba, sodium salt |
| 1194-65-6 | Dichlobenil |
| 97-17-6 | Dichlofenthion |
| 50-29-3 | Dichloro diphenyl trichloroethane (no |
| | longer permitted in pesticides) (NO INERT USE) |
| 2782-57-2 | Dichloro-s-triazinetrione |
| 75-71-8 | Dichlorodifluoromethane |
| | (No longer approved for inert use) |
| 120-36-5 | Dichlorprop |
| 62-73-7 | DDVP |
| 7789-12-0 | Dichromic acid, (H2Cr2O7), disodium salt, dihydrate |
| 108-90-7 | Chlorobenzene |
| 75-45-6 | Chlorodifluoromethane (HCFC-22) |
| 67-66-3 | Chloroform |
| 1319-86-4 | Chloromethoxypropylmercuric acetate |
| 2675-77-6 | Chloroneb |
| 3691-35-8 | Chlorophacinone |
| 76-06-2 | Chloropicrin |
| 5836-10-2 | Chloropropylate |
| 1897-45-6 | Chlorothalonil |
| 1982-47-4 | Chloroxuron |
| 88-04-0 | Chloroxylenol |
| 101-21-3 | Chlorpropham |
| 2921-88-2 | Chlorpyrifos |
| 5598-13-0 | Chlorpyrifos-methyl |
| 64902-72-3 | Chlorsulfuron |
| | Chondrostereum purpureum strain PFC 2139 |
| | Chondrostereum purpureum strain HQ1 |
| 7738-94-5 | Chromic acid |
| 87818-31-3 | Cinmethylin |
| 104-55-2 | Cinnamaldehyde |
| | Cinnamon |
| 35764-59-1 | Cismethrin |
| 5392-40-5 | Citral |
| 77-92-9 | Citric acid |
| 106-22-9 | Citronellol |
| 947173-77-5 | Clarified hydrophobic neem oil |
| | Clavibacter xyli subsp. cynodontis isolate |
| | producing bacillus thuringiensis subsp. |
| | kurstaki delta-endotoxin protein |
| | Clavibacter xyli subspecies cyondontis isolate |
| | MD69a producing Bacillus thuringiensis |
| | subspecies kurstaki delta-endotoxin protein |
| 99129-21-2 | Clethodim |
| 105511-96-4 | Clodinafop-propargyl (CAS Reg. No. 105512-06-9) |
| 82697-71-0 | Clofencet |
| 74115-24-5 | Clofentezine |
| 81777-89-1 | Clomazone |
| 1702-17-6 | Clopyralid |
| 119308-91-7 | Clopyralid, triethanolamine |
| 210880-92-5 | Clothianidin |
| | Clove, Crushed |
| 8007-45-2 | Coal tar |
| 8001-58-9 | Coal tar creosote |
| 65996-82-9 | Coal tar neutral oils |
| | Coat Protein Gene of Plum Pox Virus |
| 61789-51-3 | Cobalt naphthenate |
| 61790-57-6 | Cocoamine acetate |
| 8001-31-8 | Coconut oil |
| 8001-69-2 | Cod liver oil |
| | Colletotrichum gloeosporioides f. sp. aeschynomene |
| | Colletotrichum gloeosporioides f. sp. malvae |
| | Combustion Product Gas (Not selected for InertFinder) |
| | Coniothyrium minitans strain CON/M/91-08 |
| 16828-95-8 | Copper-ammonia complex |
| 1344-74-7 | Copper-zinc-chromate complex |
| 14915-37-8 | Copper 2-pyridinethio-1-oxide |
| 12002-03-8 | Copper acetoarsenite |
| 33113-08-5 | Copper ammonium carbonate |
| 10103-61-4 | Copper arsenate |
| 7440-50-8 | Copper as elemental |
| 50376-91-5 | Copper as elemental from copper-etidronic acid complex |
| 10402-15-0 | Copper as metallic (in the form of chelates |
| | of copper citrate and copper gluconate) |
| 12069-69-1 | Copper carbonate, basic |
| 10125-13-0 | Copper chloride (dihydrate) |
| 10402-15-0 | Copper citrate |
| 67989-88-2 | Copper complex with ammonia |
| | and ethylene diamine tetraacetate |
| 53404-24-3 | Copper dehydroabietylammonium 2-ethylhexanoate |
| 14215-52-2 | Copper ethanolamine complex |
| 13426-91-0 | Copper ethylene diamine complex |
| 20427-59-2 | Copper hydroxide |
| 7721-15-5 | Copper linoleate |
| 1338-02-9 | Copper naphthenate |
| 3251-23-8 | Copper nitrate |
| 1120-44-1 | Copper oleate |
| 814-91-5 | Copper oxalate |
| 1332-65-6 | Copper oxychloride (Cu2Cl(OH)3) |
| 8012-69-9 | Copper oxychloride sulfate |
| 9007-39-0 | Copper salts of fatty and rosin acids |
| 1344-72-5 | Copper silicate |
| 7758-98-7 | Copper sulfate (anhydrous) |
| 37574-18-8 | Carbamic acid, 1H-benzimidazol-2-yl-, |
| | methyl ester, monohydrochloride |
| 52316-55-9 | Carbamic acid, 1H-benzimidazol-2-yl-, |
| | methyl ester, phosphate (1:1) |
| 55406-53-6 | Carbamic acid, butyl-, 3-iodo-2-propynyl ester |
| 644-64-4 | Carbamic acid, dimethyl-, 1- |
| | ((dimethylamino)carbonyl)-5-methyl-1H-pyrazol-3-yl ester |
| 122-42-9 | Carbamic acid, phenyl-, 1-methylethyl ester |
| 138-93-2 | Carbamodithioic acid, cyano-, disodium salt |
| 95-06-7 | Carbamodithioic acid, diethyl-, 2-chloro-2-propenyl ester |
| 137-41-7 | Metam-Potassium |
| 36756-79-3 | Carbamothioic acid, bis(1-methylpropyl)-, |
| | S-(phenylmethyl) ester |
| 759-94-4 | Carbamothioic acid, dipropyl-, S-ethyl ester |
| 63-25-2 | Carbaryl |
| 10605-21-7 | Carbendazim |
| 1563-66-2 | Carbofuran |
| 7440-44-0 | Carbon |
| 124-38-9 | Carbon dioxide |
| 75-15-0 | Carbon disulfide |
| 56-23-5 | Carbon tetrachloride (NO INERT USE) |
| 1066-33-7 | Ammonium bicarbonate |
| 64-02-8 | EDTA, tetrasodium salt |
| 51609-52-0 | Egg solids |
| 155569-91-8 | Emamectin benzoate |
| 115-29-7 | Endosulfan |
| 2164-07-0 | Endothal-dipotassium |
| 145-73-3 | Endothall |
| 66330-88-9 | Endothall, mono(N,N,-dimethyl alkyl amine) salt |
| 72-20-8 | Endrin |
| 136-25-4 | Erbon |
| 66230-04-4 | Esfenvalerate |
| 8016-36-2 | Ester gum |
| 55283-68-6 | Ethalfluralin |
| 97780-06-8 | Ethametsulfuron |
| 34256-92-3 | Ethanamine, N,N-diethyl-2-(2-((1,7,7- |
| | trimethylbicyclo(2.2.1)hept-2-yl)oxy)ethoxy)- |
| 811-97-2 | Ethane, 1,1,1,2-Tetrafluoro- |
| 79-21-0 | Ethaneperoxoic acid |
| 64-17-5 | Ethanol |
| 94-84-8 | Ethanol, 2-(2,4-dichlorophenoxy)-, phosphite (3:1) |
| 53404-78-7 | Ethanol, 2-amino-, hydrogen |
| | phosphate (ester), monosodium salt |
| 141-43-5 | Ethanolamine |
| 26836-07-7 | Ethanolamine dodecylbenzenesulfonate |
| 2491-38-5 | Ethanone, 2-bromo-1-(4-hydroxyphenyl)- |
| 16672-87-0 | Ethephon |
| 2941-55-1 | Ethiolate |
| 563-12-2 | Ethion |
| 80844-07-1 | Etofenprox |
| 26225-79-6 | Ethofumesate |
| 13194-48-4 | Ethoprop |
| 61790-81-6 | Ethoxylated lanolin |
| 26635-75-6 | Ethoxylated monoethanolamine of lauric acid |
| 91-53-2 | Ethoxyquin |
| 2122-70-5 | Ethyl 1-naphthaleneacetate |
| 510-15-6 | Ethyl 4,4′-dichlorobenzilate |
| 25059-80-7 | Ethyl 4-chloro-2-oxo-3(2H)-benzothiazoleacetate |
| 141-78-6 | Ethyl acetate (Fil List) |
| 2597-03-7; | Ethyl alpha- |
| 61361-99-7; | ((dimethoxyphosphinothioyl)thio)benzeneacetate |
| 61362-00-3; | |
| 61391-87-5 | |
| 109-94-4 | Ethyl formate |
| 352-93-2 | Ethyl sulfide |
| 74-85-1 | Ethylene |
| 106-93-4 | Ethylene dibromide |
| 107-21-1 | 1,2-Ethanediol |
| 53404-49-2 | Ethylene glycol ether of pinene |
| | (Not selected for InertFinder) |
| 75-21-8 | Ethylene oxide |
| 60-00-4 | Ethylenediaminetetraacetic acid |
| 150-38-9 | Ethylenediaminetetraacetic acid (EDTA), trisodium salt |
| 17421-79-3 | Ethylenediaminetetraacetic acid, sodium salt |
| 96-45-7 | Ethylenethiourea |
| 153233-91-1 | Etoxazole |
| 2593-15-9 | Etridiazole |
| 97-53-0 | Eugenol |
| 131807-57-3 | Famoxadone |
| 4602-84-0 | Farnesol |
| 85566-12-7 | Fatty alcohols (54.5% C10, 45.1% C8, 0.4% C6) |
| 68603-15-6 | Fatty alcohols (55.10% C10, 42.88% |
| | C8, 1.01% C6, 1.01% C12) |
| 161326-34-7 | Fenamidone |
| 22224-92-6 | Fenamiphos |
| 60168-88-9 | Fenarimol |
| 114369-43-6 | Fenbuconazole |
| 13356-08-6 | Fenbutatin-oxide |
| 126833-17-8 | Fenhexamid |
| 122-14-5 | Fenitrothion |
| 66441-23-4 | Fenoxaprop |
| 71283-80-2 | Fenoxaprop-p-ethyl |
| 72490-01-8 | Fenoxycarb |
| 39515-41-8 | Fenpropathrin |
| 67564-91-4 | Fenpropimorph |
| 134098-61-6 | Fenpyroximate |
| 83588-43-6 | Fenridazon |
| 55-38-9 | Fenthion |
| 76-87-9 | Fentin hydroxide |
| 51630-58-1 | Fenvalerate |
| 14484-64-1 | Ferbam |
| | Fermentation biomas of |
| | xanthomonas campestris pv. poae |
| 10028-22-5 | Ferric sulfate |
| 10045-89-3 | Ferrous ammonium sulfate |
| 7782-63-0 | Ferrous sulfate heptahydrate |
| 17375-41-6 | Ferrous sulfate monohydrate |
| 120068-37-3 | Fipronil |
| 8021-28-1 | Fir Needle Oil |
| 8016-13-5 | Fish oil |
| | Flavobacterium balustinum strain 299 |
| 158062-67-0 | Flonicamid |
| | Flowers of Chamomile (Matricaria |
| | chamomilla and/or Anthemidis nobilis) |
| 69806-50-4 | Fluazifop |
| 79622-59-6 | Fluazinam |
| 181274-17-9 | Flucarbazone-sodium |
| 33245-39-5 | Fluchloralin |
| 70124-77-5 | Flucythrinate |
| 131341-86-1 | Fludioxonil |
| 142459-58-3 | Flufenacet |
| 188489-07-8 | Flufenpyr-ethyl |
| 62924-70-3 | Flumetralin |
| 98967-40-9 | Flumetsulam |
| 87546-18-7 | Flumiclorac |
| 103361-09-7 | Flumioxazin |
| 2164-17-2 | Fluometuron |
| 15457-05-3 | Fluorodifen |
| 77501-90-7 | Fluoroglycofen-ethyl |
| 361377-29-9 | Fluoxastrobin |
| 59756-60-4 | Fluridone |
| 69377-81-7 | Fluroxypyr |
| 81406-37-3 | Fluroxypyr-meptyl |
| 56425-91-3 | Flurprimidol |
| 85509-19-9 | Flusilazole |
| 117337-19-6 | Fluthiacet-methyl |
| 66332-96-5 | Flutolanil |
| 69409-94-5 | Fluvalinate |
| 133-07-3 | Folpet |
| 944-22-9 | Fonofos |
| 68157-60-8 | Forchlorfenuron |
| 50-00-0 | Formaldehyde |
| 82010-83-1 | Formaldehyde, compd. with |
| | 1-ethenyl-2-pyrrolidinone homopolymer |
| 22259-30-9 | Formetanate |
| 23422-53-9 | Formetanate hydrochloride |
| 64-18-6 | Formic acid |
| 25954-13-6 | Fosamine |
| 39148-24-8 | Fosetyl-Al |
| 5598-52-7 | Fospirate |
| 98886-44-3 | Fosthiazate |
| 21548-32-3 | Fosthietan |
| 68476-30-2 | Fuel oil #2 |
| 110-17-8 | Fumaric acid |
| 22248-79-9 | Gardona (cis-isomer) |
| 8000-78-0 | Garlic oil |
| | Gas cartRidge (as a device for burrowing animal control) |
| 1403-66-3 | Gentamicin |
| 106-24-1 | Geraniol |
| | German cockroach pheromone |
| 77-06-5 | Gibberellic acid |
| 40843-25-2 | Diclofop |
| 51338-27-3 | Diclofop-methyl |
| 99-30-9 | Dicloran |
| 145701-21-9 | Diclosulam |
| 115-32-2 | Dicofol |
| 141-66-2 | Dicrotophos |
| 68213-53-6 | Dicyclopentadiene linseed oil copolymer |
| 148788-55-0 | Didecyl dimethyl ammonium carbonate and |
| | didecyl dimethyl ammonium bicarbonate |
| 32426-10-1 | Didecyl methyl benzyl ammonium chloride |
| 2227-17-0 | Dienochlor |
| 68603-42-9 | Diethanolamides of the fatty acids of coconut oil |
| 1432-14-0 | Diethanolamine 2-(2-methyl-4-chlorophenoxy)propionate |
| 20405-19-0 | Diethanolamine 2-methyl-4-chlorophenoxyacetate |
| 53404-16-3 | Diethanolamine 3-amino-2,5-dichlorobenzoate |
| 53404-23-2 | Diethanolamine 4-chlorophenoxyacetate |
| 26545-53-9 | Diethanolamine dodecylbenzenesulfonate |
| | (Data Submitter Rights) |
| 23564-06-9 | Diethyl 4,4′-o-phenylenebis(3-thioallophanate) |
| 134-62-3 | Diethyl toluamide |
| | Diethyl-2-(4-methylbenzyloxy)ethylamine |
| 111-46-6 | Diethylene glycol |
| 111-77-3 | Diethylene glycol monomethyl ether |
| 53404-34-5 | Diethylethanolamine 2,4-dichlorophenoxyacetate |
| 119446-68-3 | Difenoconazole |
| 43222-48-6 | Difenzoquat methyl sulfate |
| 104653-34-1 | Difethialone |
| 35367-38-5 | Diflubenzuron |
| 109293-97-2 | Diflufenzopyr |
| 53466-80-1 | Dihydroabietylamine acetate |
| 108189-58-8 | Dihydroazadirachtin |
| 20018-12-6 | Diiodomethyl p-chlorophenyl sulfone |
| 20018-09-1 | Diiodomethyl p-tolyl sulfone |
| 108-83-8 | Diisobutyl ketone |
| 53466-89-0 | Diisobutylphenoxyethanol |
| 52508-35-7 | Dikegulac |
| 3282-73-3 | Dilauryl dimethyl ammonium bromide |
| 87674-68-8 | Dimethenamid |
| 55290-64-7 | Dimethipin |
| 60-51-5 | Dimethoate |
| 110488-70-5 | Dimethomorph |
| 70-38-2 | Dimethrin |
| 122-10-1 | Dimethyl 3-hydroxyglutaconate dimethyl phosphate |
| 12379-48-5 | Dimethyl isopropylaminophenanthrene |
| 131-11-3 | Dimethyl phthalate (SEE COMMENTS) |
| | (No longer approved for nonfood use) |
| 67-68-5 | Dimethyl sulfoxide |
| 53404-32-3 | Dimethylamine 2-(2,4-dichlorophenoxy)propionate |
| 2758-42-1 | Dimethylamine 4-(2,4-dichlorophenoxy)butyrate |
| 83657-18-5 | Diniconazole |
| 29091-05-2 | Dinitramine |
| 39300-45-3 | Dinocap |
| 88-85-7 | Dinoseb |
| 165252-70-0 | Dinotefuran |
| 78-34-2 | Dioxathion |
| 82-66-6 | Diphacinone |
| 42721-99-3 | Diphacinone, sodium salt |
| 957-51-7 | Diphenamid |
| 86-29-3 | Diphenylacetonitrile |
| 122-39-4 | Diphenylamine (Not selected for InertFinder) |
| 60704-91-8; | Dipotassium phosphate |
| 7758-11-4 | |
| 4147-51-7 | Dipropetryn |
| 25265-71-8 | Dipropylene glycol |
| 2764-72-9 | Diquat |
| 85-00-7 | Diquat dibromide |
| 5136-51-6 | Disodium 2,2′-oxybis(4-dodecylbenzenesulfonate) |
| 7575-62-4 | Disodium 4-dodecyl-2,4′-oxydibenzenesulfonate |
| 135-37-5 | Disodium N-(2-hydroxyethyl)iminodiacetate |
| 74988-17-3 | Disodium di(2-hydroxyethyl)ethylenediaminediacetate |
| 139-33-3 | Disodium ethylenediaminetetraacetate |
| 53404-45-8 | Disodium monoethanolamine phosphate |
| 36445-71-3 | Disodium n-decyldiphenyl ether disulfonate |
| 8007-87-2 | Distilled cubeb oil |
| 2179-57-9 | Diallyl disulfide |
| 298-04-4 | Disulfoton |
| 5131-24-8 | Ditalimfos |
| 3347-22-6 | Dithianon |
| 97886-45-8 | Dithiopyr |
| 330-54-1 | Diuron |
| 301-11-1 | Dodecanoic acid, 2-thiocyanatoethyl ester |
| 16830-40-3 | Dodecanoic acid, compd with 2-aminoethanol (1:1) |
| 27194-74-7 | Propylene glycol monolaurate |
| 3772-94-9 | Dodecanoic acid, pentachlorophenyl ester |
| 40642-40-8 | Dodecen-1-ol, (Z)- |
| 142-90-5 | Dodecyl 2-methacrylate |
| 7281-04-1 | Dodecyl dimethyl benzyl ammonium bromide |
| 139-07-1 | Dodecyl dimethyl benzyl ammonium chloride |
| | Dodecyl dimethyl benzyl ammonium naphthenate |
| | (Not selected for InertFinder) |
| 7491-20-5 | Dodecylamine lactate |
| 50291-24-2 | Dodecylammonium sulfate |
| 27176-87-0 | Dodecylbenzenesulfonic acid |
| 1330-85-4 | Dodecylbenzyl trimethyl ammonium chloride |
| 112-65-2 | Dodecylguanidine hydrochloride |
| 112-65-2; | Dodine |
| 15880-99-6; | |
| 2439-10-3; | |
| 51426-08-5; | |
| 96923-04-5 | |
| 39354-74-0 | Dowfax 3B1 (Data Submitter Rights) |
| 68911-49-9 | Dried blood |
| | Dried fermentation solids & solubles |
| | of myrothecium verrucaria |
| | Dried fermentation solids and solubles |
| | resulting from fermentation of Trichoderma |
| | harzianum isolate T-39, containing T-39 |
| | fungus propagules, as either conidia or |
| | mycelia |
| 12276-01-6 | EDTA, copper salt |
| 76-44-8 | Heptachlor |
| 53466-91-4 | Heptadecyl hydroxyethyl imidazoline |
| 56634-95-8 | Bromoxynil heptanoate |
| 116-16-5 | Hexachloroacetone |
| 77-47-4 | Hexachlorocyclopentadiene |
| 79983-71-4 | Hexaconazole |
| 629-80-1 | Hexadecanal |
| 86479-06-3 | Hexaflumuron |
| 4719-04-4 | Hexahydro-1,3,5-tris(2-hydroxyethyl)-s-triazine |
| 111-01-3 | Hexamethyltetracosane |
| 22221-10-9 | Hexanoic acid, 2-ethyl-, copper salt |
| 51235-04-2 | Hexazinone |
| 78587-05-0 | Hexythiazox |
| | Hirsutella tompsonii (Fisher) 300,000 |
| | spores per gram of product. |
| 67485-29-4 | Hydramethylnon |
| 10034-85-2 | Hydriodic acid |
| 7647-01-0 | Hydrochloric acid |
| 50-23-7 | Hydrocortisone |
| 74-90-8 | Hydrocyanic acid |
| 7664-39-3 | Hydrofluoric acid |
| 7722-84-1 | Hydrogen peroxide |
| 8001-78-3 | Hydrogenated castor oil |
| 41096-46-2 | Hydroprene |
| 10004-44-1 | Hymexazol |
| 7790-92-3 | Hypochlorous Acid |
| | IR-23, Bacillus thuringiensis subspecies |
| | tenebrionis delta endotoxin as produced in |
| | potato by an expression enhancer-CryIIIA |
| | fusion product and its controlling sequences |
| | and found in the following construct:PV-STBT05 |
| 35554-44-0 | Imazalil |
| 58594-72-2 | Imazalil sulphate |
| 8022-15-9 | Lavandin oil |
| 301-04-2 | Lead acetate |
| 1327-31-7 | Lead arsenate hydroxide (Pb5(AsO4)3(OH)) |
| | Leaves of Eucalyptus |
| | Leaves of Pennyroyal (Mentha pulegium) |
| 8020-19-7 | Lemon peel oil |
| 1344-81-6 | Lime sulfur |
| 138-86-3 | Limonene |
| 78-70-6 | Linalool |
| 58-89-9 | Lindane |
| 8001-26-1 | Linseed oil |
| 330-55-2 | Linuron |
| | Listeria specific Bacteriophages |
| 29457-72-5 | Lithium (perfluorooctane)sulfonate |
| 7447-41-8 | Lithium chloride |
| 13840-33-0 | Lithium hypochlorite |
| 4485-12-5 | Lithium stearate |
| | Live Chlamydospores of Phytophthora palmivora MWV |
| 95046-40-5 | Lysophosphatidylethanolamines, egg yolk |
| 94-74-6 | MCPA |
| 29450-45-1 | MCPA, 2-ethylhexyl ester |
| 2039-46-5 | MCPA, dimethylamine salt |
| 3653-48-3 | MCPA, sodium salt |
| 94-81-5 | MCPB (and salts) |
| 6062-26-6 | MCPB, sodium salt |
| 66423-05-0 | Mecoprop-P-potassium |
| 113-48-4 | MGK 264 |
| 2163-80-6 | MSMA (and salts) |
| 5902-95-4 | MSMA, calcium salt |
| 7786-30-3 | Magnesium chloride |
| 29110-22-3 | Magnesium dalapon ( 2,2-dichloropropionic acid ) |
| 3097-08-3 | Magnesium lauryl sulfate |
| 1309-48-4 | Magnesium oxide (MgO) |
| 12057-74-8 | Magnesium phosphide |
| 7487-88-9 | Magnesium sulfate anhydrous |
| 121-75-5 | Malathion (NO INERT USE) |
| 123-33-1 | Maleic hydrazide |
| 28382-15-2 | Maleic hydrazide, potassium salt |
| 6915-15-7 | Malic acid |
| | Mamestra configurata nucleopolyhedrovirus (McNPV) |
| 8018-01-7 | Mancozeb |
| 12427-38-2 | Maneb |
| 75747-77-2 | Manganese, dichlorotetrakis(N-propyl- |
| | N-(2-(2,4,6-trichlorophenoxy)ethyl)-1H- |
| | imidazole-1-carboxamide)- |
| 53404-58-3 | Manganous benzothiazylmercaptide |
| 15339-36-3 | Manganous dimethyldithiocarbamate |
| 68131-12-4 | Meat meal |
| 7085-19-0 | Mecoprop |
| 32351-70-5 | Mecoprop-dimethylammonium |
| 28473-03-2 | Mecoprop-isoctyl |
| 1929-86-8 | Mecoprop-potassium |
| 16484-77-8 | Mecoprop-P |
| 53780-34-0 | Mefluidide |
| | Melanoplus sanguinipes virus |
| 1490-04-6 | Menthol |
| 24307-26-4 | Mepiquat chloride |
| 53404-67-4 | Mercurate(1-), (acetato-O)amidophenyl-, hydrogen |
| 53404-68-5 | Mercurate(1-), amidophenyl(propanoato-O)-, hydrogen |
| 7487-94-7 | Mercuric chloride |
| 10112-91-1 | Mercurous chloride |
| 6273-99-0 | Mercury, (.mu.-(orthoborato(2-)-O:O′))diphenyldi- |
| 122-64-5 | Mercury, (2-hydroxypropanoato)phenyl- |
| 104-60-9 | Mercury, (9-octadecenoato-O)phenyl-, (Z)- |
| 55-68-5 | Mercury, (nitrato-O)phenyl- |
| 27236-65-3 | Mercury, diphenyl(.mu.- |
| | ((tetrapropenyl)butanedioato(2-)-O:O′))di- |
| 208465-21-8 | Mesosulfuron-methyl |
| 104206-82-8 | Mesotrione |
| 57837-19-1 | Metalaxyl |
| 108-62-3 | Metaldehyde |
| 137-42-8 | Metam-sodium |
| 67892-13-1 | Metarhizium anisopliae Strain ESF1 |
| | Metarhizium brunneum (formerly known |
| | as Metarhizium anisopliae) Strain F52 |
| 10265-92-6 | Methamidophos |
| 107-43-7 | Methanaminium, 1-carboxy-N,N,N-trimethyl-, inner salt |
| 569-64-2 | Methanaminium, N-(4-((4- |
| | (dimethylamino)phenyl)phenylmethylene)- |
| | 2,5-cyclohexadien- |
| | 1-ylidene)-N-methyl-, chloride |
| 74-88-4 | Methane, iodo- |
| 556-61-6 | Methane, isothiocyanato- |
| 69462-14-2 | Methanesulfonamide, 1-chloro-N-(4,5- |
| | dichloro-2-(2,4,5-trichlorophenoxy)phenyl)-, |
| | sodium salt |
| 30388-01-3 | Methanesulfonothioic acid, S-(2-hydroxypropyl) ester |
| 19750-95-9 | Methanimidamide, N′-(4-chloro-o-tolyl)- |
| | N,N-dimethyl-, monohydrochloride |
| 97553-90-7 | Methanol, (((1-methyl-2-(5-methyl-3- |
| | oxazolidinyl)ethoxy)methoxy)methoxy)- |
| 141112-29-0 | Isoxaflutole |
| 20354-26-1 | Methazole |
| 950-37-8 | Methidathion |
| 2032-65-7 | Methiocarb |
| 16752-77-5 | Methomyl |
| 40596-69-8 | Methoprene |
| 72-43-5 | Methoxychlor |
| 161050-58-4 | Methoxyfenozide |
| 1729-67-5 | Methyl 2,3-dibromopropionate |
| 99-76-3 | Methyl 4-hydroxybenzoate |
| 1216-44-0 | Methyl 9-hydroxyfluorene-9-carboxylate |
| 57973-66-7 | Methyl N-benzoyl-N-(3-chloro-4-fluorophenyl)-L-alaninate |
| 50594-67-7 | Methyl acifluorfen |
| 67-56-1 | Methyl alcohol |
| 4175-47-7 | Methyl alpha-eleostearate (methyl ester |
| | of (E,Z,E)-9,11,13-octadecatrienoic acid) |
| 74-83-9 | Methyl bromide (NO INERT USE) |
| | Methyl bromide w/chloropicrin |
| 71-55-6 | Methyl chloroform |
| 67762-39-4 | Methyl esters of fatty acids (100% C8-C12) |
| 110-93-0 | Methyl isohexenyl ketone |
| 112-12-9 | Methyl nonyl ketone |
| 298-00-0 | Methyl parathion |
| | Methylammonium N-methyldithiocarbamate |
| 28804-88-8 | Methylated naphthalenes (No longer |
| | approved for nonfood use) |
| 1399-80-0 | Methyldodecylbenzyl trimethyl ammonium |
| | chloride 80% and methyldodecylxylylene |
| | bis(trimethyl ammonium chloride) 20% |
| 6317-18-6 | Methylene bis(thiocyanate) |
| 61-73-4 | Methylene blue |
| 75-09-2 | Methylene chloride |
| 9006-42-2 | Metiram |
| 3060-89-7 | Metobromuron |
| 81405-85-8 | Imazamethabenz |
| 114311-32-9 | Imazamox |
| 104098-48-8 | Imazapic |
| 81334-34-1 | Imazapyr |
| 81335-37-7 | Imazaquin |
| 81335-77-5 | Imazethapyr |
| 138261-41-3 | Imidacloprid |
| 72963-72-5 | Imiprothrin |
| | Indian meal moth granulosis virus and |
| | larval parts on milled wheat bran carrier |
| 120-72-9 | Indole |
| 87-51-4 | Indole-3-acetic acid |
| 133-32-4 | Indole-3-butyric acid |
| 173584-44-6 | Indoxacarb |
| 7553-56-2 | Iodine |
| 26617-87-8 | Iodine, compd. with methyloxirane polymer with oxirane |
| 144550-36-7 | lodosulfuron-methyl-sodium |
| 125225-28-7 | Ipconazole |
| 36734-19-7 | Iprodione |
| 1309-37-1 | Iron oxide (Fe2O3) |
| 42509-80-8 | Isazofos |
| 125-12-2 | Isobornyl acetate |
| 115-31-1 | Isobornyl thiocyanoacetate |
| 1713-11-7 | Isobutyl 2-methyl-4-chlorophenoxyacetate |
| 79-31-2 | Isobutyric acid |
| 314-42-1 | Isocil |
| 25311-71-1 | Isofenphos |
| 28631-35-8 | Isooctyl 2-(2,4-dichlorophenoxy)propionate |
| 53404-37-8 | 2,4-D, isooctyl ester |
| 53404-76-5 | Isooctyl* silvex * 2-ethylhexyl |
| 53404-10-7 | Isooctyl* silvex * 2-ethyl-4-methylpentyl |
| 53404-14-1 | Isooctyl* silvex * 2-octyl |
| 9004-87-9 | Isooctylphenoxypolyethoxyethanol |
| | Isoparaffinic hydrocarbons |
| 33820-53-0 | Isopropalin |
| 2698-40-0 | Isopropyl 2-methyl-4-chlorophenoxyacetate |
| 108-21-4 | Isopropyl acetate |
| 67-63-0 | Isopropyl alcohol |
| 63393-93-1 | Isopropyl lanolin |
| 110-27-0 | Isopropyl myristate |
| 499-75-2 | Isopropyl-2-cresol |
| 12379-45-2 | Isothymyl 2-chloroethyl ether |
| 82558-50-7 | Isoxaben |
| | Jeffrey pine bark shavings |
| 61789-91-1 | Jojoba oil |
| 8013-10-3 | Juniper tar oil |
| 1332-58-7 | Kaolin clay |
| 4849-32-5 | Karbutilate |
| 8008-20-6 | Kerosene (petroleum) hydrodesulfurized |
| 42588-37-4 | Kinoprene |
| 56-86-0 | L-Glutamic acid |
| 79-33-4 | L-Lactic acid |
| 77501-63-4 | Lactofen |
| | Lagenidium giganteum, mycelium or oospores |
| 8006-54-0 | Lanolin |
| 120-40-1 | Lauric diethanolamide |
| 112-53-8 | Lauryl alcohol |
| 125-67-7 | Gibberellic acid, monopotassium salt |
| 8030-53-3 | Gibberellin A4 mixt. with Gibberellin A7 |
| | Gliocladium virens GL-21 |
| 77182-82-2 | Glufosinate |
| 111-30-8 | Glutaraldehyde |
| 66071-96-3 | Glutens, corn |
| 56-81-5 | Glycerol |
| 53404-54-9 | Glycine, N,N′-(1-hydroxy-1,2-ethanediyl)bis(N- |
| | (carboxymethyl)-, monosodium salt |
| 53404-52-7 | Glycine, N,N′-1,2-ethanediylbis(N-(carboxymethyl)-, |
| | compd. with 2-aminoethanol (1:4) |
| 5964-35-2 | Glycine, N,N′-1,2-ethanediylbis(N- |
| | (carboxymethyl)-, tetrapotassium salt |
| 17123-43-2 | Glycine, N,N-bsi(2-hydroxyethyl)-, sodium salt |
| 70161-44-3 | Glycine, N-(hydroxymethyl)-, monosodium salt |
| 70901-12-1 | Glycine, N-(phosphonomethyl)-potassium salt |
| 114370-14-8 | Glyphosate, ammonium salt |
| 70393-85-0 | Glycine, N-(phosphonomethyl)-, sodium salt (2:3) |
| 7097-60-1 | Glycine, hydriodide (4:1), compd. with iodine (4:5) |
| 79-14-1 | Glycolic acid |
| 1071-83-6; | Glyphosate |
| 40465-66-5 | |
| 38641-94-0 | Glyphosate-isopropylammonium |
| 2439-99-8 | Glyphosine |
| | Green alder bark shavings |
| | Ground corn cobs |
| 9000-75-3 | Gum Resins |
| 8050-07-5 | Gum Thus |
| 10101-41-4 | Gypsum (Ca(SO4).2H2O) |
| | HD-1 Protein as encoded by Bacillus thuringiensis |
| | subsp. kurstaki gene and produced |
| | in corn |
| 100784-20-1 | Halosulfuron-methyl |
| 69806-34-4 | Haloxyfop |
| | Hardwood oil |
| 151438-54-9 | Harpin protein |
| | Harrisina brillians granulosis virus |
| 64742-94-5 | Heavy aromatic naphtha |
| | Heliothis Armigera NPV A44EB |
| 112-05-0 | Nonanoic acid |
| 91125-43-8 | Nonanoic acid, sulfophenyl ester, sodium salt |
| 9016-45-9 | Nonylphenoxypolyethoxyethanol |
| 11096-42-7 | Nonylphenoxypolyethoxyethanol-iodine complex |
| 18530-56-8 | Norea |
| 27314-13-2 | Norflurazon |
| | Nosema locustae |
| 116714-46-6 | Novaluron |
| 121451-02-3 | Noviflumuron |
| 63284-71-9 | Nuarimol |
| 3244-90-4 | O,O,O,O-Tetrapropyl dithiopyrophosphate |
| 4104-14-7 | O,O-Bis(p-chlorophenyl) |
| | acetimidoylphosphoroamidothioate |
| 115-90-2 | O,O-Diethyl O-(4- |
| | (methylsulfinyl)phenyl) phosphorothioate |
| 8065-48-3 | O,O-Diethyl O-(and S-)(2-(ethylthio)ethyl) |
| | phosphorothioate (mixed isomers) |
| 297-97-2 | O,O-Diethyl O-2-pyrazinyl phosphorothioate |
| 42509-83-1 | O,O-Dimethyl O-(1-isopropyl-5-chloro- |
| | 1,2,4-triazol-3-yl) phosphorothioate |
| 57018-04-9 | Tolclofos-methyl |
| 115-93-5 | O,O-Dimethyl O-(p-sulfamoylphenyl) phosphorothioate |
| 21923-23-9 | O-(2,5-Dichloro-4-(methylthio)phenyl) |
| | O,O-diethyl phosphorothioate |
| 8022-00-2 | O-(2-(Ethylthio)ethyl) O,O-dimethyl phosphorothioate |
| | and S-(2-(ethylthio)ethyl) O,O-dimethyl phosphorothioate |
| 1757-18-2 | O-(2-Chloro-1-(2,5-dichlorophenyl)vinyl) |
| | O,O-diethyl phosphorothioate |
| 2463-84-5 | O-(2-Chloro-4-nitrophenyl) |
| | O,O-dimethyl phosphorothioate |
| 2104-64-5 | O-Ethyl O-(p-nitrophenyl) phenylphosphonothioate |
| 57-74-9 | Octachloro-4,7-methanotetrahydroindane |
| 57-11-4 | Octadecanoic acid |
| 20543-04-8 | Octanoic acid, copper salt |
| 68332-79-6 | Octanoic acid, ester with 1,2-propanediol |
| 26530-20-1 | Octhilinone |
| 6379-37-9 | Octylammonium methanearsonate |
| 27193-28-8 | Octylphenol |
| | Oedaleus senegalensis virus |
| 8007-44-1 | Oil of Pennyroyal |
| 8007-70-3 | Oil of anise |
| 8006-80-2 | Oil of camphor sassafrassy |
| 8000-29-1 | Oil of citronella |
| 8000-34-8 | Oil of cloves |
| 8000-48-4 | Oil of eucalyptus |
| 8000-46-2 | Oil of geranium |
| 8022-96-6 | Oil of jasmine |
| 8000-28-0 | Oil of lavender |
| 8007-02-1 | Oil of lemongrass |
| 57-06-7 | Allyl isothiocyanate |
| 8008-57-9 | Oil of orange |
| 8000-25-7 | Oil of rosemary |
| 8008-79-5 | Oil of spearmint |
| 119-36-8 | Methyl salicylate |
| 8006-82-4 | Oils, black pepper |
| 8014-29-7 | Oils, rue |
| 68647-73-4 | Oils, tea-tree |
| 112-80-1 | Oleic acid |
| | Oriental mustard seed (Brassica juncea) |
| 95-50-1 | Orthodichlorobenzene |
| 19044-88-3 | Oryzalin |
| 80-33-1 | Ovex |
| 19666-30-9 | Oxadiazon |
| 77732-09-3 | Oxadixyl |
| 144-62-7 | Oxalic acid |
| 23135-22-0 | Oxamyl |
| 7747-35-5 | Oxazolidine-E |
| 68610-00-4 | Oxirane, methyl-, polymer with oxirane, |
| | monobutyl ether, compd. with iodine |
| 5259-88-1 | Oxycarboxin |
| 301-12-2 | Oxydemeton-methyl |
| 68607-28-3 | Oxydiethylenebis(alkyl* dimethyl ammonium |
| | chloride) *(as in fatty acids of coconut oil) |
| 26468-79-1 | Oxyethylated tert-Butylphenol |
| 42874-03-3 | Oxyfluorfen |
| 2058-46-0 | Oxytetracycline hydrochloride |
| 113535-72-1; | Oxythioquinox |
| 2439-01-2; | |
| 85188-88-1 | |
| 52292-17-8 | POE isooctadecanol |
| 76738-62-0 | Paclobutrazol |
| | Isaria fumosorosea (Paecilomyces fumosoroseus) |
| 9000-28-6 | Paloja |
| | Pantoea agglomerans strain C9-1 |
| 106-46-7 | Paradichlorobenzene |
| 30525-89-4 | Paraformaldehyde |
| 4685-14-7 | Paraquat |
| 1910-42-5 | Paraquat dichloride |
| 56-38-2 | Parathion |
| 17781-31-6 | Parinol |
| 1114-71-2 | Pebulate |
| 40487-42-1 | Pendimethalin |
| | Penicillium oxalicum |
| 219714-96-2 | Penoxsulam |
| 82-68-8 | Pentachloronitrobenzene |
| 87-86-5 | Pentachlorophenol |
| 7978-73-6 | Pentachlorophenol, potassium salt |
| 131-52-2 | Pentachlorophenol, sodium salt |
| 2917-32-0 | Pentachlorophenol, zinc salt |
| 109-66-0 | Pentane |
| 101929-89-9 | Pentanoic acid, 3-hydroxy-4-(4-((5- |
| | (trifluoromethyl)-2-pyridinyl)oxy)phenoxy)-, methyl |
| | ester |
| 140-01-2 | Pentasodium diethylenetriaminepentaacetate |
| 10332-33-9 | Perboric acid, (HBO(O2)), sodium salt, monohydrate |
| 118-74-1 | Perchlorobenzene |
| 37924-13-3 | Perfluidone |
| 61228-92-0 | Periplanone B |
| 52645-53-1 | Permethrin |
| | Petrolatum |
| 64742-16-1 | Petroleum resins |
| | Petromyzonol sulfate |
| 13684-63-4 | Phenmedipham |
| 108-95-2 | Phenol |
| 97-18-7 | Phenol, 2,2′-thiobis(4,6-dichloro- |
| 6385-58-6 | Phenol, 2,2′-thiobis(4,6-dichloro-, disodium salt |
| 97-24-5 | Phenol, 2,2′-thiobis(4-chloro- |
| 1918-11-2 | Phenol, 2,6-bis(1,1-dimethylethyl)- |
| | 4-methyl-, methylcarbamate |
| 51218-45-2 | Metolachlor |
| 21087-64-9 | Metribuzin |
| 74223-64-6 | Metsulfuron |
| 315-18-4 | Mexacarbate |
| | Milbemectin (A mixture of >=70% |
| | Milbemcin A4, & <= 30% Milbemycin A3) |
| 51596-11-3 | Milbemycin B, 5-O-demethyl-28-deoxy- |
| | 6,28-epoxy-25-ethyl-, (6R,25R)- |
| 8012-95-1 | Mineral oil-includes paraffin oil from 063503 |
| 8032-32-4 | Mineral spirits |
| | Mint Herbs |
| 8006-90-4 | Mint oil (use PC 500740) |
| | Modified Cry3A protein and the genetic |
| | material necessary for its production (via |
| | elements of pZM26) in Event MIR604 corn |
| 2212-67-1 | Molinate |
| 13492-26-7 | Dipotassium phosphite (K2HPO3) |
| 2321-53-1 | Monoammonium methanearsonate |
| 53404-28-7 | Monoethanolamine 3,6-dichloro-o-anisate |
| 5736-15-2 | Monosodium 2,2′-methylenebis(3,4,6-trichlorophenate) |
| 7558-80-7 | Monosodium phosphate |
| 150-68-5 | Monuron |
| 110-91-8 | Morpholine |
| 1854-23-5 | Morpholine, 4,4′-(2-ethyl-2-nitro-1,3-propanediyl)bis- |
| | Muscodor albus strain QST 20799 |
| 88671-89-0 | Myclobutanil |
| | Mycoleptodiscus terrestris mycelia |
| 84929-34-0 | Myrica cerifera, extract |
| 112-72-1 | Myristyl alcohol |
| 93-71-0 | N,N-Diallyl-2-chloroacetamide |
| 68959-20-6 | N,N-Didecyl-N-methyl-3- |
| | (trimethoxysilyl)propanaminium chloride |
| 173159-57-4 | Foramsulfuron |
| 245735-90-4 | Mepiquat pentaborate |
| 83601-83-6 | N-(2,4-Dimethyl-5- |
| | (((trifluoromethyl)sulfonyl)amino)phenyl)acetamide, |
| | potassium salt |
| 71626-11-4 | N-(2,6-Dimethylphenyl)-N- |
| | (phenylacetyl)-DL-alanine, Methyl ester |
| | N-(2-Cyanoethyl)-N′-alkyl |
| | *-1,3-diaminopropane *(100% C6-18) |
| 59-40-5 | N-(2-Quinoxalinyl)sulfanilamide |
| 7149-79-3 | N-(3-Chloro-4-methylphenyl)acetamide |
| 2312-73-4 | N-(Phenylmethyl)-9-(tetrahydro-2H- |
| | pyran-2-yl)-9H-p<BR>urin-6-amine |
| | Glyphosate ethanolamine salt |
| 61791-63-7 | N-(coco alkyl)trimethylenediamine |
| | N-Alkyl* dimethyl benzyl ammonium chloride |
| | *(57% C12, 18% C14, 8% C16, 6% C10- |
| | C18, 5% C8) |
| 61791-34-2 | N-Alkyl *-N-ethyl morpholinium ethyl sulfate |
| | *(66% C18, 25% C16, 8% C18′, 1% C14) |
| 10096-64-7 | N-Alkyl *-N-ethyl morpholinium ethyl |
| | sulfate *(92% C18, 8% C16) |
| 91-49-6 | N-Butylacetanilide |
| 78-21-7 | N-Cetyl-N-ethylmorpholinium ethyl sulfate |
| 38727-55-8 | N-Chloroacetyl-N-(2,6-diethylphenyl)glycine, ethyl ester |
| 3700-59-2 | N-Lauryldiethylenetriamine |
| 26635-93-8 | N-Polyethoxylated oleylamine |
| 26635-92-7 | N-Polyoxyethylated stearylamine |
| 85-72-3 | N-meta-Tolylphthalamic acid |
| 142-59-6 | Nabam |
| 300-76-5 | Naled |
| 91-20-3 | Naphthalene |
| 571-58-4 | Naphthalene, 1,4-dimethyl- |
| 24157-81-1 | Naphthalene,2,6-bis(1-methylethyl)- |
| 15299-99-7 | Napropamide |
| 132-67-2 | Naptalam, sodium salt |
| 555-37-3 | Neburon |
| 8002-65-1 | Neem oil (See Kerry Leifer. No Inert |
| | Use without his clearance.) |
| 105726-67-8 | Neodecanamide, N-methyl- |
| 50315-14-5 | Neodecanoic acid, copper salt |
| 27253-29-8 | Neodecanoic acid, zinc salt |
| 1405-10-3 | Neomycin sulfate |
| 7212-44-4 | Nerolidol |
| 10101-97-0 | Nickel sulfate hexahydrate |
| 1420-04-8 | Niclosamide |
| 111991-09-4 | Nicosulfuron |
| 54-11-5 | Nicotine |
| 65-30-5 | Nicotine sulfate |
| 59-67-6 | Nicotinic acid |
| 61444-62-0 | Nifluridide |
| 1929-82-4 | Nitrapyrin |
| 5064-31-3 | Nitrilotriacetic acid, trisodium salt |
| 98-95-3 | Nitrobenzene |
| 9004-70-0 | Nitrocellulose (NO INERT USE. NOT |
| | APPROVED FOR INERT INGREDIENT USE, |
| | FOOD OR NON-FOOD, PER FEDERAL |
| | REGISTER: Jun. 11, 1999 (VOLUME 64, |
| | NUMBER 112) Page 31575-31576) |
| 7727-37-9 | Nitrogen, Liquid |
| 12046-09-2 | Nobleite |
| 13171-21-6 | Phosphamidon |
| 7803-51-2 | Phosphine |
| | Phospholipid |
| 6361-58-6 | Phosphonic acid, bis(2-(2,4-dichlorophenoxy)ethyl) ester |
| 299-85-4 | Phosphoramidothioic acid, (1-methylethyl)-, |
| | O-(2,4-dichlorophenyl) O-methyl ester |
| 7664-38-2 | Phosphoric acid |
| 68649-38-7 | Phosphoric acid, bis(2-ethylhexyl) ester, compd. |
| | with 2,2′-(coco alkylimino)bis(ethanol) |
| 6923-22-4 | Phosphoric acid, dimethyl 1-methyl-3- |
| | (methylamino)-3-oxo-1-propenyl ester, (E)- |
| 68961-66-0 | Phosphoric acid, dioctyl ester.compd. |
| | with 2,2′-(dodecylimino)bis(ethanol) (1:1) |
| 10028-24-7 | Phosphoric acid, disodium salt, dihydrate |
| 10045-86-0 | Phosphoric acid, iron(3+) salt (1:1) |
| 1070-03-7 | Phosphoric acid, mono(2-ethylhexyl) ester |
| 120579-32-0 | Phosphoric acid, mono(2-ethylhexyl) ester, |
| | compds.with diethanolamine N-coco alkyl |
| | derivs.(1:1) |
| 125091-04-5 | Phosphoric acid, monooctyl ester, compd. |
| | with 2,2′-(dodecylimino)bis(ethanol) (1:1) |
| 2642-71-9 | Phosphorodithioic acid, O,O-diethyl |
| | S-((4-oxo-1,2,3-benzotriazin-3(4H)-yl)methyl) ester |
| 35400-43-2 | Phosphorodithioic acid, O-ethyl |
| | O-(4-(methylthio)phenyl) S-propyl ester |
| 953-17-3 | Phosphorodithioic acid, S- |
| | (((4-chlorophenyl)thio)methyl) O,O-dimethyl ester |
| | Polyethoxypolypropoxypolyethoxyethanol- |
| | n-alkyl (54% C12, 18% C14, 9% C16, 9% |
| | C18, 5% C10, 5% C8) di(beta-hydroxyethyl) |
| | benzyl ammonium chloride-iodine |
| | complex |
| 9002-88-4 | Polyethylene |
| 9005-08-7 | Polyethylene glycol distearate |
| 8050-33-7 | Polyethylene glycol monoesters of |
| | mixed fatty and rosin acids |
| | Polyhedral inclusion bodies of Douglas fir |
| | tussock moth nucleopolyhedrosis virus |
| | Polyhedral inclusion bodies of gypsy |
| | moth nucleopolyhedrosis virus |
| | Polyhedral inclusion bodies of n.sertifer |
| | Polyhedral occlusion bodies (OBs) of the |
| | nuclear polyhedrosis virus of Autographa |
| | californica (alfalfa looper) |
| | Polyhedral occlusion bodies (OBs) of the nuclear |
| | polyhedrosis virus of Helicoverpa zea |
| | (corn earworm) |
| | Polyhedral occlusion bodies of the |
| | beet armyworm nuclear polyhedrosis virus |
| 9003-27-4 | Polyisobutylene |
| 65997-05-9 | Polymerized resin acids |
| 51344-60-6 | Polyoxyethylene condensate with abietylamine |
| 9005-64-5 | Polyoxyethylene sorbitan monolaurate |
| 9005-65-6 | Polyoxyethylene sorbitan monooleate |
| 37232-02-3 | Polyoxyethylene sorbitol oleate-laurate |
| | Polyoxyethylene sorbitol, mixed ether ester |
| 9003-39-8 | Polyvinylpyrrolidone |
| | Polyxylenol tetrasulfide |
| 15165-79-4 | Potassium 1-naphthaleneacetate |
| 67923-62-0 | Potassium 2,2′-methylenebis(3,4,6-trichlorophenate) |
| 35471-43-3 | Potassium 2,4,5-trichlorophenate |
| 2591-21-1 | Potassium 2,4,6-trichlorophenate |
| 14214-89-2 | Potassium 2,4-dichlorophenoxyacetate |
| 35471-49-9 | Potassium 2-benzyl-4-chlorophenate |
| 18128-16-0 | Potassium 2-chloro-4-phenylphenate |
| 51026-28-9 | Potassium N-hydroxymethyl-N-methyldithiocarbamate |
| 298-14-6 | Potassium bicarbonate |
| 7789-29-9 | Potassium bifluoride |
| 7646-93-7 | Potassium bisulfate |
| 59217-61-7; | Potassium bromide |
| 7758-02-3 | |
| 584-08-7 | Potassium carbonate |
| 7789-00-6 | Potassium chromate (Not selected for InertFinder) |
| 12002-51-6 | Potassium cresylate |
| 590-28-3 | Potassium cyanate |
| 151-50-8 | Potassium cyanide |
| 2244-21-5 | Potassium dichloro-s-triazinetrione |
| 7778-50-9 | Potassium dichromate (NO INERT USE) |
| 128-03-0 | Potassium dimethyldithiocarbamate |
| 27177-77-1 | Potassium dodecylbenzenesulfonate |
| 7379-27-3 | Potassium ethylenediaminetetraacetate |
| 68154-69-8 | Potassium fish oil soap |
| 1310-58-3 | Potassium hydroxide (K(OH)) |
| 7778-66-7 | Potassium hypochlorite |
| 7758-05-6 | Potassium iodate |
| 7681-11-0 | Potassium iodide |
| 67701-09-1 | Potassium laurate |
| 13429-27-1 | Potassium myristate |
| 7757-79-1 | Potassium nitrate |
| 143-18-0 | Potassium oleate |
| 7722-64-7 | Potassium permanganate |
| 10058-23-8 | Potassium peroxymonosulfate |
| 7727-21-1 | Potassium persulfate |
| 7778-77-0 | Potassium phosphate, monobasic |
| 7778-53-2 | Potassium phosphate, tribasic |
| 37199-66-9 | Potassium polysulfide |
| 7492-30-0 | Potassium ricinoleate |
| 13932-13-3 | Potassium tetrathionate |
| 10233-00-8 | Potassium thiosulfate |
| 30526-22-8 | Potassium toluene sulfonate |
| 12298-68-9 | Potassium triiodide |
| 30346-73-7 | Potassium xylene sulfonate |
| | Potato leaf roll virus (PLRV) coat protein |
| | as produced in potato by PLRV modCP gene |
| | and its controlling sequences and found in |
| | the following constructs: PV-STMT02, PV- |
| | STMT04, PV-STMT10, PV-STMT11, |
| | PV-STMT12, PV-STMT13 and PV-STMT14 |
| | Potato leafroll virus (PLRV) replicase |
| | protein as produced in potato plants |
| 23031-36-9 | Prallethrin |
| 86209-51-0 | Primisulfuron-methyl |
| 67747-09-5 | Prochloraz |
| 32889-48-8 | Procyanazine |
| 29091-21-2 | Prodiamine |
| 41198-08-7 | Profenofos |
| 26399-36-0 | Profluralin |
| 1610-18-0 | Prometon |
| 7287-19-6 | Prometryn |
| 1918-16-7 | Propachlor |
| 24579-73-5 | Propamocarb |
| 25606-41-1 | Propamocarb hydrochloride |
| 5221-17-0 | Propanal, 2,3-dibromo- |
| 709-98-8 | Propanil |
| 127-20-8 | Propanoic acid, 2,2-dichloro-, sodium salt |
| 55617-85-1 | Propanoic acid, 2-(2,4,5-trichlorophenoxy)-, |
| | compd. with N-methylmethanamine (1:1) |
| 15165-67-0 | 2,4-DP-p |
| 104786-87-0 | 2,4-DP-p, DMA salt |
| 79270-78-3 | Propanoic acid, 2-(2,4-dichlorophenoxy)-, |
| | 2-ethylhexyl ester |
| 69806-40-2 | Propanoic acid, 2-(4-((3-chloro-5-(trifluoromethyl)- |
| | 2-pyridinyl)oxy)phenoxy)-, methyl |
| | ester |
| 79241-46-6 | Fluazifop-P-butyl |
| 66423-09-4 | MCPP-P, DMA salt |
| 100646-51-3 | Quizalofop-p-ethyl |
| 5454-22-8 | Propanoic acid, 2-methyl-, decyl ester |
| 2312-35-8 | Propargite |
| 139-40-2 | Propazine |
| 31218-83-4 | Propetamphos |
| 60207-90-1 | Propiconazole |
| 79-09-4 | Propionic acid |
| 114-26-1 | Propoxur |
| 181274-15-7 | Propoxycarbazone-sodium |
| 94-13-3 | Propyl 4-hydroxybenzoate |
| 71-23-8 | Propyl alcohol |
| 57-55-6 | Propylene glycol |
| 53466-86-7 | Propylene glycol isobutyl ether |
| | 2,4,5-trichlorophenoxyacetate |
| 75-56-9 | Propylene oxide |
| 23950-58-5 | Propyzamide |
| 94125-34-5 | Prosulfuron |
| 68602-93-7 | Pseudomonas Syringae 742RS |
| | Pseudomonas aureofaciens strain Tx-1 |
| | Pseudomonas cepacia type Wisconsin |
| | Pseudomonas chlororaphis strain 63-28 |
| | Pseudomonas fluorescens |
| | Pseudomonas fluorescens (natural occurring strain) |
| | Pseudomonas fluorescens 1629RS |
| | Pseudomonas fluorescens A506 (previously coded 006418) |
| | Pseudomonas fluorescens EG-1053 |
| | (previously coded 006418) |
| | Pseudomonas fluorescens Strain NCIB 12089 |
| | Pseudomonas fluorescens isolate Ps 3732-3-7. |
| | Contains delta endotoxin gene from |
| | BTK(Bacillus thuringiensis, subsp. kurstaki). |
| | Resistant to kanamycin. HOMOLOGOUS |
| | RECOMBINATION TECHNOLOGY. |
| | Pseudomonas fluorescens strain PRA-25 |
| 68583-32-4 | Pseudomonas syringae, strain ESC 10 |
| | Pseudomonas syringae, strain ESC-11 |
| | Pseudozyma flocculosa |
| | Puccinia canaliculate (Schweinitz) |
| | Lagerheim (ATCC #40199) |
| | Puccinia thlaspeos ‘woad strain’ on |
| | rust-infected pieces of dyer′s woad |
| 123312-89-0 | Pymetrozine |
| 175013-18-0 | Pyraclostrobin |
| 129630-19-9 | Pyraflufen-ethyl |
| 1698-60-8 | Pyrazon |
| | Pyrethrin coils |
| 8003-34-7 | Pyrethrins |
| 8003-34-7 | Pyrethrum flowers |
| 8003-34-7 | Pyrethrum powder other than pyrethrins |
| 96489-71-3 | Pyridaben |
| 179101-81-6 | Pyridalyl |
| 55512-33-9 | Pyridate |
| 110-86-1 | Pyridine |
| 52-85-7 | Phosphorothioic acid, O-(4- |
| | ((dimethylamino)sulfonyl)phenyl) O,O-dimethyl ester |
| 2104-96-3 | Phosphorothioic acid, O-(4-bromo-2,5- |
| | dichlorophenyl) O,O-dimethyl ester |
| 90338-20-8 | Phosphorothioic acid, O-(2-(1,1-dimethylethyl)- |
| | 5-pyrimidinyl O,O diethyl ester |
| 35575-96-3 | Phosphorothioic acid, S-{(6-chloro-2- |
| | oxooxazolo(4,5-b}pyridin-3(2H)-yl}methyl} |
| | O,O-dimethyl ester |
| 150-50-5 | Phosphorotrithious acid, tributyl ester |
| 10294-56-1 | Phosphorous acid |
| 7723-14-0 | Phosphorus |
| 96182-53-5 | Phostebupirim |
| 70892-20-5 | Phytelene of marigold |
| 119515-38-7 | Picaridin |
| 1918-02-1 | Picloram |
| 2545-60-0 | Picloram-potassium |
| 83-26-1 | Pindone |
| 6120-20-3 | Pindone, sodium salt |
| 8002-09-3 | Pine oil |
| 8011-48-1 | Pine tar |
| 91995-59-4 | Pine tar oil |
| 1330-16-1 | Pinene |
| 3478-94-2 | Piperalin |
| 99-00-3 | Piperazine-carbon disulfide complex |
| 142-64-3 | Piperazine dihydrochloride |
| 458-88-8 | Piperidine, 2-propyl-, (S)- |
| 5281-13-0 | Piperonal bis(2-(2-butoxyethoxy)ethyl) acetal |
| 51-03-6 | Piperonyl butoxide |
| 23103-98-2 | Pirimicarb |
| 23505-41-1 | Pirimiphos-ethyl |
| 29232-93-7 | Pirimiphos-methyl |
| | Plant essences composition |
| | (Litsea-Pinus-Cinnamomum-Cymbopogon) |
| | Plant extract* (*Derived from quercus falcata, |
| | opuntia lindheimer, rhus aromatica, and |
| | rhizophoria mangle tissues) |
| | Plant pesticide bacillus thuringiensis |
| | Cry1A(b) delta-endotoxin and the genetic |
| | material necessary for its production |
| | (plasmid Vector pCIB4431) in corn |
| | Poly(hydroxyethylene(dimethyliminio)ethyl- |
| | ene(dimethyliminio)methylene) dichloride |
| 32289-58-0 | Poly(iminoimidocarbonyliminoimidocarbonyl- |
| | iminohexamethylene) hydrochloride |
| 83562-66-7 | Poly(oxy(methyl-1,2-ethanediyl)),.alpha.- |
| | (1-oxo-2-(2,4,5-trichlorophenoxy)propyl)- |
| | .omega.-propoxy- |
| 25322-69-4 | Poly(oxy(methyl-1,2-ethanediyl)), |
| | alpha-hydro-omega-hydroxy- |
| 31512-74-0 | Poly(oxy-1,2-ethanediyl(dimethylimino)- |
| | 1,2-ethanediyl(dimethylimino)-1,2-ethanediyl |
| | dichloride) |
| 53404-03-8 | Poly(oxy-1,2-ethanediyl),.alpha.- |
| | (2-(4-morpholinyl)ethyl)-.omega.-hydroxy- |
| 53404-04-9 | Poly(oxy-1,2-ethanediyl),.alpha.-(4-(1,1,3,3- |
| | tetramethylbutyl)phenyl)-.omega.-hydroxy-, |
| | compd. with iodine |
| 82010-75-1 | Poly(oxy-1,2-ethanediyl),.alpha.-hydro-.omega.- |
| | hydroxy-, ester with 5(or 6)-carboxy-4- |
| | hexyl-2-cyclohexene-1-octanoic acid, |
| | compd. with iodine |
| 9004-82-4 | Poly(oxy-1,2-ethanediyl),.alpha.- |
| | sulfo-.omega.-(dodecyloxy)-, sodium salt |
| 53404-05-0 | Poly(oxy-1,2-ethanediyl),.alpha.- |
| | tridecyl-.omega.-hydroxy-, compd. with iodine |
| 25322-68-3 | Poly(oxy-1,2-ethanediyl), alpha-hydro-omega-hydroxy- |
| 51344-62-8 | Poly(oxy-1,2-ethanediyl),.alpha.,.alpha.′- |
| | ((((1,2,3,4,4a,9,10, 10a-octahydro-1,4a- |
| | dimethyl-7-(1-methylethyl)-1- |
| | phenanthrenyl)methyl)imino)di-2,1- |
| | ethanediyl)bis(.omega.-hydroxy-, |
| | (1R-(1-.alpha.,4a.beta., 10a.alpha.))- |
| 11005-09-7 | Polyamidohygrostreptin |
| | Polybromide form of trimethylbenzyl ammonium resin |
| 9003-29-6 | Polybutene |
| 61788-33-8 | Polychlorinated terphenyls |
| 8029-29-6 | Polychlorobicyclopentadiene isomers |
| | (Chlorine content 60%-62% or 62%-64% ) |
| 4419-22-1 | Phenol, 2-(((tributylstannyl)oxy)carbonyl)- |
| | 4-(((tributylstannyl)oxy)sulfonyl)- |
| 35040-03-0 | Phenol, 2-(1-methylpropyl)-4,6-dinitro-, sodium salt |
| 51487-69-5 | Phenol, 2-(2-chloro-1-methoxyethoxy)-, methylcarbamate |
| 67233-85-6 | Phenol, 2-methoxy-5-nitro-, sodium salt |
| 534-52-1 | Phenol, 2-methyl-4,6-dinitro- |
| 64-00-6 | Phenol, 3-(1-methylethyl)-, methylcarbamate |
| 3130-29-8 | Phenol, 4-(1,1-dimethylethyl)-, potassium salt |
| 53404-20-9 | Phenol, 4-chloro-2-cyclopentyl-, sodium salt |
| 89-68-9 | Phenol, 4-chloro-5-methyl-2-(1-methylethyl)- |
| 88-30-2 | TFM |
| 35109-57-0 | Phenol, pentachloro-, compd. with |
| | (1R-(1.alpha.,4a.beta.,10a.alpha.))- |
| | 1,2,3,4,4a,10,10a-octahydro-1,4- |
| | a-dimethyl-7-(1-methylethyl)-1- |
| | phenanthrenemethanamine (1:1) |
| 66071-33-8 | Phenolic-tung oil varnish |
| 92-84-2 | Phenothiazine |
| 26002-80-2 | Phenothrin |
| 13302-00-6 | Phenylmercuric 2-ethylhexanoate |
| 62-38-4 | Phenylmercuric acetate |
| 23319-66-6 | Phenylmercuritriethanolammonium lactate |
| 298-02-2 | Phorate |
| 2310-17-0 | Phosalone |
| 732-11-6 | Phosmet |
| 7784-46-5 | Sodium arsenite |
| 26628-22-8 | Sodium azide |
| 532-32-1 | Sodium benzoate |
| 144-55-8 | Sodium bicarbonate |
| 7681-38-1 | Sodium hydrogen sulfate |
| 7631-90-5 | Sodium bisulfite (NaHSO3) |
| 7647-15-6 | Sodium bromide |
| 497-19-8 | Sodium carbonate |
| 7775-09-9 | Sodium chlorate |
| 7647-14-5 | Sodium chloride |
| 7758-19-2 | Sodium chlorite |
| 7775-11-3 | Sodium chromate |
| 143-33-9 | Sodium cyanide |
| 1322-98-1 | Sodium decylbenzene sulfonate |
| 126-96-5 | Sodium diacetate |
| 2893-78-9 | Sodium dichloro-s-triazinetrione |
| 51580-86-0 | Sodium dichloroisocyanurate dihydrate |
| 10588-01-9 | Sodium dichromate (NO INERT USE) |
| 128-04-1 | Sodium dimethyldithiocarbamate |
| 25155-30-0 | Sodium dodecylbenzenesulfonate |
| 15708-41-5 | Sodium ferric ethylenediaminetetraacetate |
| 7681-49-4 | Sodium fluoride |
| 62-74-8 | Sodium fluoroacetate |
| 16893-85-9 | Sodium fluosilicate |
| 2836-32-0 | Sodium glycolate |
| 10124-56-8 | Sodium hexametaphosphate |
| 1310-73-2 | Sodium hydroxide |
| 7681-52-9 | Sodium hypochlorite |
| 629-25-4 | Sodium laurate |
| 151-21-3 | Sodium lauryl sulfate |
| 7681-57-4 | Sodium metabisulfite |
| 6834-92-0 | Sodium metasilicate |
| 27987-00-4 | Sodium methylundecyl benzenesulfonate |
| | Sodium mono and dimethyl naphthalene sulfonate |
| 7631-99-4 | Sodium nitrate |
| 7632-00-0 | Sodium nitrite |
| 824-39-5 | Sodium o-nitrophenolate |
| 28675-11-8 | Sodium octylbenzene sulfonate |
| 143-19-1 | Sodium oleate |
| 15733-22-9 | Sodium p-chloro-m-cresolate |
| 824-78-2 | Sodium p-nitrophenolate |
| 15630-89-4 | Sodium percarbonate |
| 68608-26-4 | Sodium petroleum sulfonate |
| 139-02-6 | Sodium phenate |
| 7558-79-4 | Disodium phosphate |
| 1344-08-7 | Sodium polysulfide |
| 137-40-6 | Sodium propionate |
| 15922-78-8 | Sodium pyrithione |
| 108731-70-0 | Sodium salt of fomesafen |
| 533-96-0 | Sodium sesquicarbonate |
| 1344-09-8 | Sodium silicate |
| | Sodium silver thiosulfate |
| 7757-82-6 | Sodium sulfate |
| 53404-60-7 | Sodium tetrahydro-3,5-dimethyl- |
| | 2H-1,3,5-thiadiazine-2-thione |
| 7345-69-9 | Sodium tetrathiocarbonate |
| 540-72-7 | Sodium thiocyanate |
| 7772-98-7 | Sodium thiosulfate |
| 12068-03-0 | Sodium toluene sulfonate |
| 650-51-1 | Sodium trichloroacetate (Not selected for InertFinder) |
| 7758-29-4 | Sodium tripolyphosphate |
| 1300-72-7 | Sodium xylenesulfonate |
| 110-44-1 | Sorbic acid |
| 590-00-1 | Sorbic acid, potassium salt |
| 8001-22-7 | Soybean oil |
| 131929-60-7 | Spinosad |
| 518-47-8 | Spiro(isobenzofuran-1(3H),9′-(9H)xanthen)- |
| | 3-one, 3′,6′-dihydroxy-, disodium salt |
| 148477-71-8 | Spirodiclofen |
| 283594-90-1 | Spiromesifen |
| | Spores of Bacillus firmus strain-1582 at |
| | least 3 times 10 to the ninth power cells per |
| | gram |
| 56-36-0 | Stannane, (acetyloxy)tributyl- |
| 24124-25-2 | Stannane, tributyl((1-oxo-9, |
| | 12-octadecadienyl)oxy)-, (Z,Z)- |
| 28801-69-6 | Stannane, tributyl((1-oxoneodecyl)oxy)- |
| 22330-14-9 | Stannane, tributyl((2-((tributylstannyl)oxy)benzoyl)oxy)- |
| 2155-70-6 | Stannane, tributyl(2-methyl-1-oxo-2-propenyl)oxy- |
| 1983-10-4 | Stannane, tributylfluoro- |
| 7745-89-3 | Starlicide |
| 5035-58-5 | Stibine, ((2-ethyl-1-oxohexyl)oxy)diphenyl- |
| 8052-41-3 | Stoddard solvent |
| | Streptomyces galbus strain QST 6047 |
| | Streptomyces strain K61 |
| | Streptomyces lydicus WYEC 108 |
| 3810-74-0 | Streptomycin sulfate |
| 60-41-3 | Strychnidin-10-one, sulfate (2:1) |
| 57-24-9 | Strychnine |
| 57-50-1 | Sucrose |
| 42922-74-7 | Sucrose octanoate |
| 144-80-9 | Sulfacetamide |
| 5329-14-6 | Sulfamic acid |
| 13637-90-6 | Sulfamic acid, chloro-, monosodium salt |
| 122836-35-5 | Sulfentrazone |
| 4151-50-2 | Sulfluramid |
| 74222-97-2 | Sulfometuron |
| 68127-34-4 | Sulfonated cresol |
| 68443-05-0 | Sulfonated oleic acid, sodium salt |
| 68439-57-6 | Sulfonic acids, C14-16-alkane hydroxy |
| | and C14-16-alkene, sodium salts |
| 81591-81-3 | Sulfosate |
| 141776-32-1 | Sulfosulfuron |
| 3689-24-5 | Sulfotepp |
| 7704-34-9 | Sulfur |
| 7446-09-5 | Sulfur dioxide |
| 7664-93-9 | Sulfuric acid |
| 82010-77-3 | Sulfuric acid, monooctyl ester, compd. |
| | with iodine and 2,2′,2″-nitrilotris(ethanol) |
| 7757-83-7 | Sulfurous acid, sodium salt |
| 2699-79-8 | Sulfuryl fluoride |
| 8002-26-4 | Tall oil |
| 61790-44-1 | Tall oil fatty acids, potassium salts |
| 1401-55-4 | Tannic acid |
| 147-71-7 | Tar |
| 107534-96-3 | Tebuconazole |
| 112410-23-8 | Tebufenozide |
| 34014-18-1 | Tebuthiuron |
| 79538-32-2 | Tefluthrin |
| 542-75-6 | Telone |
| 3383-96-8 | Temephos |
| 5902-51-2 | Terbacil |
| 13071-79-9 | Terbufos |
| 5915-41-3 | Terbuthylazine |
| 886-50-0 | Terbutryn |
| 19727-17-4 | Terephthalic acid, compd. with |
| | dodecylguanidine (1:2) |
| 138-87-4 | Terpineols ( unspec.) |
| 33079-08-2 | Tertiary butylamine pyridinethiol-1-oxide |
| 10543-57-4 | Tetraacetylethylenediamine |
| 127-18-4 | Tetrachloroethylene |
| 25167-83-3 | Tetrachlorophenols |
| 137543-70-5 | Tetrachlorophenols, alkyl* amine salt |
| | *(as in fatty acids of coconut oil) |
| 53535-27-6 | Tetrachlorophenols, potassium salt |
| 25567-55-9 | Tetrachlorophenols, sodium salt |
| 961-11-5 | Tetrachlorvinphos |
| 112281-77-3 | Tetraconazole |
| 53404-40-3 | Tetradecanoic acid, compd. with |
| | 2,2′iminobis(ethanol) and iodine |
| 116-29-0 | Tetradifon |
| 107-49-3 | Tetraethyl pyrophosphate |
| 53494-58-9 | Tetrahydroabietylamine acetate |
| 513-92-8 | Tetraiodoethylene |
| 55566-30-8 | Tetrakis(hydroxymethyl)phosphonium sulphate (THPS) |
| 119-64-2 | Tetralin (Not selected for InertFinder) |
| 7696-12-0 | Tetramethrin |
| 7320-34-5 | Tetrapotassium pyrophosphate |
| 7722-88-5 | Tetrasodium pyrophosphate |
| 148-79-8 | Thiabendazole |
| 28558-32-9 | Thiabendazole hypophosphite |
| 111988-49-9 | Thiacloprid |
| 153719-23-4 | Thiamethoxam |
| 117718-60-2 | Thiazopyr |
| 51707-55-2 | Thidiazuron |
| 13108-52-6 | Pyridine, 2,3,5,6-tetrachloro-4-(methylsulfonyl)- |
| 60263-88-9 | Pyridine, 2-((1-(2,5-dimethylphenyl)ethyl)sulfonyl)-, |
| | 1-oxide |
| 1121-76-2 | Pyridine, 4-chloro-, 1-oxide |
| 5406-97-3 | Pyridinium, 1-dodecyl-, salt with |
| | 5-chloro-2(3H)-benzothiazolethione (1:1) |
| 1334-77-6 | Pyridylmercuric acetate |
| 53112-28-0 | Pyrimethanil |
| 95737-68-1 | Pyriproxyfen |
| 123343-16-8 | Pyrithiobac-sodium |
| 70166-48-2 | Pyroxyfur |
| | Bacillus subtilis strain QST 713 |
| 84087-01-4 | Quinclorac |
| 106-51-4 | Quinone |
| 878790-59-1 | Quinoxyfen |
| 76578-14-8 | Quizalofop |
| | Red pepper |
| 507-60-8 | Red squill |
| 50-55-5 | Reserpic acid methyl ester |
| | 3,4,5-trimethoxybenzoate (ester) |
| 8023-77-6 | Resins, oleo-, capsicum |
| 10453-86-8 | Resmethrin |
| | Reynoutria sachalinensis |
| | Rhizobia leguminosarum biovar viceae |
| | containing the cryIII gene from bacillus |
| | thuringiengis subsp. tenebrionis |
| | Rhodotorula glutinis |
| 122931-48-0 | Rimsulfuron |
| 299-84-3 | Ronnel |
| | Rosemary Herbs |
| 8002-16-2 | Rosin oil |
| 83-79-4 | Rotenone |
| 15662-33-6 | Ryania speciosa, powdered stems of |
| 15662-33-6 | Ryanodine |
| 83318-76-7 | S-(1,1-Dimethylethyl) O-ethyl ethylphosphonothioate |
| 2303-16-4 | S-(2,3-Dichloroallyl) diisopropylthiocarbamate |
| 28434-00-6 | S-Bioallethrin |
| 65733-16-6 | S-Methoprene |
| 87392-12-9 | S-Metolachlor |
| 8051-02-3 | Sabadilla alkaloids |
| 87-17-2 | Salicylanilide |
| 69-72-7 | Salicylic acid |
| 8047-15-2 | Saponin |
| | Sawdust |
| | Sclerotinia sclerotiorum |
| | Scytalidium FY |
| 8008-74-0 | Sesame oil |
| | Sesame plant, ground |
| 74051-80-2 | Sethoxydim |
| 1982-49-6 | Siduron |
| 63231-67-4 | Silica gel |
| 53404-77-6 | Silicate(2-), hexafluoro-, aluminum sodium (4:1:5) |
| 16949-65-8 | Silicate(2-), hexafluoro-, magnesium (1:1) |
| 7631-86-9 | Silicon dioxide |
| 7440-22-4 | Silver |
| 534-16-7 | Silver carbonate |
| 7783-90-6 | Silver chloride |
| 7775-41-9 | Silver fluoride |
| 7761-88-8 | Silver nitrate |
| 155645-89-9 | Silver oxide (Ag404) |
| 265647-11-8 | Silver sodium hydrogen zirconium |
| | phosphate (Ag0.18Na0.57H0.25Zr2(PO4)3) |
| 93-72-1 | Silvex |
| 19398-13-1 | Silvex*, 2-Butoxyethyl ester |
| | *(2-(2,4,5-trichlorophenoxy)propionic acid) |
| 51170-59-3 | Silvex*, Diethanolamine salt |
| | *(2-(2,4,5-trichlorophenoxy)propionic acid) |
| 2818-16-8 | Silvex*, Potassium salt |
| | *(2-(2,4,5-trichlorophenoxy)propionic acid) |
| 17369-89-0 | Silvex*, Triethanolamine salt |
| | *(2-(2,4,5-trichlorophenoxy)propionic acid) |
| 53404-74-3 | Silvex*, Triethylamine salt |
| | *(2-(2,4,5-trichlorophenoxy)propionic acid) |
| 122-34-9 | Simazine |
| 61789-31-9 | Soap |
| 61-31-4 | Sodium 1-naphthaleneacetate |
| 68957-70-0 | Sodium 2,2′-methylenebis(4,6-dichlorophenate) |
| 10254-48-5 | Sodium 2,2′-methylenebis(4-chlorophenate) |
| 136-32-3 | Sodium 2,4,5-trichlorophenate |
| 136-78-7 | Sodium 2-(2,4-dichlorophenoxy)ethyl sulfate |
| 3184-65-4 | Sodium 2-benzyl-4-chlorophenate |
| 35535-81-0 | Sodium 2-chlorophenate |
| 1954-81-0 | Sodium 3-amino-2,5-dichlorobenzoate |
| 2312-76-7 | Sodium 4,6-dinitro-o-cresylate |
| 10433-59-7 | Sodium 4-(2,4-dichlorophenoxy)butyrate |
| 3567-25-7 | Sodium 5-chloro-2-(4-chloro-2-(3-(3,4- |
| | dichlorophenyl)ureido)phenoxy)benzenesulfonate |
| 137-16-6 | Sodium N-lauroylsarcosinate |
| 137-20-2 | Sodium N-methyl-N-oleoyltaurate |
| 13464-38-5 | Sodium arsenate |
| 82097-50-5 | Triasulfuron |
| 101200-48-0 | Tribenuron-methyl |
| 78-48-8 | Tribufos |
| 115-78-6 | Tributyl (2,4-dichlorobenzyl) phosphonium chloride |
| 13331-52-7 | Tributyltin acrylate |
| 4342-36-3 | Tributyltin benzoate |
| 1461-22-9 | Tributyltin chloride |
| 56573-85-4 | Tributyltin chloride complex of ethylene |
| | oxide condensate of abietylamine |
| 4027-18-3 | Tributyltin maleate |
| 26354-18-7 | Tributyltin methacrylate co-methacrylate polymer |
| 56-35-9 | Tributyltin oxide (NO INERT USE) |
| 13387-91-2 | Tributyltin resinate |
| 52-68-6 | Trichlorfon |
| 87-90-1 | Trichloro-s-triazinetrione |
| 76-03-9 | Trichloroacetic acid |
| 1344-32-7 | Trichlorobenzyl chloride |
| 79-01-6 | Trichloroethylene (NO INERT USE) |
| 75-69-4 | Trichlorofluoromethane (No longer approved for inert use) |
| 7673-09-8 | Trichloromelamine |
| | Trichoderma hamatum |
| | Trichoderma hamatum TH382 |
| 67892-31-3 | Trichoderma harzianum Rifai strain T-22 |
| | Trichoderma polysporum (ATCC 20475) |
| 67892-34-6 | Trichoderma viride (ATCC 20476) |
| 67892-34-6 | Trichoderma viride sensu Bisby |
| 55335-06-3 | Triclopyr |
| 57213-69-1 | Triclopyr, triethylamine salt |
| 3380-34-5 | Triclosan |
| 41814-78-2 | Tricyclazole |
| 58138-08-2 | Tridiphane |
| 102-71-6 | Triethanolamine |
| 53404-48-1 | Triethanolamine 2-(2,4-dichlorophenoxy)propionate |
| 6420-47-9 | Triethanolamine dinoseb ( 2-sec-Butyl-4,6-dinitrophenol ) |
| 27323-41-7 | Triethanolamine dodecylbenzenesulfonate |
| | (Data Submitter Rights) |
| 8001-39-6 | Vegetable wax |
| 1196-01-6 | Verbenone |
| | Vermicasts |
| 1929-77-7 | Vernolate |
| | Verticillium dahliae isolate WCS 850 |
| 67892-35-7 | Verticillium lecanii |
| 50471-44-8 | Vinclozolin |
| 157090-22-7; | Vinegar |
| 207004-55-5; | |
| 64-19-7; | |
| 68475-71-8; | |
| 77671-22-8; | |
| 9035-69-2 | |
| 14150-71-1 | Vinylene bisthiocyanate |
| 50-14-6 | Vitamin D2 |
| 81-81-2 | Warfarin |
| 129-06-6 | Warfarin, sodium salt |
| | Wheat germ agglutinin |
| | Bacteriophage active against |
| | xanthomonas campestris pv. vesicatoria |
| 1330-20-7 | Xylene |
| 64742-95-6 | Xylene range aromatic solvent |
| 1300-71-6 | Xylenol (unspec.or mixed from 086804) |
| 87-99-0 | Xylitol |
| | Yellow mustard seed (Brassica hirta) |
| 137497-61-1; | Zeta-Cypermethrin |
| 139203-31-9; | |
| 142443-95-6; | |
| 146909-55-9; | |
| 159940-28-0; | |
| 186554-45-0; | |
| 52315-07-8; | |
| 69865-47-0; | |
| 71697-59-1; | |
| 86752-99-0; | |
| 86753-92-6; | |
| 88161-75-5; | |
| 97955-44-7 | |
| 7440-66-6 | Zinc |
| 12447-61-9 | Zinc borate (3ZnO, 2BO3, 3.5H2O; mw 434.66) |
| 7646-85-7 | Zinc chloride |
| 16509-79-8 | Zinc dimethyldithiocarbamate-cyclohexylamine complex |
| 12122-67-7 | Zinc ethylenebis(dithiocarbamate) |
| 16871-71-9 | Zinc fluosilicate |
| 12001-85-3 | Zinc naphthenate |
| 1314-13-2 | Zinc oxide |
| 127-82-2 | Zinc phenol sulfonate |
| 1314-84-7 | Zinc phosphide (Zn3P2) |
| 13463-41-7 | Zinc pyrithione |
| 13597-65-4; | Zinc silicate |
| 142044-50-6 | |
| 557-05-1 | Zinc stearate |
| 7733-02-0 | Zinc sulfate |
| 7446-19-7 | Zinc sulfate monohydrate |
| 68813-94-5 | Zinc sulfate, basic |
| 137-30-4 | Ziram |
| 1314-23-4 | Zirconium oxide (ZrO2) |
| 156052-68-5 | Zoxamide |
| 86-88-4 | a-Naphthylthiourea |
| 14816-18-3 | alpha-(((Diethoxyphosphinothioyl) |
| | oxy)imino)benzene<BR>acetonitrile |
| 80-56-8 | alpha-(+)-Pinene |
| 68439-47-4 | alpha-Alkyl-omega-hydroxypoly(oxyethylene)- |
| | iodine complex *(100% C12-C15) |
| 68131-40-8 | alpha-C11-15-sec-alkyl-omega- |
| | hydroxypoly(oxy-1,2-e<BR>thanediyl) |
| 96-24-2 | alpha-Chlorohydrin |
| 55179-31-2 | beta-((1,1′-Biphenyl)-4-yloxy)-alpha- |
| | (1,1-dimethyl<BR>ethyl)-1H-1,2,4-triazole-1- |
| | ethanol |
| 1424-48-2 | beta-(Cyanovinyl)-p-tolylsulfone |
| 7166-19-0 | beta-Bromo-beta-nitrostyrene |
| 68359-37-5 | beta-Cyfluthrin |
| 120-23-0 | beta-Naphthoxyacetic acid |
| 188425-85-6 | boscalid |
| 29804-22-6 | cis-7,8-Epoxy-2-methyloctadecane |
| 27519-02-4 | cis-9-Tricosene |
| 584-79-2 | d-Allethrin |
| 66841-24-5 | d-trans-.beta.Cypermethrin |
| 584-79-2 | Bioallethrin |
| 163515-14-8 | dimethenamide-P |
| 76703-62-3 | gamma-Cyhalothrin |
| 91465-08-6 | lambda-Cyhalothrin |
| 108-39-4 | m-Cresol (NOT APPROVED FOR INERT |
| | INGREDIENT USE, FOOD OR NON-FOOD, |
| | PER FEDERAL REGISTER: Jun. 11, |
| | 1999 (VOLUME 64, NUMBER 112) Page |
| | 31575-31576.Fragrance use only) |
| | n-Alkyl (68% C12, 32% C14) dimethyl |
| | dimethylbenzyl ammonium chloride |
| 2173-56-0 | n-Pentyl valerate |
| 83-59-0 | n-Propyl isome |
| 90-43-7 | o-Phenylphenol (NO INERT USE) |
| 13707-65-8 | o-Phenylphenol, potassium salt |
| 132-27-4 | o-Phenylphenol, sodium salt |
| 140-56-7 | p-(Dimethylamino)benzenediazo sodium sulfonate |
| 104-46-1 | p-Propenylanisole |
| 53404-18-5 | p-tert-Amylphenol, potassium salt |
| 31366-95-7 | p-tert-Amylphenol, sodium salt |
| 5787-50-8 | p-tert-Butylphenol, sodium salt |
| 108-80-5 | S-Triazinetriol |
| 78-92-2 | sec-Butanol |
| 2224-49-9 | Triethanolamine laurate |
| 139-96-8 | Triethanolamine lauryl sulfate |
| 41669-40-3 | Triethanolamine myristate |
| 2717-15-9 | Triethanolamine oleate |
| | Triethanolamine sulfonate |
| | tridecylpolyoxyethyleneethanol-bromine complex |
| 112-27-6 | Triethylene glycol |
| 141517-21-7 | Trifloxystrobin |
| 68694-11-1 | Triflumizole |
| 1582-09-8 | Trifluralin |
| 126535-15-7 | Triflusulfuron-methyl |
| 26644-46-2 | Triforine |
| 3424-21-3 | Triisopropylamine |
| 12407-86-2 | Trimethacarb |
| 95266-40-3 | Trinexapac-ethyl |
| 379-52-2 | Triphenyltin fluoride |
| 17572-97-3 | Tripotassium ethylenediaminetetraacetate |
| 4154-35-2 | Tripropyltin methacrylate |
| 122-20-3 | Tris(2-hydroxypropyl)amine |
| 139-89-9 | Trisodium (2-hydroxyethyl)ethylenediaminetriacetate |
| 7601-54-9 | Trisodium phosphate |
| 131983-72-7 | Triticonazole |
| | Trypsin Modulating Oostatic Factor (TMOF) |
| 8002-33-3 | Turkey red oil |
| 68187-76-8 | Turkey red oil, sodium salt |
| 8006-64-2 | Turpentine |
| 112-38-9 | Undecylenic acid |
| 83657-22-1 | Uniconazole |
| 57-13-6 | Urea |
| 111578-32-6 | Urea, N′-(4-((3,4-dihydro-2-methoxy-2,4,4- |
| | trimethyl-2H-1-benzopyran-7-yl)oxy)phenyl)- |
| | N-methoxy-N-methyl- |
| 66063-05-6 | Urea, N-((4-chlorophenyl)methyl)- |
| | N-cyclopentyl-N′-phenyl- |
| 78491-02-8 | Urea, N-(1,3-bis(hydroxymethyl)-2,5-dioxo- |
| | 4-imidazolidinyl)-N,N′-bis(hydroxymethyl)- |
| 30043-49-3 | Urea, N-(5-(ethylsulfonyl)-1,3,4- |
| | thiadiazol-2-yl)-N,N′-dimethyl- |
| 21351-39-3 | Urea, sulfate (1:1) |
| 79277-27-3 | Thifensulfuron |
| 28249-77-6 | Thiobencarb |
| 24689-89-2 | Thiocyanic acid, 1-chloro-1,2-ethanediyl ester |
| 4617-17-8 | Thiocyanic acid, oxydi-2,1-ethanediyl ester |
| 31895-22-4 | Thiocyclam hydrogen oxalate |
| 59669-26-0 | Thiodicarb |
| 541-53-7 | Thioimidodicarbonic diamide ((H2N)C(S))2NH |
| 502-55-6 | Thioperoxydicarbonic acid ( (HO)C(S))2S2 ), diethyl ester |
| 23564-05-8 | Thiophanate-methyl |
| 3737-41-5 | Thiophene, 3,3,4,44-tetrachlorotetrahydro-, 1,1-dioxide |
| 65691-00-1 | Thiophene, 5-(4-chlorophenyl)-2,3-diphenyl- |
| 6012-97-1 | Thiophene, tetrachloro- |
| 53404-00-5 | Thiourea, monosilver(1+) salt, polymer |
| | with 2-propenoic acid |
| 137-26-8 | Thiram |
| 23526-02-5 | Thuringiensin |
| | Thyme Herbs |
| 89-83-8 | Thymol |
| 108-88-3 | Toluene (SEE COMMENTS) |
| 104-15-4 | Toluene sulfonic acid |
| 210631-68-8 | Topramezone |
| 8001-35-2 | Toxaphene ( Technical chlorinated |
| | camphene (67-69% chlorine) ) |
| 87820-88-0 | Tralkoxydim |
| 66841-25-6 | Tralomethrin |
| 81741-28-8 | Tri-n-butyl tetradecyl phosphonium chloride |
| 43121-43-3 | Triadimefon |
| 55219-65-3 | Triadimenol |
| 2303-17-5 | Triallate |
| 12680-35-2 | tert-Alkyl* amine *(100% C18-C22) |
| 75-65-0 | tert-Butanol |
| 3304-97-0 | tert-Butyl dimethyltrithioperoxycarbamate |
| 75-91-2 | tert-Butyl hydroperoxide |
| 1113-14-0 | trans-1,2-Bis(propylsulfonyl)ethylene |
| | Bacillus thuringiensis Cry1F protein and |
| | the genetic material (PHP27118 T-DNA) |
| | necessary for its production in corn event DP-4114-3 |
| | Bacillus thuringiensis Cry34Ab1 and Cry35Ab1 |
| | proteins and the genetic material |
| | (PHP27118 T-DNA) necessary for its |
| | production in corn event DP-4114-3 |

Some embodiments of the composition comprise one or more of the following pesticides: an essential oil, thyme oil, a thymol compound, thymol (2-isopropyl-5-methyiphenol), a thymyl salt, a thymyl ester, a limonene compound, limonene, S-limonene, R-limonene, an insecticidal soap, a non-detergent insecticidal soap, mineral oil, fish oil, vegetable oil, neem oil, garlic oil, cedarwood oil, cedrol, spearmint oil, wintergreen oil, peppermint oil, caraway oil, red thyme oil, orange oil, citronella oil, citronellol, citronellal, seed fennel, quassia, ryania, peracetic acid, dihydrocapsaicin, nordihydrocapsaicin, homocapsaicin, homodihydrocapsaicin, nonivamide, an insect pheromone, spinosad, and an organic pesticide permitted under The National List of Allowed and Prohibited Substances maintained by the United States Environmental Protection Agency (7 C.F.R. §§ 205.600-606 (2020), incorporated herein by reference only to teach which pesticides are permitted). Further embodiments of the composition contain a pesticide registered as an insecticide, fungicide, and/or rodenticide by the United States Environmental Protection Agency.

In further embodiments of the composition the pesticide is a thymol compound selected from the following:

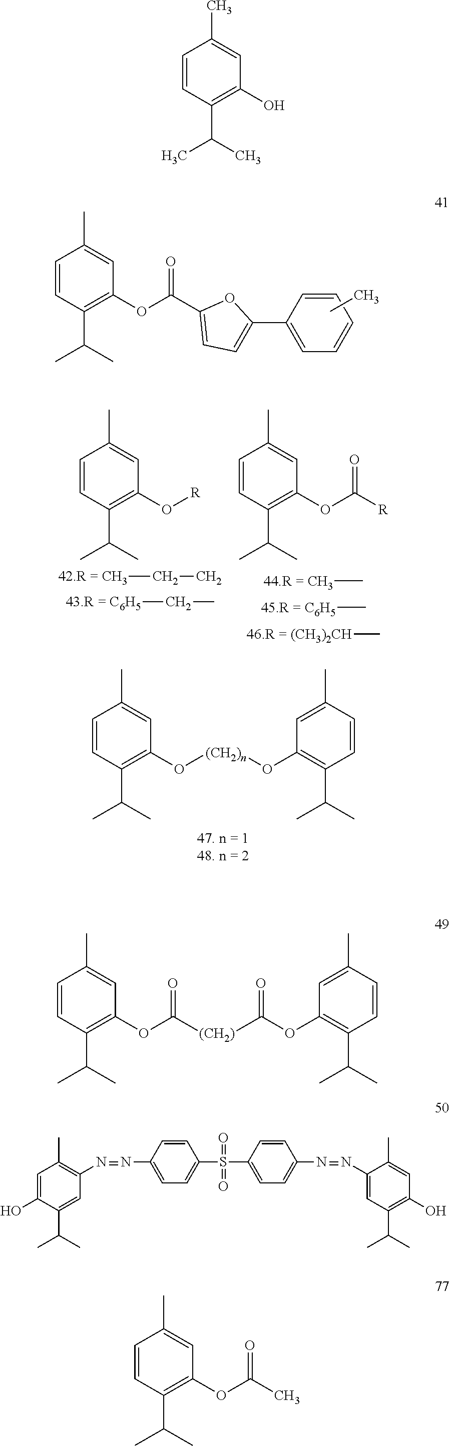

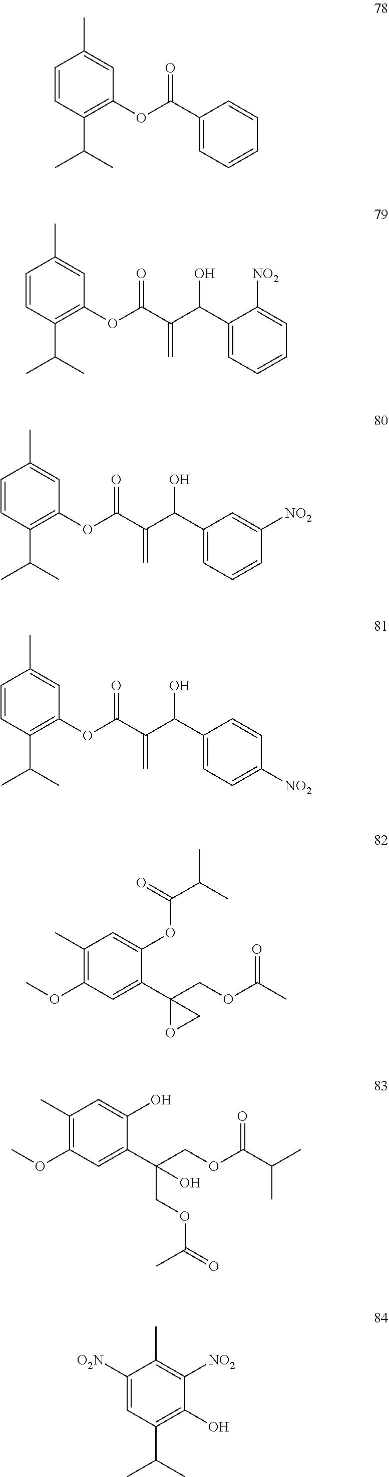

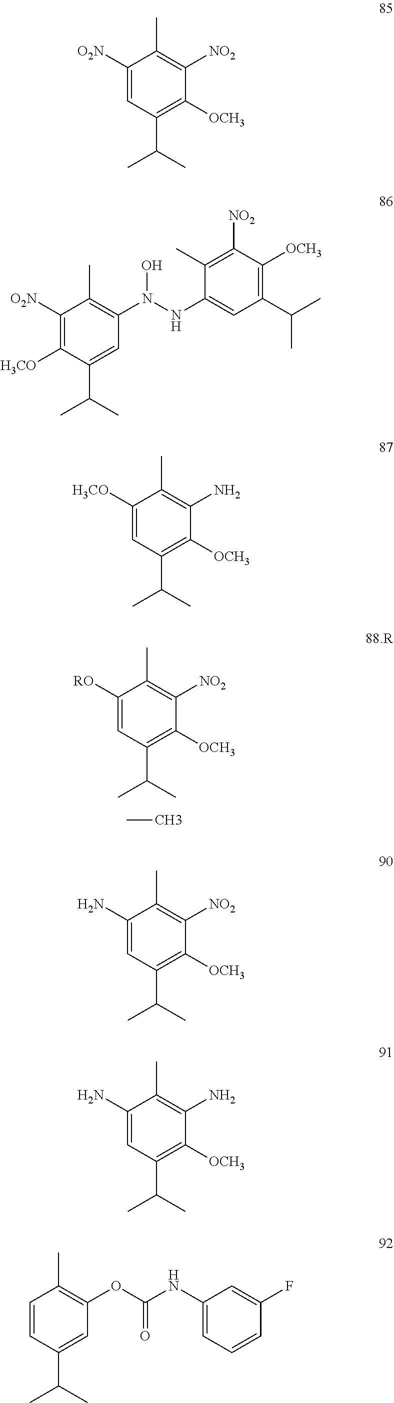

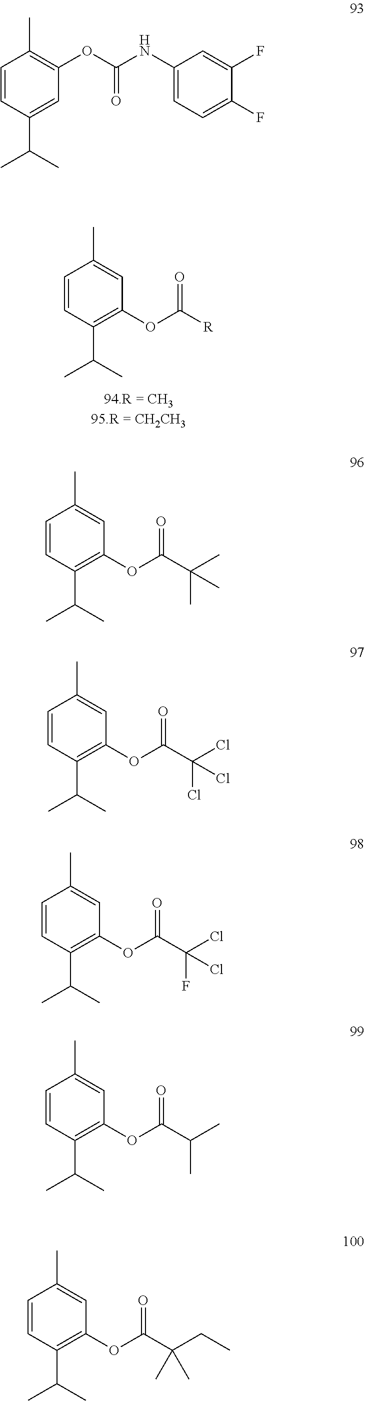

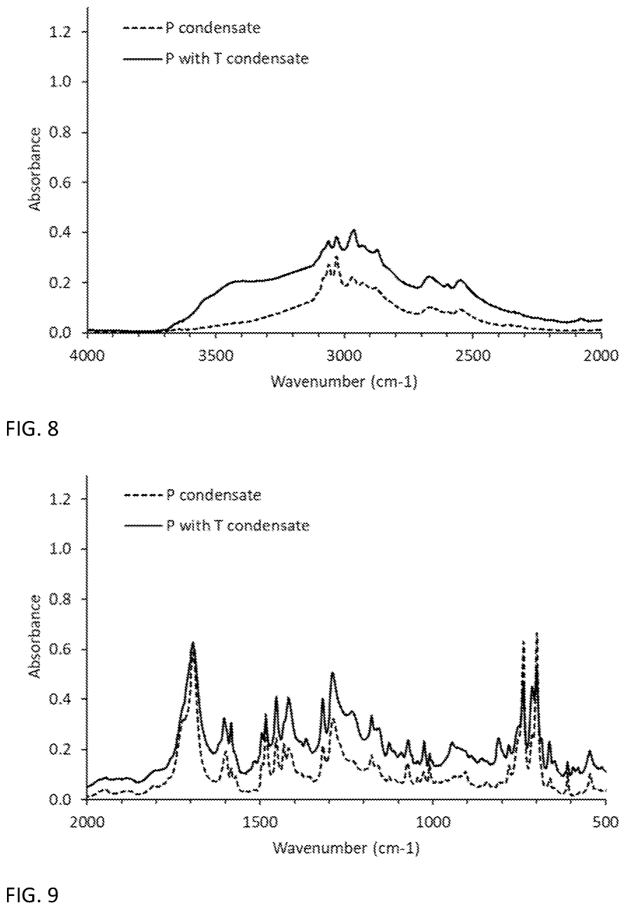

The concentration of the pesticide in the smoke is affected by the relative concentrations of the pesticide and the initiator. Some embodiments of the composition comprise the pesticide at a mass concentration at least 50% of the mass concentration of the initiator. In further embodiments of the composition the pesticide is present at a mass concentration at least 1%, 2%, 3%, 4%, 5%, 6%, 7%, 8%, 9%, 10%, 11%, 12%, 13%, 14%, 15%, 20%, 25%, 30%, 35%, 40%, 45%, 50%, 60%, 70%, 80%, 85%, 90%, 95%, 99%, and 100% of the mass concentration of the initiator. In a further embodiment of the method the pesticide is present at no more than 10%, 15%, 20%, 25%, 30%, 35%, 40%, 45%, 50%, 60%, 70%, 80%, 85%, 90%, 95%, 99%, and 100% of the mass concentration of the initiator. In a further embodiment of the method the pesticide is present at 1%, 2%, 3%, 4%, 5%, 6%, 7%, 8%, 9%, 10%, 11%, 12%, 13%, 14%, 15%, 20%, 25%, 30%, 35%, 40%, 45%, 50%, 60%, 70%, 80%, 85%, 90%, 95%, 99%, and 100% of the mass concentration of the initiator, about any of the foregoing, ±20% any of the foregoing, ±10% any of the foregoing, ±5% any of the foregoing or ±1% any of the foregoing. FIGS. 8-9 show an infrared spectrum of an exemplary embodiment of the smoke comprising TMPTA and tert-butyl peroxybenzoate with thymol, indicating the presence of thymol in the smoke (this was also confirmed by an observable thymol scent in the smoke).

### III. METHODS OF GENERATING AND USING PESTICIDE SMOKE

A non-pyrotechnic method of generating pesticide-containing smoke is provided, comprising initiating a frontal reaction in a composition for the non-pyrotechnic generation of pesticide-containing smoke, and generating smoke comprising the pesticide. The composition may be any of the smoke-generating compositions disclosed above. Because the smoke is generated by an FR, in at least some embodiments of the method the smoke is not produced by combustion. Furthermore, in at least some embodiments of the method the smoke is generated non-explosively. It is preferred that the method involves the non-pyrotechnic generation of the pesticide smoke, involving neither flame nor explosion. As discussed above, such embodiments may have the advantage of generating the smoke without O₂ being a reactant in the smoke generating reaction. In some embodiments of the method no inorganic oxidizer is a reactant in the smoke generating reaction. Consequently, in such embodiments of the method O₂ is not consumed while smoke is generated.

Without wishing to be bound by any hypothetical model, it is believed that the method generates smoke that mainly comprises (at least 50% w/w) the pesticide and reaction products of the initiator. Some embodiments of the method will generate smoke that is at least 1%, 2%, 3%, 4%, 5%, 6%, 7%, 8%, 9%, 10%, 15%, 20%, 25%, 30%, 35%, 40%, 45%, 50%, 75%, 80%, 85%, 90%, 95%, or 100% reaction products of the initiator, and the pesticide. In a further embodiment of the method the pesticide is present at no more than 10%, 15%, 20%, 25%, 30%, 35%, 40%, 45%, 50%, 60%, 70%, 80%, 85%, 90%, 95%, 99%, and 100% of the mass concentration of the initiator.

The method comprises initiating the FR. If thermal initiation is used the initiating step comprises heating the composition of any one of the claims above to an initiation temperature suitable to initiate polymerization of the monomer with the initiator. This heating must be localized if an FR is desired, as heating the entire composition to the initiation temperature would result in the entire composition polymerizing simultaneously. The localized heating can be at a point, along a line, over a relatively small region, or using a similar approach. Some embodiments of the method have the advantage of requiring relatively low temperatures for thermal initiation. In some such embodiments initiation can be accomplished by locally heating the composition to a temperature of no more than about 200° C. In further such embodiments the initiation is accomplished by heating the composition to a temperature of 100-200° C. In still further embodiments the initiation is accomplished by heating the composition to a temperature of 100-160° C. In still further embodiments the initiation is accomplished by heating the composition to a temperature of no more than about 130° C.

Thermal initiation can be accomplished using any of various heaters. For example, thermal initiation could be accomplished by running an electric current through an electrically conductive material in contact with the composition. In a preferred embodiment the conductive material is a nickel-chromium wire. The power source can be as simple as a 9V battery. The heat source can also be a thermally conductive material in contact with the composition, where the thermally conductive material is in contact with a heater.

Some embodiments of the method have the advantage of producing pesticide smoke at low temperatures. In some embodiments of the method the composition does not exceed 300° C. during the generation of the smoke. In some such embodiment the smoke itself may not exceed 300° C.

The smoke finds use in a method of controlling pests. The smoke as generated by any of the methods described above may be exposed to one or more surfaces or air volumes to be treated. Exposure should be conducted for a period of time sufficient to achieve the desired pesticide effect. The subject of pest control can be a volume of air, a surface, a workpiece, an organism, a garment, a vehicle, a building, and the like. Some organisms can be treated by virtue of the low toxicity of the smoke and the low temperature of the smoke, when a pesticide of low toxicity is also used. Types of non-pest organisms that can be treated include crop plants, humans, livestock, and other animals. Treatment would be expected to be effective at least on the organism's external surfaces. Pest control in this context refers to exposing pests that are present at the time of fumigation or after the time of fumigation to a level of pesticide sufficient to exert an observable toxic effect.

### IV. PESTICIDE SMOKE

A pesticide-containing smoke is provided. As described above, the smoke comprises a reaction product of an initiator that participated in a polymerization reaction, and a pesticide. As discussed above, it is believed that the smoke comprises one or both of initiator thermal decomposition products and initiator oligomerization products. More specific embodiments of the smoke comprise a reaction product of an initiator from an FR. The initiator from which the reaction product is derived may be any described above as suitable in the composition.

The smoke may be produced by any of the methods described above.

The smoke will in some cases be opaque in the visible spectrum, although this is not critical so long as the pesticide is effectively dispersed in the smoke. However, visual opacity has the advantage of allowing the dispersal of the smoke to be easily monitored. The smoke may also be opaque in the infrared spectrum, which has the advantage of allowing the dispersal of the smoke to be monitored using infrared sensors. Alternatively, the smoke may be non-opaque in at least part of the infrared spectrum, to allow IR cameras and sensors to function unhindered during its use. In a specific embodiment the smoke is non-opaque over at least part of the infrared spectrum that includes λ=1.4 μm; this is a wavelength at which many infrared cameras are sensitive. If infrared opacity is desired, the smoke may comprise an infrared-opaque agent, such as any listed above as suitable for use in the composition.

### V. PESTICIDE APPLICATION DEVICES

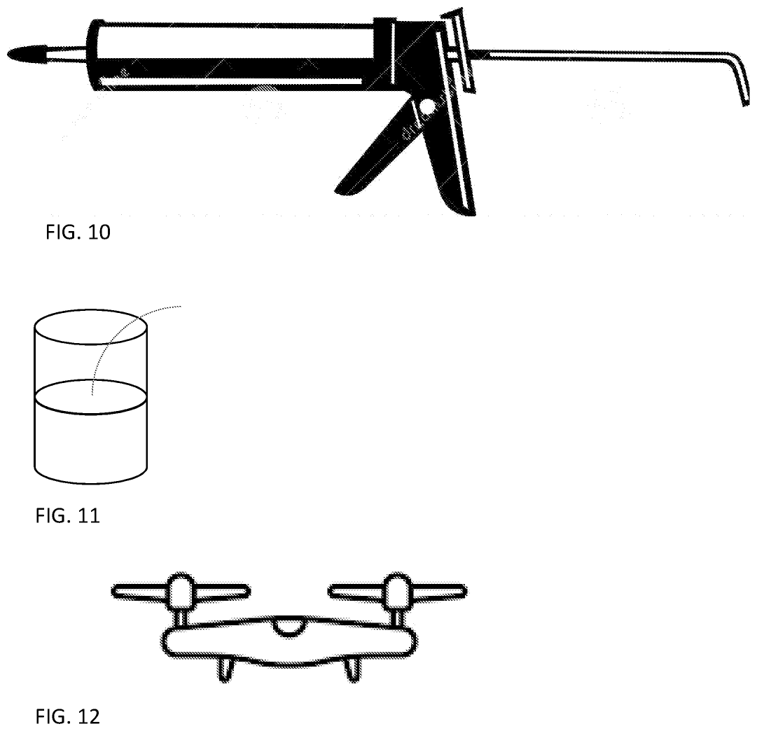

The composition finds use in a non-pyrotechnic pesticidal device that generates a pesticide-containing smoke. A general embodiment of the device comprises any of the smoke generating compositions described above; and a heat source positioned to heat the composition. Some embodiments of the device comprise a support member, on which the composition is supported. An alternative general embodiment of the device is a caulk dispenser loaded with any of the compositions disclosed above (FIG. 10); in such embodiments a line of the composition can be deposited on a surface, and the FPL can be initiated anywhere along the line.

An alternative general embodiment of the device is a container at least partially filled with pesticide smoke composition (FIG. 11). Such embodiments may comprise a volume of any one of the pesticide-containing smoke generating compositions in the claims above in the container, and a heating device to initiate an FPL in said composition. The heating device may take any suitable form, as described below. The container may be, for example, a cup. The container may be shaped so as to allow a frontal reaction to proceed through the composition once initiated.

Some embodiments of the device are a plug-in wall unit. Such embodiments may comprise a plug to connect to a power source, a heating device powered by said power source, and a volume of any one of the pesticide-containing smoke generating compositions in the claims above positioned to be initiated by the heating device.

The heat source can advantageously be non-pyrotechnic, such as a source of electric current, a heated gas, a solid heat conductor, or a radiation source. Some embodiments of the device may use a pyrotechnic heat source to trigger the otherwise non-pyrotechnic reaction. Examples of pyrotechnic heat sources include a fuse. In a specific embodiment the heat source is a wire in contact with the composition and connected to a source of electric current. In a further specific embodiment, the heat source is a nickel-chromium wire connected to a source of electric current. The heat source may be configured to limit the temperatures generated into a relatively safe range. In some such embodiments of the device, the heat source is configured to generate a temperature of no more than about 200° C. In further such embodiments of the device, the heat source is configured to generate a temperature of 100-200° C. In still further such embodiments of the device, the heat source is configured to generate a temperature of 100-160° C. In a specific embodiment of the device, the heat source is configured to generate a temperature of no more than about 130° C.

The device may be dimensioned to modulate the duration of the FR of the composition. One way this can be accomplished is by providing a support member that is longer in one dimension than another (i.e. the ratio of the length to the width is more than about 1:1). Because an FR generally spreads in all directions at about the same rate, the support member becomes more efficient in terms of duration of the FR per unit mass when it is longer and thinner. Various examples of such configuration include: a support member that is a spiral and in which the ignition wire contacts the spiral at the center of the spiral or the edge; a support member that is a coiled strip and in which the ignition wire contacts the support member at the center of the coil or the edge of the coil; multiple support members each being a coiled strip, and in which the ignition wire contacts each of the said support members at the center of the coil or the edge of the coil; multiple support members each having the shape of an arc of an open cylinder, and contacting the other support members along a line of contact from the top to the bottom of the cylinder, wherein the ignition wire runs along the line of contact.

Other shapes of the support member can be used to modulate smoke production as needed. For example, when the support member is a disc, and the ignition wire contacts the center of the disc, smoke will be produced at an accelerating rate as the front of the FR expands as a circle of increasing circumference.

The support member functions to hold the smoke generating composition and provide it with shape. In a specific embodiment the support member comprises a fibrous matrix onto which the composition is deposited (e.g., coated). In some such embodiments the smoke generating composition occupies a significant portion (at least 25% v/v) of the interstices in the matrix. In further embodiments the composition may occupy more specific portions of the interstitial volume of the matrix, for example at least 30%, 35%, 40%, 45%, 50%, 55%, 60%, 65%, 70%, 75%, 80%, 85%, 90%, 95%, 99%, or 100% v/v. The matrix itself may comprise fibers of various compositions, such as polymer fibers, natural fibers, metallic fibers, and ceramic fibers. The matrix could also comprise one or more wires that serve as the heat source (“ignition wires,” although nothing is ignited).

Some embodiments of the pesticidal device take the form of other more conventional smoke generators, such as a handheld grenade, or a variety of grenades. In a specific embodiment of the pesticidal device the composition is carried by a remotely controlled vehicle, or a robot vehicle (FIG. 12). Such vehicles may non-exclusively include an aircraft, a watercraft (surface vessel or submersible), a wheeled vehicle, a tracked vehicle, a hovercraft, and a ground-effect vehicle.

### VI. EXAMPLES

### Pesticide Smoke Generator (Prophetic)

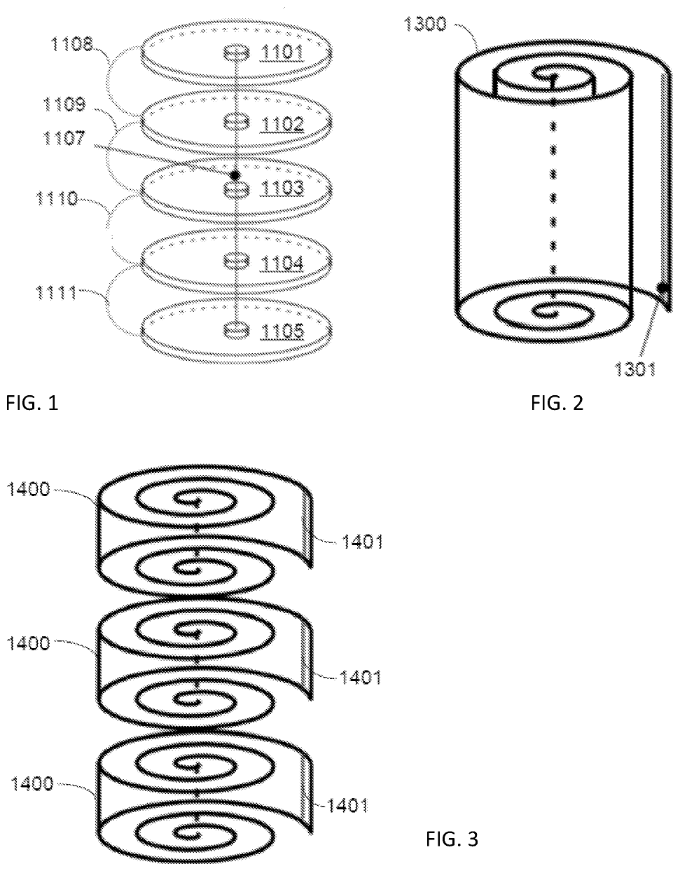

FIG. 1 depicts an embodiment of a smoke generating device 1100 using the composition disclosed herein. In this “stacked disk arrangement,” an embodiment of the smoke generating compound (not shown) is applied to disks 1101, 1102, 1103, 1104 and 1105 stacked atop one another. Although five (5) disks 1101-1105 are shown in FIG. 1, this number of disks is illustrated for explanatory purposes; a smoke generating device 1100 may comprise 10-30 stacked disks, or more or fewer, as desired.

An ignition wire 1106 extends through openings 1107 in the disks 1101-1105 for initiating the reaction. In other embodiments, the ignition wire 1106 may be “woven” into the fiber comprising the disk.

Wires 1108, 1109, 1110, and 1111 extend between adjacent disks. In this regard, wire 1108 extends between disk 1101 and disk 1102; wire 1109 extends between disk 1102 and disk 1103; wire 1110 extends between disk 1103 and disk 1104; wire 1111 extends between disk 1104 and disk 1105.

In some embodiments, insulators (not shown) are disposed between adjacent disks to isolate each disk from the remaining disks, to prevent the disks from sticking together.

FIG. 2 depicts an embodiment of a smoke producing device comprising a substrate 1300 formed from a single sheet of material, rolled into a spiral shape as shown. The substrate 1300 may be formed from the materials discussed above with respect to FIG. 1. An ignition line 1301 extends through the substrate 1300.

FIG. 3 depicts a “stacked spiral” arrangement in which a plurality of spiral substrates 1400 like those discussed above with respect to FIG. 2 are stacked atop one another. Each substrate comprises an ignition line 1401.

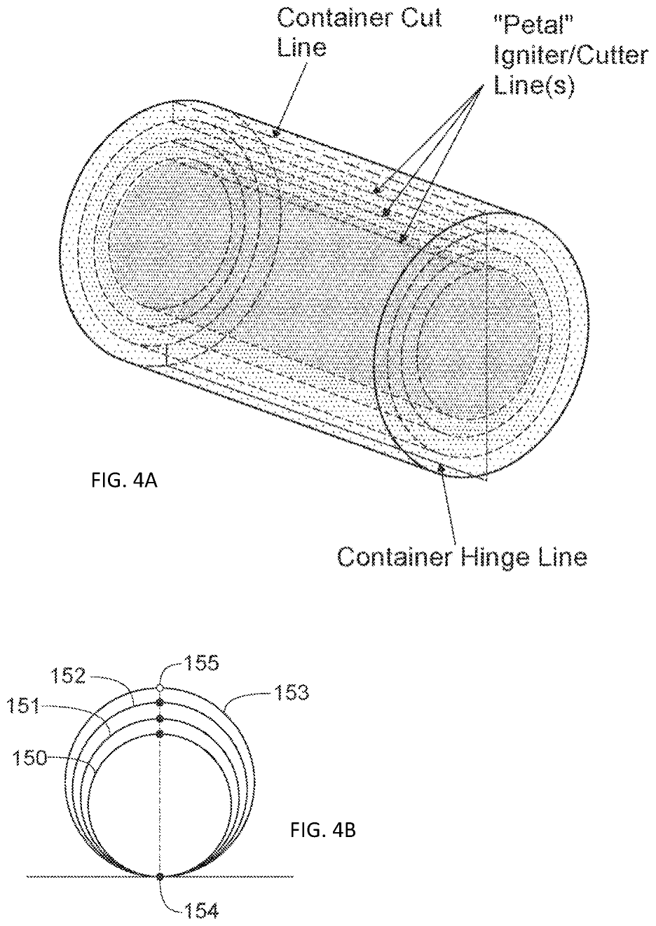

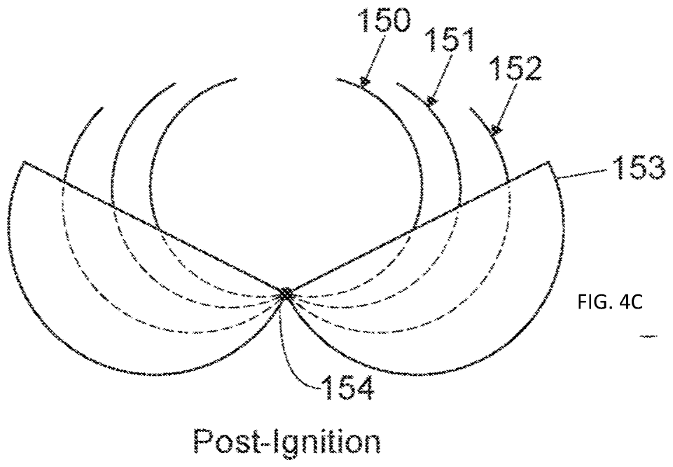

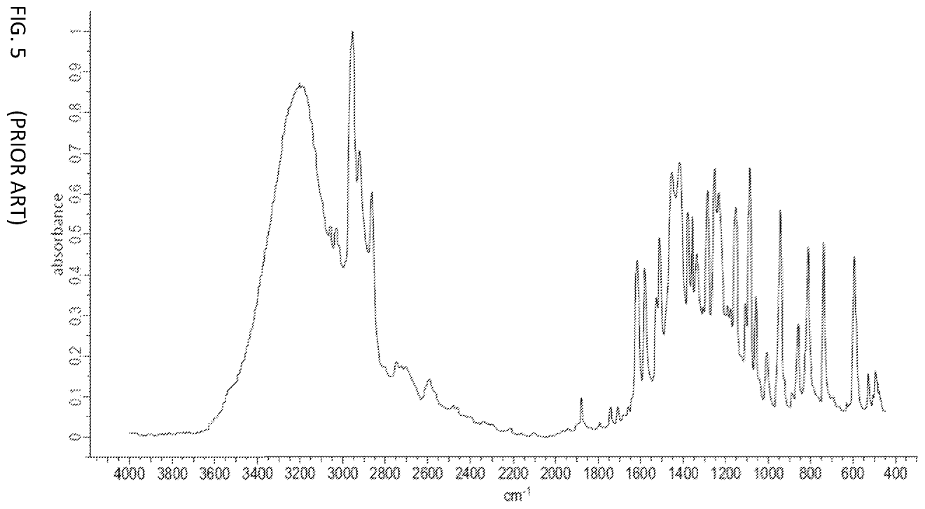

FIGS. 4A, 4B and 4C depict an embodiment of a smoke producing device in which a plurality of cylindrical petals 150, 151 and 152 nested inside a cylindrical container 153 that is hinged on one side via a hinge 154. FIGS. 4A and 4B depict the container 153 before the smoke producing reaction is initiated, and FIG. 4C depicts the container 153 after the reaction has begun. Although three petals 150, 151, and 152 are depicted in the illustrated embodiment, more or fewer petals are employed in other embodiments.

The reaction sequence causes the container 153 to be split so that it opens up along a hinge line 155 of the container 153. The concentrically arranged petals 150, 151 and 152 are initiated and split along one side so that they “open up” like a blooming flower. Each of the petals 150, 151 and 152 may be formed from the materials discussed with respect to FIG. 1 above.

### Pesticide Testing

A pesticide was tested: thymol.

Solubility in an embodiment of the smoke generating composition, comprising Luperox P, TMPTA, fumed silica, and an organic pesticide (thymol) was tested. A 50% thymol/Luperox P (5 g thymol for each 10 g Luperox P (t-butyl peroxybenzoate)) solution was achieved.

Thymol was dispersed in the carrier fluid of initiator and monomer by dissolution in Luperox P followed by the addition of TMPTA monomer. The fluid without thymol was also tested for a baseline. A sample was placed in a chamber and then “smoked”. A KBr IR card was placed in the smoke path to collect condensable product. The exposed cards were then read by Fourier-transform infrared spectroscopy for spectral signatures. The absorbance spectrum of thymol alone is shown in FIG. 5.

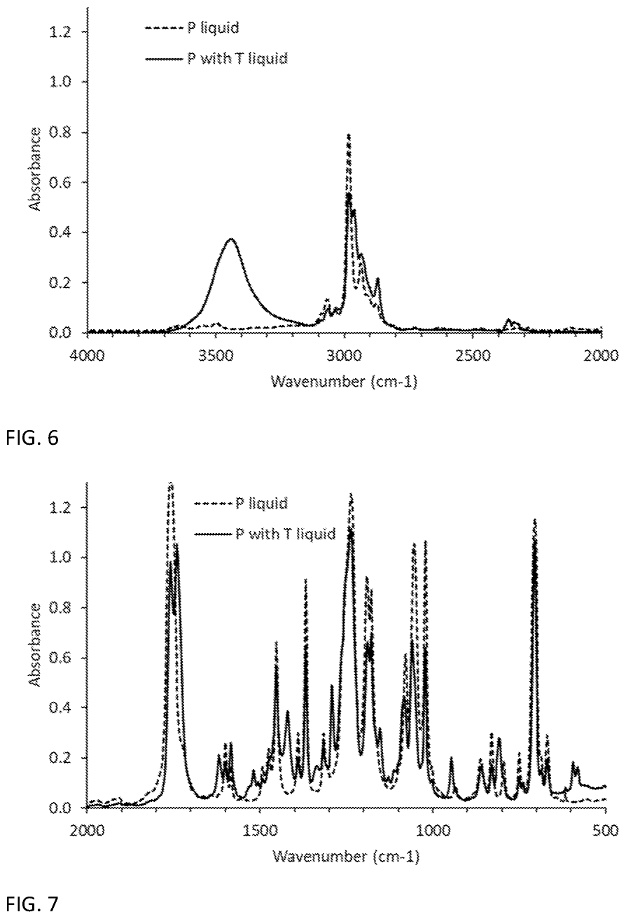

FIGS. 6 and 7 are absorbance spectra of the liquids before activation. The broken lines correspond to the smoke generating composition without thymol, and the solid lines correspond to the smoke generating composition containing thymol. The solid peak near 3500/cm provides evidence that thymol is present in the liquid. The spectral signature of thymol is presented in FIG. 5 for comparison. The concentration of thymol in this sample was approximately 30%. As expected, the sample without thymol (broken) doesn't have the characteristic peak.

FIGS. 8 and 9 show an absorbance spectrum of condensate from smoke produced from the same liquid compositions analyzed in FIGS. 6 and 7. Broken lines correspond to the spectrum of the smoke from the composition without thymol, and solid lines correspond to the spectrum of the smoke from the composition with thymol. Thymol is evident in the condensate spectra, which is evidence that the product is carried by or vaporized in the smoke. Although the signatures have broadened around 3000/cm, and the peak is no longer as well defined, the thymol containing condensate spectra (solid) is clearly more absorbing than the thymol free sample spectra (broken).

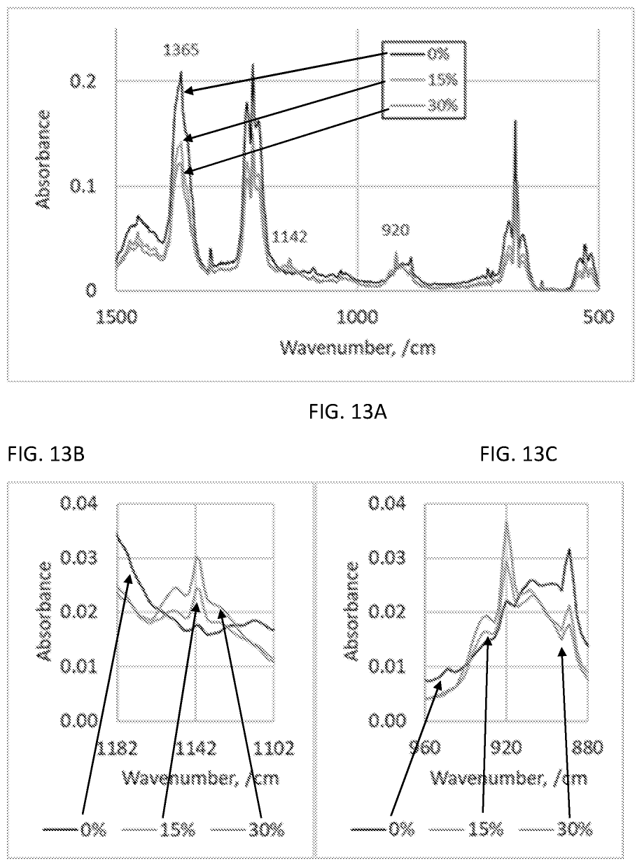

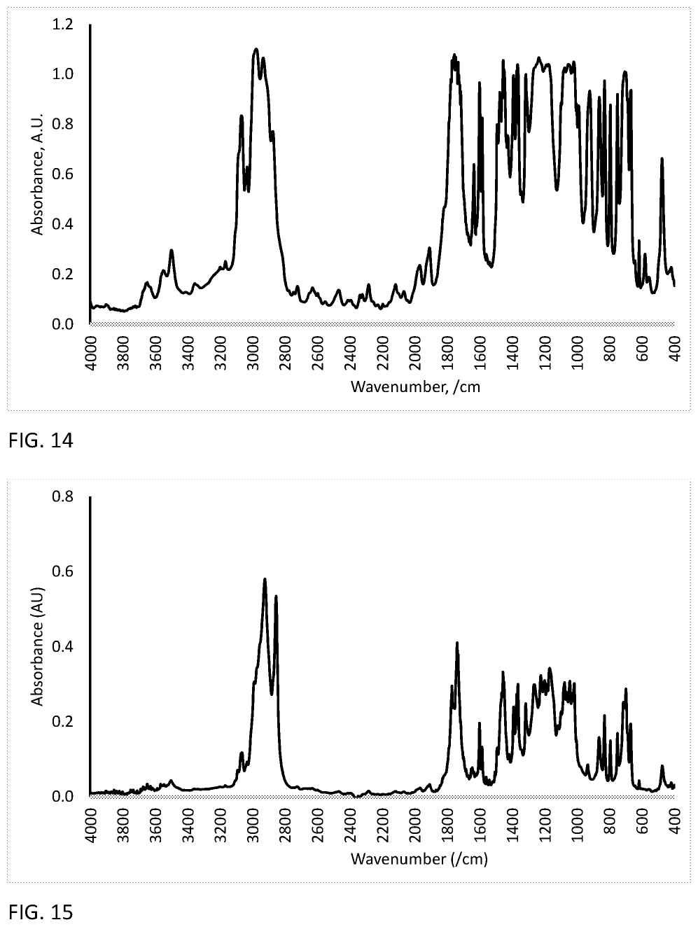

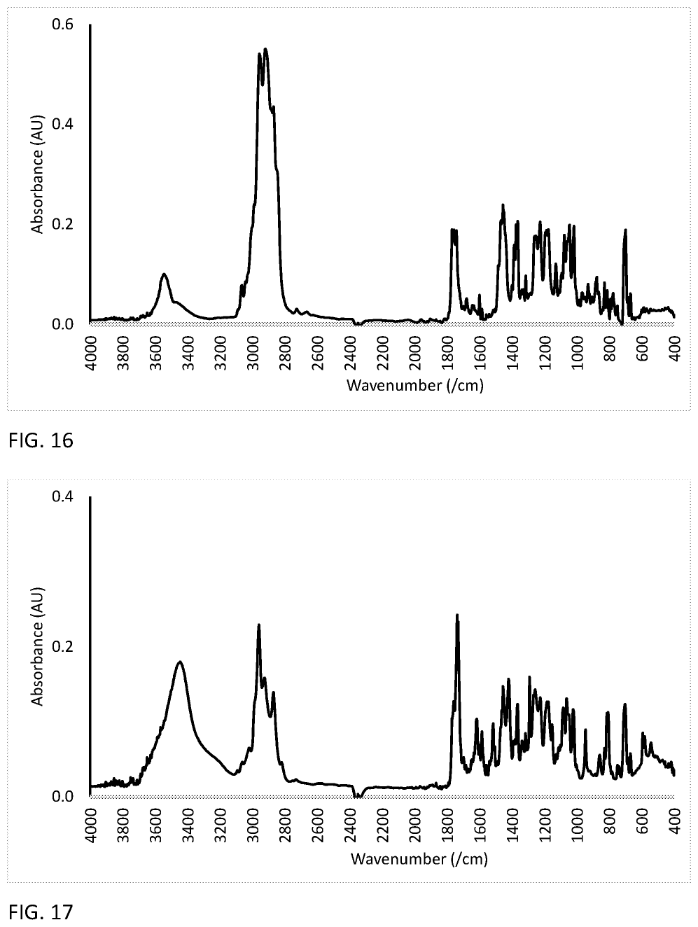

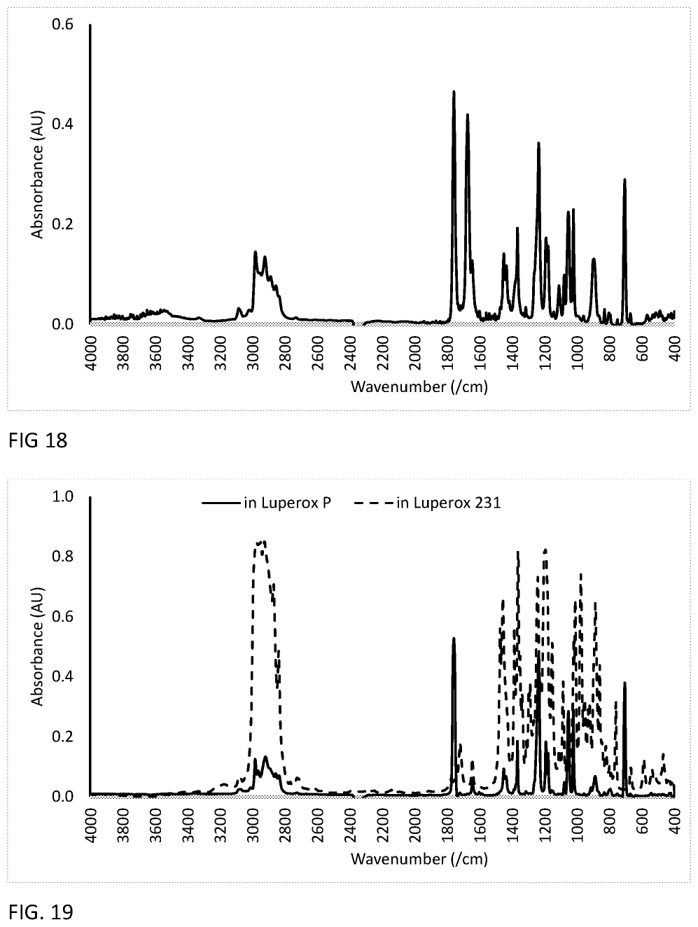

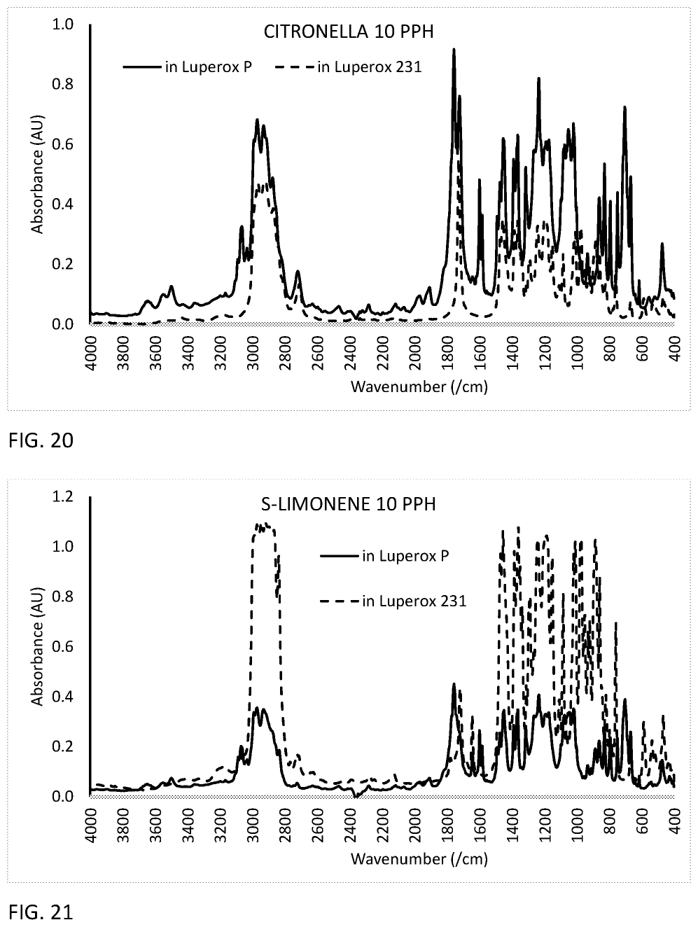

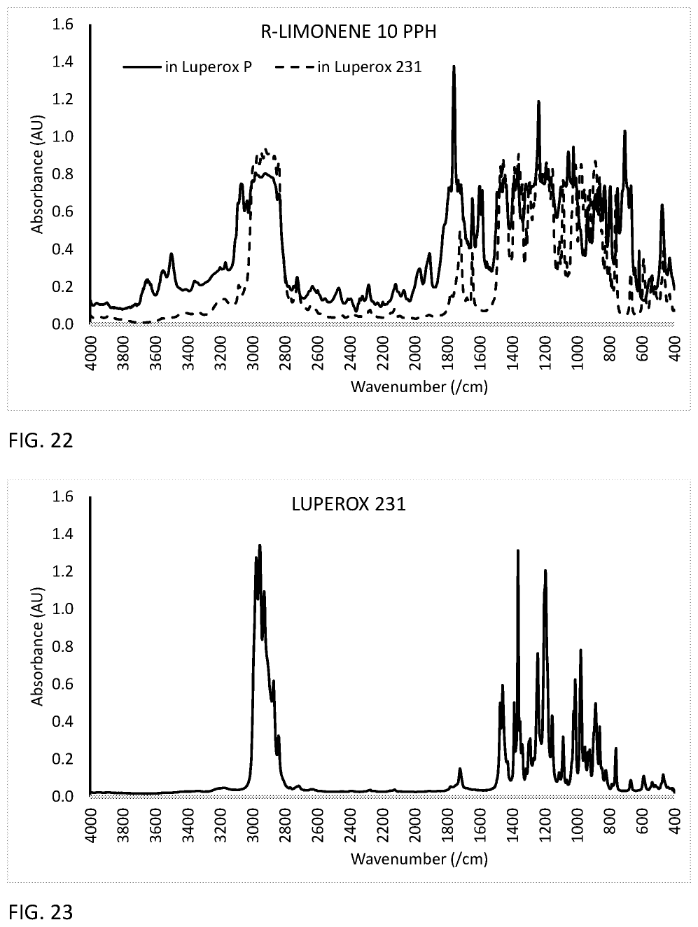

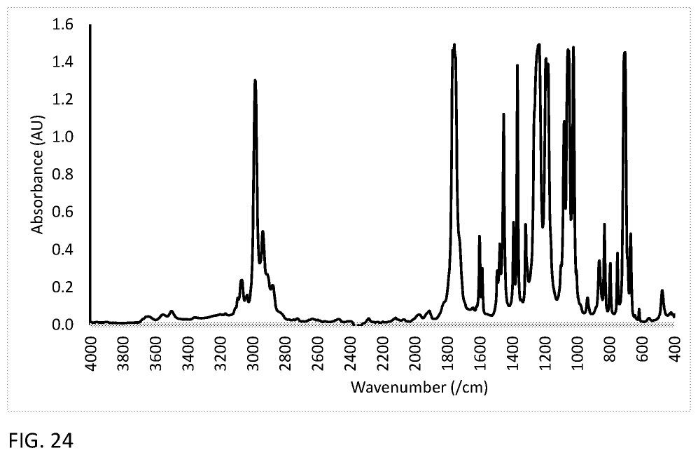

FIGS. 13-25 show absorbance spectra of mixtures of initiator (LUPEROX P and LUPEROX 231) and various additional pesticidal agents. The spectra show dissolution of the pesticides in the initiator at 1 part pesticide to 10 parts initiator.

### VII. CONCLUSIONS

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art.

Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein.

Any section headings herein are provided only for consistency with the suggestions of 37 C.F.R. § 1.77 or otherwise to provide organizational queues. These headings shall not limit or characterize the invention(s) set forth herein.

The following is claimed:

1. A composition for the non-pyrotechnic generation of pesticide-containing smoke, the composition comprising:
(a) an initiator capable of a frontal reaction that produces one or more reaction products to generate a smoke; and
(b) a pesticide agent in an amount sufficient to produce a pesticide effect in the smoke.

2. The composition of claim 1, comprising a monomer that exothermically polymerizes upon initiation with the initiator to generate the smoke, wherein the initiator is present at a mass concentration that is at least one tenth a mass concentration of the monomer.

3. The composition of any one of claims 1-2, comprising a monomer that exothermically polymerizes upon initiation with the initiator to generate the smoke, wherein the initiator is present at a mass concentration that is at least a mass concentration of the monomer.

4. The composition of any one of claims 1-3, comprising a monomer that exothermically polymerizes upon initiation with the initiator to generate the smoke, wherein the initiator is present at a mass concentration that is at least double a mass concentration of the monomer.

5. The composition of any one of claims 1-4, comprising a monomer that exothermically polymerizes upon initiation with the initiator to generate the smoke, wherein the initiator is present at a mass concentration that is at least triple a mass concentration of the monomer.

6. The composition of any one of claims 1-5, comprising a monomer that exothermically polymerizes upon initiation with the initiator to generate the smoke, wherein the initiator is present at a mass concentration that is at least five times a mass concentration of the monomer.

7. The composition of any one of claims 1-6 comprising a monomer that exothermically polymerizes upon initiation with the initiator to generate the smoke, wherein the initiator is present at a mass concentration that is at most about twenty times a mass concentration of the monomer.

8. The composition of any one of claims 1-7, wherein the initiation temperature of the monomer when initiated in the presence of the initiator is 100-160° C.

9. The composition of any one of claims 1-8, wherein the initiation temperature of the monomer when initiated in the presence of the initiator is 120-130° C.

10. The composition of any one of claims 1-9, wherein the composition does not exceed 300° C. when the monomer polymerizes upon initiation with the initiator.

11. The composition of any one of claims 1-10, wherein the composition does not exceed 300° C. during generation of the smoke.

12. The composition of any one of claims 1-11, wherein the pesticide agent is present in an amount sufficient to create a pesticidal effect in the smoke.

13. The composition of any one of claims 1-12, wherein the pesticide agent is selected from the group consisting of: an essential oil, thyme oil, a thymol compound, thymol (2-isopropyl-5-methylphenol), a thymyl salt, a thymyl ester, a limonene compound, limonene, S-limonene, R-limonene, an insecticidal soap, a non-detergent insecticidal soap, mineral oil, fish oil, vegetable oil, neem oil, garlic oil, cedarwood oil, cedrol, spearmint oil, wintergreen oil, peppermint oil, caraway oil, red thyme oil, orange oil, citronella oil, citronellol, citronellal, seed fennel, quassia, ryania, peracetic acid, capsaicin, dihydrocapsaicin, nordihydrocapsaicin, homocapsaicin, homodihydrocapsaicin, nonivamide, an insect pheromone, spinosad, and an organic pesticide permitted under The National List of Allowed and Prohibited Substances maintained by the United States Environmental Protection Agency, a pesticide registered as an insecticide, fungicide, and/or rodenticide by the United States Environmental Protection Agency, and a combination of two or more of the foregoing.

14. The composition of any one of claims 1-13, wherein the pesticide agent is selected from Table 1.

15. The composition of any one of claims 1-14, wherein the pesticide agent is a thymol compound selected from the following:

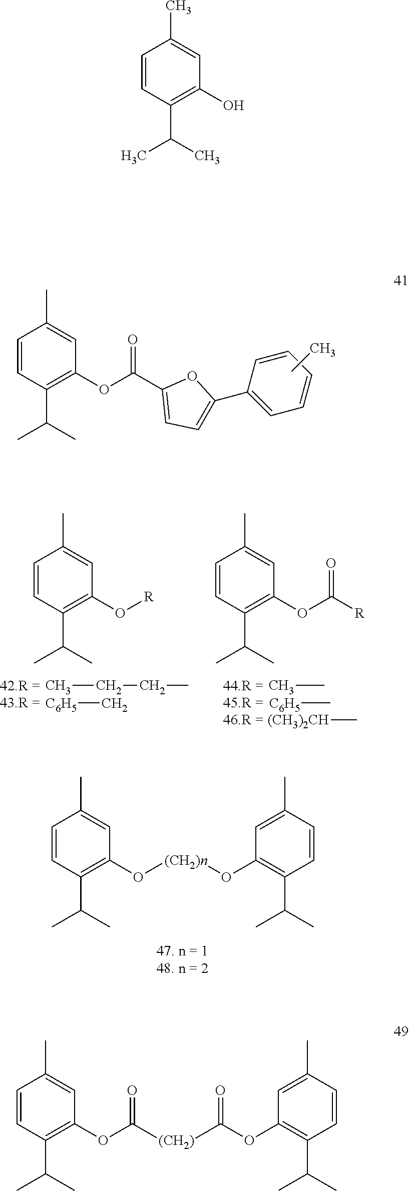

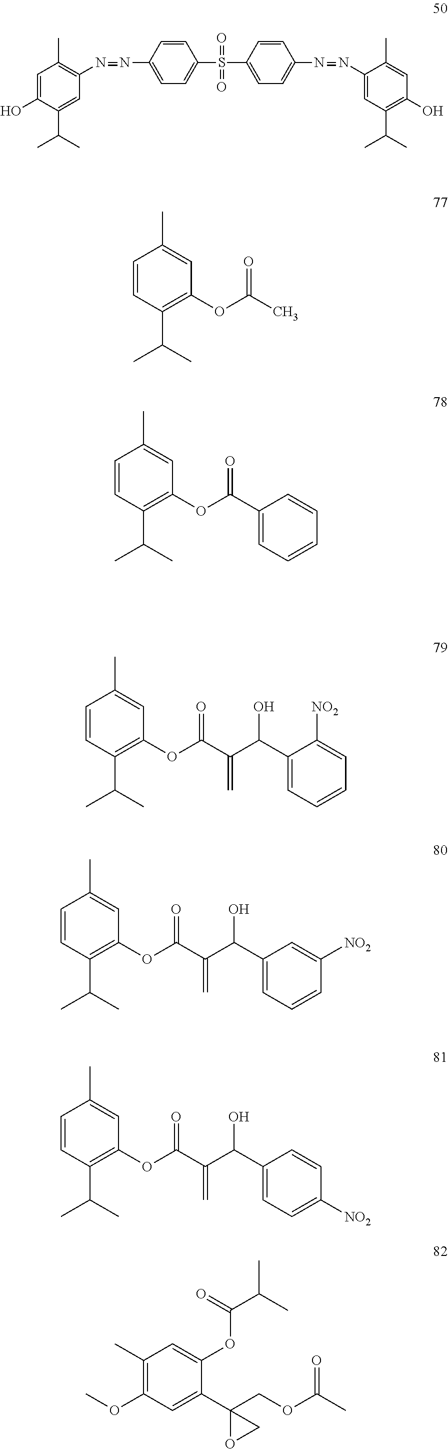

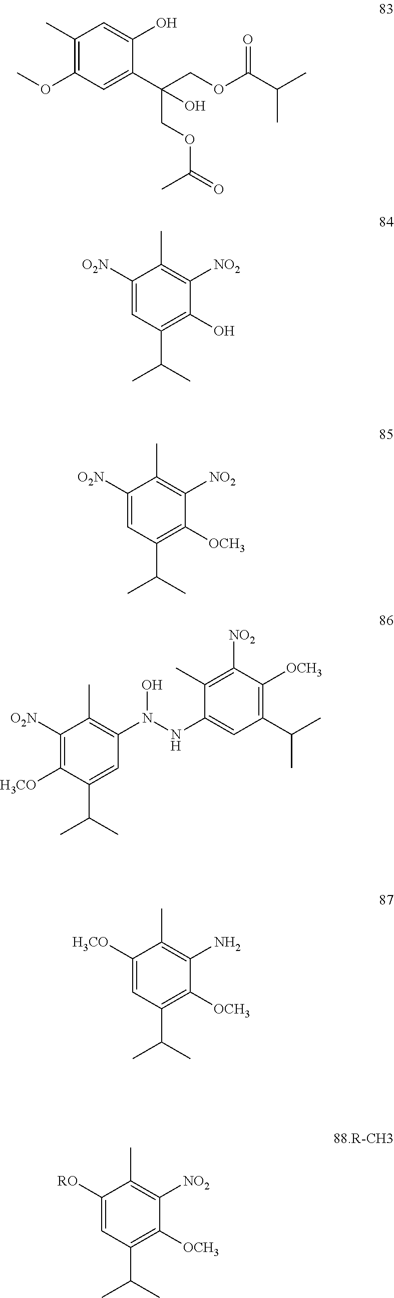

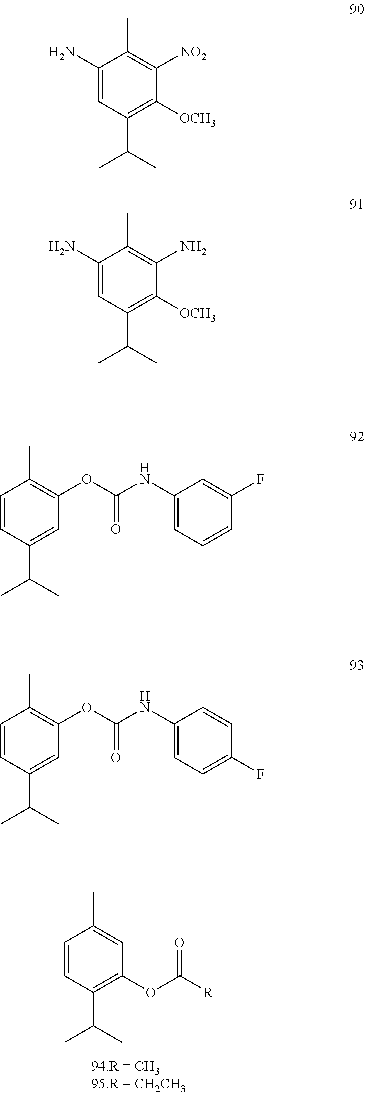

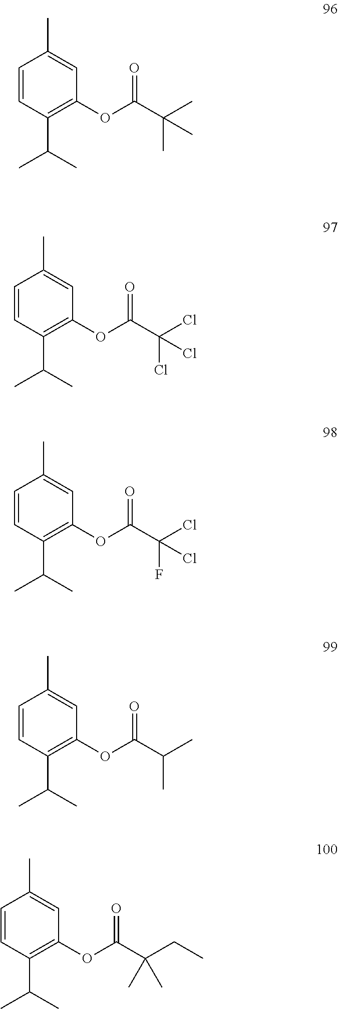 [SMILES: Cc1ccc(C(C)C)c(OC(=O)C(C)(C)C)c1 ; Cc1ccc(C(C)C)c(OC(=O)C(Cl)(Cl)Cl)c1 ; Cc1ccc(C(C)C)c(OC(=O)C(F)(Cl)Cl)c1 ; Cc1ccc(C(C)C)c(OC(=O)C(C)C)c1 ; CCC(C)(C)C(=O)Oc1cc(C)ccc1C(C)C]

16. The composition of any one of claims 1-15, wherein the pesticide agent is present at least 1% w/w or more compared to a mass of initiator.

17. The composition of any one of claims 1-16, wherein the pesticide agent is present at a mass concentration at least 1%, 2%, 3%, 4%, 5%, 6%, 7%, 8%, 9%, 10%, 11%, 12%, 13%, 14%, 15%, 20%, 25%, 30%, 35%, 40%, 45%, 50%, 60%, 70%, 80%, 85%, 90%, 95%, 99%, or 100% of a mass concentration of the initiator, about any of the foregoing, ±20% any of the foregoing, ±10% any of the foregoing, ±5% any of the foregoing, or ±1% any of the foregoing.

18. The composition of any one of claims 1-17, wherein the pesticide agent is present at a mass concentration at most 10%, 11%, 12%, 13%, 14%, 15%, 20%, 25%, 30%, 35%, 40%, 45%, 50%, 60%, 70%, 80%, 85%, 90%, 95%, 99%, or 100% of the mass concentration of the initiator about any of the foregoing, ±20% any of the foregoing, ±10% any of the foregoing, ±5% any of the foregoing, or ±1% any of the foregoing.

19. The composition of any one of claims 1-18, wherein the pesticide agent is present at a mass concentration of 1%, 2%, 3%, 4%, 5%, 6%, 7%, 8%, 9%, 10%, 11%, 12%, 13%, 14%, 15%, 20%, 25%, 30%, 35%, 40%, 45%, 50%, 60%, 70%, 80%, 85%, 90%, 95%, 99%, and 100% of the mass concentration of the initiator, about any of the foregoing, ±20% any of the foregoing, ±10% any of the foregoing, ±5% any of the foregoing or ±1% any of the foregoing.

20. The composition of any one of claims 1-19, wherein the pesticide agent is present in an amount effective to produce a pesticide effect in the smoke.

21. The composition of any one of claims 1-20, wherein the pesticide agent is present in an amount effective to produce a pesticide effect in the smoke to kill or inactivate at least 50% of a pest population.

22. The composition of any one of claims 1-21, wherein the pesticide agent is present in an amount effective to produce a pesticide effect in the smoke to kill or inactivate at least 90% of a pest population.

23. The composition of any one of claims 1-22, wherein the pesticide agent is present in an amount effective to produce a pesticide effect in the smoke to repel at least 50% of a pest population.

24. The composition of any one of claims 1-23, wherein the pesticide agent is an arachnidicide, fungicide, herbicide, insecticide, insect growth regulator, nematicide, miticide, molluscicide, ovicide, repellent, rodenticide, vermicide, or any agent with two or more listed properties.

25. The composition of any one of claims 1-24, wherein the pesticide agent is effective against one or more target organisms selected from: a rodent, an invertebrate, an insect, an arachnid, a tick, a mite, a fungus, and a protozoan.

26. The composition of any one of claims 1-25, wherein the pesticide agent is effective against one or more target organisms selected from: mosquitos, fleas, ants, termites, grasshoppers, cockroaches, wasps, lepidopterans, aphids, weevils, armyworms, beetles, and larvae.

27. The composition of any one of claims 1-26, wherein the pesticide agent is effective against one or more target organisms, and has a lower toxicity against one or more non-target organisms.

28. The composition of any one of claims 1-27, wherein the pesticide agent is effective against one or more target organisms, and has a lower toxicity against one or more non-target organisms selected from a human, a mammal, a bird, a fish, a reptile, an amphibian, a plant, and a non-target arthropod.

29. The composition of any one of claims 1-28, wherein the smoke is composed mainly of the pesticide agent and the one or more reaction products of the initiator.

30. The composition of any one of claims 1-29, wherein the smoke is composed mainly of the pesticide agent, and one or more of a thermal decomposition product of the initiator and an oligomerization product of the initiator.

31. The composition of any one of claims 1-30, comprising a monomer, wherein initiation of the polymerization of the monomer by the initiator triggers a frontal polymerization reaction.

32. The composition of any one of claims 1-31, wherein the frontal reaction is a frontal oligomerization reaction, a frontal degradation reaction, a frontal polymerization reaction, or a combination of two or more of the foregoing.

33. The composition of any one of claims 1-32, comprising a filler agent.

34. The composition of any one of claims 1-33, wherein the smoke has approximately uniform absorption across the visible spectrum from 300-1000 nm.

35. The composition of any one of claims 1-34, wherein the smoke is translucent over at least a portion of the infrared spectrum.

36. The composition of any one of claims 1-35, wherein the smoke is translucent over at least a portion of the infrared spectrum that includes λ=1.4 μm

37. The composition of any one of claims 1-36, comprising an infrared-opaque agent.

38. The composition of any one of claims 1-37, comprising an infrared-opaque agent selected from the group consisting of: methyl benzoate, benzyl benzoate, and pentyl acetate.

39. The composition of any one of claims 1-38, wherein the composition is not fluid.

40. The composition of any one of claims 1-39, wherein the composition is not fluid, and wherein the composition is formed to allow the propagation of a frontal reaction.

41. The composition of any one of claims 1-40, wherein the composition is a solid or a gel.

42. The composition of any one of claims 1-41, wherein the composition is not fluid, has a first dimension and a second dimension, and the ratio of the first dimension to the second dimension is less than 1.

43. The composition of any one of claims 1-42, wherein the monomer is triacrylate compound.

44. The composition of any one of claims 1-43, wherein the monomer is at least one of: TMPTA, glycerol propoxylate (1-PO/OH) triacrylate (GPOTA), and trimethylpropane propoxylate triacrylate (TM(PO)TA).

45. The composition of any one of claims 1-44, wherein the initiator is selected from the group consisting of: di-tert-butyl peroxide, tert-butyl peroxybenzoate, tert-butyl hydroperoxide, tert-butylperoxy 2-ethylhexyl carbonate, 1,1-Bis(tert-butylperoxy)-3,3,5-trimethylcyclohexane, cyclohexyl hydroperoxide, and a combination of two or more of the foregoing.

46. The composition of any one of claims 1-45, comprising at least 1, 2, 3, 4, 5, 6, 7, 8, 9, 10, 11, 12, 13, 14, 15, 16, 17, 18, 19, 20, 21, 22, 23, 24, 25, 26, 27, 28, 30 pph w/w filler, about any of the foregoing, ±20% any of the foregoing, ±10% any of the foregoing, ±5% any of the foregoing, ±4% any of the foregoing, ±3% any of the foregoing, ±2% any of the foregoing, or ±1% any of the foregoing mass concentration (compared to initiator).

47. The composition of any one of claims 1-46, comprising at most 3, 4, 5, 6, 7, 8, 9, 10, 11, 12, 13, 14, 15, 16, 17, 18, 19, 20, 21, 22, 23, 24, 25, 26, 27, 28, 30 pph w/w filler, about any of the foregoing, ±20% any of the foregoing, ±10% any of the foregoing, ±5% any of the foregoing, ±4% any of the foregoing, ±3% any of the foregoing, ±2% any of the foregoing, or ±1% any of the foregoing mass concentration (compared to initiator).

48. The composition of any one of claims 1-47, comprising 3, 4, 5, 6, 7, 8, 9, 10, 11, 12, 13, 14, 15, 16, 17, 18, 19, 20, 21, 22, 23, 24, 25, 26, 27, 28, 30 pph w/w filler, about any of the foregoing, ±20% any of the foregoing, ±10% any of the foregoing, ±5% any of the foregoing, ±4% any of the foregoing, ±3% any of the foregoing, ±2% any of the foregoing, or ±1% any of the foregoing mass concentration (compared to initiator).

49. The composition of any one of claims 1-48, comprising 8-15% mass concentration (compared to initiator) of a filler

50. The composition of any one of claims 1-49, comprising 2-10% mass concentration (compared to initiator) of a filler.

51. The composition of any one of claims 1-50, comprising a filler that is fumed silica.

52. The composition of any one of claims 1-51, wherein the composition does not contain a significant amount of an inorganic oxidizer.

53. The composition of any one of claims 1-52, wherein the composition contains no more than 10% w/w inorganic oxidizer.

54. The composition of any one of claims 1-53, wherein the composition contains no more than 5% w/w inorganic oxidizer.

55. The composition of any one of claims 1-54, wherein the composition contains no more than 1% w/w inorganic oxidizer.

56. The composition of any one of claims 1-55, wherein O₂ is not a reactant in the frontal reaction.

57. The composition of any one of claims 1-56, wherein the frontal reaction does not consume O₂.

58. The composition of any one of claims 1-57, comprising dibutyl phthalate.

59. The composition of any one of claims 1-58, comprising a heat source to activate the initiator.

60. The composition of any one of claims 1-59, comprising a heat source that is one or more of: a conductive wire connected to a source of electric current, a fuse, a heated gas, a source of electromagnetic radiation, and a solid heat conductor.

61. The composition of any one of claims 1-60, wherein the heat source is a nickel-chromium wire connected to a source of electric current.

62. The composition of any one of claims 1-61, wherein the monomer-initiator combination will not self-initiate or self-polymerize.

63. The composition of any one of claims 1-62, wherein the frontal reaction is self-sustaining once the reaction has been initiated.

64. The composition of any one of claims 1-63, comprising at least 5% w/w fumed silica, and wherein: the monomer is glycerol propoxylate triacrylate; the initiator is tert-peroxybenzoate present at a mass concentration that is 5-20 times the mass concentration of the monomer; and the pesticide is thymol.

65. The composition of any one of claims 1-64, comprising at least 5% w/w fumed silica, and wherein: the monomer is TMPTA; the initiator is tert-peroxybenzoate present at a mass concentration that is 5-20 times the mass concentration of the monomer; and the pesticide is thymol.

66. A non-pyrotechnic method of generating pesticide-containing smoke, the method comprising initiating a frontal reaction in a composition for the non-pyrotechnic generation of pesticide-containing smoke of any one of claims 1-65, and generating smoke comprising the pesticide agent.

67. A non-pyrotechnic method of generating pesticide-containing smoke, the method comprising initiating a frontal reaction in a composition for the non-pyrotechnic generation of pesticide-containing smoke, and generating smoke comprising the pesticide agent.

68. The method of any one of claims 66-67, wherein the smoke is not produced by combustion.

69. The method of any one of claims 66-68, wherein the smoke is generated non-explosively.

70. The method of any one of claims 66-69, wherein the composition for the non-pyrotechnic generation of pesticide-containing smoke is the composition of any one of the claims above.

71. The method of any one of claims 66-70, wherein the smoke mainly comprises the pesticide agent and the one or more reaction products of the initiator.

72. The method of any one of claims 66-71, wherein the smoke mainly comprises the pesticide agent and one or both of thermal decomposition products of the initiator and oligomerization products of the initiator.

73. The method of any one of claims 66-72, wherein the initiating step comprises heating the composition of any one of the claims above to an initiation temperature.

74. The method of any one of claims 66-73, wherein the initiation is accomplished by heating the composition to a temperature of no more than about 200° C.

75. The method of any one of claims 66-74, wherein the initiation is accomplished by heating the composition to a temperature of 100-200° C.

76. The method of any one of claims 66-75, wherein the initiation is accomplished by heating the composition to a temperature of 100-160° C.

77. The method of any one of claims 66-76, wherein the initiation is accomplished by heating the composition to a temperature of no more than about 130° C.

78. The method of any one of claims 66-77, comprising heating the composition by running an electric current through a conductive object in contact with the composition.

79. The method of any one of claims 66-78, comprising heating the composition by running an electric current through a nickel-chromium wire in contact with the composition.

80. The method of any one of claims 66-79, wherein the composition does not exceed 300° C. during the generation of the smoke.

81. The method of any one of claims 66-80, wherein the smoke is generated at a temperature that does not exceed 300° C.

82. The method of any one of claims 66-81, wherein O₂ is not a reactant in the frontal polymerization reaction.

83. The method of any one of claims 66-82, wherein the frontal polymerization reaction does not consume O₂.

84. The method of any one of claims 66-83, comprising: generating a pesticide containing smoke according to any one of the claims above; and exposing the area to the smoke for a period of time sufficient to achieve a pesticidal effect.

85. The method of any one of claims 66-84, comprising exposing the pest organism to the smoke.

86. The smoke that is the product of the method of any one of claims 66-85.

87. A non-pyrotechnic pesticide device for generating a pesticide-containing smoke, said pesticide device comprising:
(a) the composition of any one of claims 1-65; and
(b) a heat source configured to initiate the FR in the composition.

88. The pesticide device of claim 87, wherein the heat source is selected from the group consisting of: a conductive wire connected to a source of electric current, a fuse, a flame, a heated gas, and a solid heat conductor.

89. The pesticide device of any one of claims 86-88, wherein the heat source is an ignition wire in contact with the composition and connected to a source of electric current.

90. The pesticide device of any one of claims 86-89, wherein the heat source is a nickel-chromium wire connected to a source of electric current.

91. The pesticide device of any one of claims 86-90, wherein the heat source is configured to generate a temperature of no more than about 200° C.

92. The pesticide device of any one of claims 86-91, wherein the heat source is configured to generate a temperature of 100-200° C.

93. The pesticide device of any one of claims 86-92, wherein the heat source is configured to generate a temperature of 100-160° C.

94. The pesticide device of any one of claims 86-93, wherein the heat source is configured to generate a temperature of no more than about 130° C.

95. The pesticide device of any one of claims 86-94, comprising a support member to hold the composition.

96. The pesticide device of any one of claims 86-95, comprising a support member to hold the composition wherein the support member comprises a fibrous matrix.

97. The pesticide device of any one of claims 86-96, wherein the generator is in the form of a grenade.

98. A non-pyrotechnic pesticide device for generating a pesticide-containing smoke, said pesticide device comprising: a container; a volume of the pesticide-containing smoke generating composition of any one of claims 1-65 in a container; and a heating device to initiate an FR in said composition.

99. A non-pyrotechnic pesticide device for generating a pesticide-containing smoke, said pesticide device comprising: a plug to connect to a power source, a heating device powered by said power source, and a volume of the pesticide-containing smoke generating composition of any one of claims 1-65 positioned to be initiated by the heating device.

100. A pesticide-containing smoke, the smoke comprising: a reaction product of an initiator and a pesticide agent.

101. The smoke of claim 100, wherein the reaction product of the initiator is a thermal decomposition product of the initiator, an oligomerization product of the initiator, or a combination of the foregoing.

102. The smoke of any one claims 100-101, wherein the smoke mainly comprises the reaction product of the initiator and the pesticide agent.

103. The smoke of any one claims 100-102, wherein the initiator is an organic peroxide.

104. The smoke of any one claims 100-103, wherein the initiator is at least one of: di-tert-butyl peroxide, tert-butyl peroxybenzoate, tert-butyl hydroperoxide, tert-butylperoxy 2-ethylhexyl carbonate, 1,1-bis(tert-butylperoxy)-3,3,5-trimethylcyclohexane, and cyclohexyl hydroperoxide.

105. The smoke of any one claims 100-104, wherein the smoke has an approximately uniform absorption across the visible spectrum from 300-1000 nm.

106. The smoke of any one claims 100-105, wherein the smoke is translucent over at least part of the infrared spectrum.

107. The smoke of any one claims 100-106, wherein the smoke is translucent over at least part of the infrared spectrum that includes λ=1.4 μm.

108. The smoke of any one claims 100-107, comprising an infrared-opaque agent.

109. A method of controlling pests in an area, the method comprising: exposing the area to the smoke of any one of any one claims 100-108 for a time sufficient to achieve pest control.
